(19) United States
(12) Patent Application Publication
(10) Pub. No.: US 2022/0306481 A1
(43) Pub. Date: Sep. 29, 2022

(54) HIGH-SILICA Y MOLECULAR SIEVE HAVING FAU TOPOLOGY AND PREPARATION METHOD THEREFOR

(71) Applicant: DALIAN INSTITUTE OF CHEMICAL PHYSICS, CHINESE ACADEMY OF SCIENCES, Dalian City, Liaoning Province (CN)

(72) Inventors: Peng TIAN, Dalian City, Liaoning Province (CN); Dali ZHU, Dalian City, Liaoning Province (CN); Zhongmin LIU, Dalian City, Liaoning Province (CN); Linying WANG, Dalian City, Liaoning Province (CN); Jianming ZHANG, Dalian City, Liaoning Province (CN); Xuebin ZHAO, Dalian City, Liaoning Province (CN)

(21) Appl. No.: 17/604,377

(22) PCT Filed: Sep. 17, 2019
(86) PCT No.: PCT/CN2019/106165

§ 371 Date: Oct. 15, 2021

(30) Foreign Application Priority Data
Apr. 18, 2019 (CN) 201910312157.0
Apr. 18, 2019 (CN) 201910312310.X
Apr. 18, 2019 (CN) 201910312333.0
Apr. 18, 2019 (CN) 201910312367.X

(51) Int. Cl. C01B 39/20; B01J 29/08

(52) U.S. Cl. CPC C01B 39/205; B01J 29/084

(57) ABSTRACT

Disclosed in the present application is a high-silica Y molecular sieve having FAU topology. The anhydrous chemical constitution of the molecular sieve is as shown in formula I: kM.mR1.nR2.(SiₓAl_{y})O₂ Formula I; wherein, M is at least one of alkali metal elements; R1 and R2 represent organic templating agent agents; k represents the numbers of moles of the alkali metal element corresponding to per mole of (SiₓAl_{y})O₂, k=0˜0.20; m and n represent the numbers of moles of templating agents R1 and R2 corresponding to per mole of (SiₓAl_{y})O₂, m=0˜0.20, n=0.01˜0.20; x, y respectively represents the mole fraction of Si and Al, 2x/y=7-40, and x+y=1; R1, R2 are independently selected from one of nitrogen-containing heterocyclic compounds and their derivatives, and quaternary ammonium compounds. Also disclosed in the present application is a synthesis method for the high-silica Y molecular sieve having FAU topology.

### FIELD

The present invention relates to a high-silica Y molecular sieve having FAU topology and a method for synthesizing high-silica Y molecular sieve by introducing organic templating agent into synthetic gel system and adding silica-alumina molecular sieve having FAU or EMT topology as seed crystal, and further relates to a method for synthesizing high-silica Y molecular sieve by introducing organic templating agent into synthetic gel system and adding directing agent solution. The present invention belong to the field of catalyst preparation.

### BACKGROUND

Y zeolite is a silica zeolite having FAU topology. It is mainly used in fluid catalytic cracking (FCC) and is currently the most used zeolite material. The framework silica-alumina ratio of Y molecular sieve plays a decisive role in its catalytic performance. The higher the silica-alumina ratio, the better the catalytic activity and stability. The high-silica Y zeolite currently used in industry is mainly obtained by chemical/physical deabomination etc. This post-treatment process cumbersome, energy-consuming, and polluting. The direct hydrothermal synthesis electively avoids the above shortcomings while maintaining the completeness and uniformity of aluminum distribution of the crystal structure. Therefore, exploring the direct synthesis of Y molecular sieve having high silica-alumina ratio is of great significance to the catalytic cracking process.

For the direct synthesis of high-silica Y molecular sieve, people initially synthesize in non-templating agent system. That is, people do not add any organic templating agent to reaction gel, and only adjust the proportioning of the gel, adjust the crystallization time, seed crystal or inorganic directing agent so as to expect to achieve the purpose of increasing the silica-alumina ratio of the Y molecular sieve. However, limited success is achieved, and the silica-alumina ratio is difficult to reach 6.

The use of organic templating agent has brought the synthesis of Y molecular sieve into a new field. In 1987, U.S. Pat. No. 4,174,601 disclosed a FAU homogenous polymorph named ECR-4 with a silica-alumina ratio of greater than 6, which was prepared by hydrothermal crystallization at a temperature ranging bran 70° C. to 120° C. using alkyl or hydroxyalkyl quaternary ammonium salt as templating agent in the presence of seed crystal.

In 1990, U.S. Pat. No. 4,931,267 disclosed a FAU homogeneous polymorph named ECR-32 with a silica-alumina ratio of greater than 6 and high thermal stability, which was prepared by hydrothermal crystallization at a temperature ranging from 90° C. to 120° C. using tetrapropyl and/or tetrabutylammonium hydroxide as templating agent.

In 1990, French Delprato et. al. (Zeolites, 1990, 10(6):546˜552) used crown ether as templating agent to synthesize FAU zeolite with cubic structure for the first time. The framework silica-to-aluminum ratio is close to 9.0, which is the highest value currently reported in the literatures. However, the expensive and highly toxic crown ether limits in industrial application. Later, the U.S. Pat. No. 5,335,717 used polyethylene oxide as templating agent to synthesize Y zeolite with a silica-alumina ratio of greater than 6.

### SUMMARY

According to one aspect of the present application there is provided a high-silica Y molecular sieve having FAU topology.

The high-silica Y molecular sieve having FAU topology is characterized in that the anhydrous chemical constitution of the molecular sieve is as shown in formula I:

kM.mR1.nR2.(SiₓAl_{y})O_{z} Formula I
wherein, M is at least one of alkali metal element;
R1 and R2 represent organic templating agents;
k represents the number of moles of alkali metal element M per mole (SiₓAl_{y})O_{z}, k=0˜0.20;
m and n represent the number of moles of templating agents R1 and R2 per mole of (SiₓAl_{y})O_{z}, m=0˜0.20, n=0.01˜0.20;
x and y respectively represent the mole fractions of Si and Al, 2x/y=7˜10, and x−y=1;
R1 and R2 are independently one of nitrogen containing heterocyclic compound and derivatives thereof and quaternary ammonium compounds;
the structural formula of the quaternary ammonium compound is as shown in formula II;

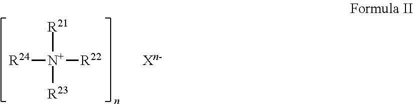

wherein, in formula II, R²¹, R²², R²³ and R²⁴ are independently at least one of C₁˜C₁₂ alkyl, C₁˜C₁₂ alkoxy, C₁˜C₁₂ hydroxyalkyl, aryl and adamantyl
X^{t}^{ₙ} is one OH⁻, Cl⁻, Br⁻, I⁻, NO₁⁻, HSO₄⁻, H₂PO₃⁻, SO₄²⁻, HPO₃²⁻, and PO₁²⁻.

Optionally, m=0.01˜0.20.

Optionally, k=0.01˜0.15; m=0.01˜0.1; n=0.02˜0.15.

Optionally, k=0.02˜0.13; m=0.01˜0.04; n=0.03˜0.08.

Optionally, the “C₁˜C₁₂ alkyl” includes “C₇˜C₁₂ phenyl alkyl”.

Optionally, the “aryl” includes “C₇˜C₁₂ aryl”.

Optionally, the “C₇˜C₁₂ aryl” includes “C₇˜C₁₂ alkyl aryl”.

Optionally, M is at least one of Na, K, and Cs, and 2x/y=7˜30.

Optionally, M is at least one of Na, K, and Cs, and 2x/y=8˜30.

Optionally, the upper limit of 2x/y is 8, 9, 10, 11. 12, 13, 14, 15, 16, 17. 18.19. 33, 22, 23, 24, 25, 26, 27, 28, 29 or 30, and the lower limit thereof is 7, 8, 9, 10, 11, 12, 13. 14, 15, 16, 17, 18, 19, 20. 22, 23. 24, 25, 26, 27, 28 or 29.

Optionally, R1 and R2 are independent one of quaternary ammonium compounds.

Optionally, R1 and R2 are independently at least one of tetramethylammonium hydroxide, tetramethylammonium hydroxide, tetrapropylammonium hydroxide, tetrabutylammonium hydroxide, tetrapentylammonium hydroxide, tetrahexylammonium hydroxide, tetrapropylammonium bromide, tetrabutylammonium chloride, tetrapentylammonium bromide, tripropyl-isoburylammonium bromide, triburyl-cyclohexylammonium hydroxide, diburyl-dihexyl ammonium hydroxide, choline, triethyl-hydroxyethyl ammonium hydroxide tripropyl-hydroxyethyl ammonium hydroxide, triethyl-hydroxyethyl ammonium hydroxide, tributyl-benzyl ammonium hydroxide, triethyl-benzyl ammonium hydroxide, tropropyl-benzyl ammonium hydroxide, N,N,N-triethyl-adamantyl ammonium chloride, and N,N,N-tripropyl ammonium chloride.

Optionally, R1 is at least one of tetraethylammonium hydroxide, tetraethylammonium hydroxide, tetrapropylammonium hydroxide and choline;

R1 is at least one of tetraethylammonium hydroxide, tetrapropylammonium hydroxide, tetrabutylammonium hydroxide, tetrapentylammonium hydroxide, tetrahexylammonium hydroxide, tetrapropylammonium bromide, tetrabutylammonium chloride, tetrapentylammonium bromide, tripropyl-isobutyl ammonium bromide, tributyl-cyclohexylammonium hydroxide, dibutyl-dihexyl at ammonium hydroxide, triethyl-hydroxyethyl ammonium hydroxide, tripropyl-hydroxyethyl ammonium hydroxide, triburyl-hydroxyethyl ammonium hydroxide, tributyl-benzyl ammonium hydroxide, triethyl-benzyl ammonium hydroxide, tripropyl-benzyl ammonium hydroxide N,N,N-triethyl-adamantyl ammonium chloride, and N,N,N-tripropyl-adamantyl ammonium chloride

Optionally, R1 is at least one of quaternary ammonium compounds; and R2 is at least one of nitrogen-containing heterocyclic compounds and derivatives thereof.

Optionally, R1 is at least one of tetramethylammonium hydroxide, tetraethylammonium hydroxide, tetrapropylammonium hydroxide and choline;

R2 is at least one of nitrogen heterocyclic compounds and derivatives thereof.

Optionally, R2 at least ore of pyridine, N-methylpyridine N-ethylpyridine N-propylpyridine, N-butylpyridine, N-ethyl-3-butylpyridine, 1-ethyl-propylpyridine hydroxide, piperidine, N,N-dimethylpiperidine, N,N-dimethyl-3,5-diethylpiperidine hydroxide, N,N-dimethyl-3,5-dipropylpiperidine hydroxide, N,N-diethyl-3,5-dipropylpiperidine hydroxide, N,N-diethyl-2,6-dimethylpiperidine hydroxide, N,N-dimethyl-2,6-diethylpiperidine hydroxide, imidazole, 1-ethyl-3-butylimidazole hydroxide, 1-ethyl-3-butyl-1-propylimidazole hydroxide, 1-benzyl-3-methylimidazole hydroxide, 1-benzyl-3-ethylimidazole hydroxide, 1-benzyl-3-butylimidazole hydroxide, piperazine, N-methylpiperazine, 1,4-dipropylpiperazine, 1-methyl-1-ethylpiperazine, and 1-ethyl-1-butyl-5-methylpiperazine.

Optionally, the high-silica Y molecular sieve having FAU topology is an octahedral structure.

Optionally, the particle size of the high-silica Y molecular sieve having FAU topology ranges from 50 min to 2500 nm.

According to another aspect of the meal application, there is provided a method for synthesizing high-silica Y molecular sieve having FAU topology by using silica-alumina molecular sieve having FAU or EMT topology as seed crystal and introducing organic templating agent under alkaline hydrochemical conditions. A high-silica (silica-alumina molar ratio in a range from 7 to 40) Y molecular sieve is synthesized.

The method for synthesizing high-silica Y molecular sieve having FAU topology is characterized in that it comprises the following steps:
a) mixing raw materials containing aluminum source, silica source, alkali metal source, organic templating agent R and water to prepare an initial gel mixture L wherein the aluminum source, silicon source, alkali metal source, organic templating agent R and water in the raw material have the following molar ratios:

SiO₂/Al₂O₃=10˜200,

M₂O/Al₂O₃=0˜30, wherein M is at least one of alkali metal elements;

R/Al₂O₃=1˜45;

H₂O/Al₂O₃=50˜8000;

b) adding silica-alumina molecular sieve seed crystal having FAU or EMT topology to the initial gel mixture I obtained in step a) to obtain a mixture II;

c) placing the mixture II obtained in step b) in a sealed reactor to perform crystallization to obtain the high-silica Y molecular sieve having FAU topology;

wherein, the number of moles of silicon source is calculated by SiO₂; the number of moles of aluminium source is calculated by Al₂O₁; the number of mole of templating agent R is calculated by the number of moles of R itself; and the number of moles of alkali metal source is calculated by the number of moles of corresponding metal oxide M₂O.

Optionally, in step a), H₂O/Al₂O₃=50˜6000.

Optionally, in step a), H₂O/Al₂O₃=100˜8000.

Optionally, in step a), R/Al₂O₃=0.1˜40.

Optionally, the organic templating agent R in step a) is at least one of nitrogen-containing heterocyclic compounds and derivatives thereof and quaternary ammonium compounds; the structural formula of it quaternary ammonium compound is as shown in formula II:

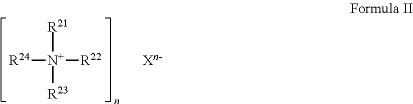

In formula II R²¹, R²², R²³ and R²⁴ are independently at least one of C₁˜C₁₂ alkyl, C₁˜C₁₂ alkoxy, C₁˜C₁₂ hydroxyalkyl, aryl and adamantyl;

Xⁿ⁻ is one of OH⁻, Cl⁻, Br⁻, I⁻, NO₃⁻, HSO₄⁻, H₂PO₃⁻, SO₄²⁻, HPO₃²⁻, and PO₃³⁻.

Optionally, the organic templating agent R in step a) is at least one of tetraethylammonium hydroxide, tetrapropylammonium hydroxide, tetrabutylammonium hydroxide, tetrapentylammonium hydroxide, tetrahexylammonium hydroxide, tetrapropylammonium bromide, tetrabutylammonium chloride, tetrapentylammonium bromide, tripropyl-isobutyl ammonium bromide, tributyl-cyclohexylammonium hydroxide, dibutyl-dihexyl ammonium hydroxide, choline triethyl-hydroxyethyl ammonium hydroxide, tripropyl-hydroxyethyl ammonium hydroxide, tributyl-hydroxyethyl ammonium hydroxide, tributyl-benzyl ammonium hydroxide, triethyl-benzyl ammonium hydroxide tripropyl-benzyl ammonium hydroxide, N,N,N-triethyl-adamantyl ammonium chloride, and N,N,N-tripropyl-adamantyl ammonium chloride.

Optionally, the nitrogen-containing heterocyclic templating agent R in step a) is at least one of nitrogen-containing heterocyclic compounds and derivatives thereof.

Optionally, in step a), the nitrogen-containing heterocyclic templating agent R is at least one of pyridine, N-methylpyridine, N-ethylpyridine, N-propylpyridine, N-butylpyridine, N-ethyl-3-butylpyridine, 1-ethyl-2-propylpyridine hydroxide, piperidine N,N-dimethylpiperidine, N,N-dimethyl-3,5-diethylpiperidine hydroxide, N,N-dimethyl-3,5-dipropylpiperidine hydroxide, N,N-diethyl-3,5-dipropylpiperidine hydroxide, N,N-diethyl-2,6-dimethylpiperidine hydroxide, N,N-dimethyl-2,6-diethylpiperidine hydroxide, imidazole, 1-ethyl-3-butylimidazole hydroxide, 1-ethyl-3-butyl-4-propylimidazole-4-propylimidazole hydroxide, 1-benzyl-3-methylimidazole hydroxide, 1-benzyl-3-ethylimidazole hydroxide, 1-butyl-3-butylimidazole hydroxide, piperazine, N-methylpiperazine, 1,4-dipropylpiperazine, 1-methyl-4-ethylpiperazine, and 1-ethyl-4-butyl-5-methylpiperazine.

Optionally the silicon source in step a) is at least one of methyl orthosilicate, ethyl orthosilicate, silica sol, solid silica gel, fumed silica, and sodium silicate;
the aluminum source in step a) is at least one of sodium aluminate, aluminum oxide, aluminum hydroxide, aluminum isopropoxide, aluminum 2-butoxide, aluminum chloride, aluminum sulfate, aluminum nitrate, and pseudo-boehmite:
the alkali metal source in step a) is at least one of sodium hydroxide, potassium hydroxide, and cesium hydroxide.

Optionally step a) comprises mixing the aluminum source, the alkali metal source, the organic templating agent R, and water, and then adding the silicon source to mix to obtain an initial gel mixture I.

Optionally, the aluminum source, silicon source, alkali metal source, organic templating agent R and water in the raw materials in step a) have the following molar ratios:

SiO₂/Al₂O₃=10˜200;

M₂O/Al₂O₃=0˜30. wherein M is at least one of alkali metal elements:

R/Al₂O₃=1˜45.

H₂O/Al₂O₃=100˜6000.

Optionally, the upper limit of SiO₂/Al₂O₃ is 15, 20, 30, 40, 45, 50, 60, 70, 93, 90, 100, 110, 120, 130, 140, 150, 160, 170, 180, 190 or 200, and the lower limit thereof 10, 15, 20, 30, 40, 45, 50, 60. 70, 80, 90, 100, 110, 120, 130, 140, 150, 160, 170, 180 or 190.

Optionally, the upper limit of M₂O/Al₂O₃ is 1.8, 2.0, 3.0, 4.0, 4.5, 4.8, 5.0, 6.0, 7.0, 8.0, 9.0, 10, 11, 12, 13, 14, 15, 16, 17, 18, 19, 20, 22, 25, 28, 29 or 30; the lower limit thereof is 0.1, 1.8, 2.0, 3.0, 4.0, 4.5, 4.5, 4.8, 5.0, 6.0, 7.0, 8.0, 9.0, 10, 11. 12, 13, 14, 15, 16, 17, 18, 19, 20, 22, 25, or 28.

Optionally, the upper limit of the malar ratio of R/Al₂O₃ is 2, 3, 3.6, 4, 4.5, 4.8, 5, 5.2, 6, 7, 8, 9, 10, 11, 12, 13, 14, 15, 16, 17, 18, 19, 20, 22, 25, 28, 29, 30, 32, 35, 38, 40, 42 or 45: the lower limit thereof is 1, 2, 3, 3.6, 4, 4.5, 4.8, 5, 5.2, 6, 7, 8, 9, 10, 11, 12, 13, 14, 15, 16, 17, 18, 19, 20, 22, 25, 28, 29, 30, 32, 35, 38, 40, or 42.

Optionally the upper limit of the molar ratio of R/Al₂O₃ is 200, 300, 400, 500, 603, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3400, 3200, 3500, 3800, 4000, 5000 or 6000; the lower limit thereof is 100, 200, 300, 400, 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3200, 3500, 3800, 4000 or 5000.

Optionally, in step b), the silica-alumina molecular sieve seed crystal having FAU or EMT topology is added to the initial gel mixture I obtained in step a), and after stirring and mixing, the mixture II is obtained.

Optionally, in step b), the stirring is performed for 1 to 48 hours.

Optionally, the upper limit of the stirring time in step b) is 48 hours, 44 hours, 40 hours, 36 hours, 32 hours, 28 hours, 24 hours, 20 hours, 16 hours, 12 hours, 8 hours, 4 hours, or 2 hours; the lower limit thereof is 1 hour, 2 hours, 4 hours, 8 hours, 12 hours, 16 hours, 20 hours, 24 hours, 28 hours, 32 hours, 36 hours 40 hours or 44 hours.

Optionally, the weight ratio of silica alumina molecular sieve seed crystal having FAU or EMT topology added in the mixture II in step b), to the silicon source in the initial gel mixture I ranges from 0.01:1 to 0.3:1;

wherein, the weight of the silicon source in the initial gel mixture I is calculated by the weight of SiO₂.

Optionally, the silica-alumina molar ratio SiO₂/Al₂O₃ of the silica-alumina molecular sieve seed crystal having FAU or EMT topology in step b) is 2˜∞.

Optionally, the silica-alumina molar ratio SiO₂/Al₂O₃ of the silica-alumina molecular sieve seed crystal having FAU or EMT topology in step b) ranges from 2.5 to 200.

Optionally, a crystallization temperature in step c) from 90 to 180° C. and a crystallization time in step c) ranges from 0.1 to 15 days.

Optionally, the upper limit of the crystallization temperature in step c) is 100° C., 120° C., 140° C., 160° C., or 180° C., and the lower limit thereof is 80° C., 90° C., 100° C., 110° C., 120° C., 140° C. or 160° C.

Optionally, the upper limit of crystallization time in step c) is 0.1 day, 0.5 day, 1 day, 1.5 days, 2.5 days, 4 days, 5 days or 6 days, and the lower limit thereof is 2 days, 4 days, 5 days, 6 days, 7 days, 8 days, 9 days or 10 days.

Optionally, the upper limit of the silica-alumina molar ratio SiO₂/Al₂O₃ of the silica-alumina molecular sieve seed crystal having FAU or EMT topology in step b) is 2.5, 3, 4, 5, 6, 7, 8, 9, 10, 11, 12, 13, 14, 15, 16, 17, 18, 19, 20, 21, 22, 23, 24, 25, 26, 27, 28, 29, 30; the lower limit thereof is 2.2, 3, 4, 5, 6, 7, 8, 9, 10, 11, 12, 13, 14, 15, 16, 17, 18, 19, 20, 21, 22, 23, 24, 25, 26, 27, 28 or 29.

Optionally, the silica-alumina moles ratio SiO₂/Al₂O₃ of the silica-alumina molecular sieve seed crystal having FAU or EMT topology is step b) ranges from 3 to 10.

Optionally, the crystallization in step c) is performed dynamically or statically.

Optionally, the crystallization in step c) is rotational crystallization.

Optionally, in step c), after the crystallization is completed the obtained solid product is filtered, washed and dried to obtain the high-silica Y molecular sieve.

In the method, washing, filtering, separating and drying the obtained Y molecular sieve are all conventional operations, wherein the drying can be performed by placing the separated Y molecular sieve at a temperature ranging from 100 to 110° C. for 12 hours.

In a specific embodiment, the synthesis process of the high-silica Y molecular sieve is as follows:
a1) preparation of synthetic gel: mixing and stirring aluminum source, silicon source, alkali metal source (M), nitrogen-containing heterocyclic templating agent R. and deionized water according to following molar ratio 1Al₂O₃:(10˜200) SiO₂:(0.1˜25) M₂O:(1˜45) R:(50˜6000) H₂O uniformly at room temperature to prepare the initial gel, then adding a certain amount of seed crystal therein, and stirring the obtained mixture for a time ranging from 1 to 48 hours to obtain the synthetic gel;
b1) synthesis of high-silica Y molecular sieve: performing crystallization of the above synthetic gel under the autogenous presume and a temperature ranging from 90 to 180° C. for a time ranging from 0.2 to 15 days, and after the crystallization is completed, filtering and separating the obtained solid product, washing the solid product with deionized water to be neutrality, and drying the solid product to obtain the high-silica Y molecular sieve.

As a specific embodiment, the method comprises following steps:
a) mixing aluminum source, silicon source, alkali metal source, organic templating agent R and water as raw materials to prepare the initial gel mixture I wherein the aluminum source, silicon source, alkali metal source, organic templating agent R and water in the raw materials have the following molar ratios:
SiO₂/Al₂O₃=10˜200;
M₂O/Al₂O₃=0˜30, wherein M is at least one of alkali metal elements;
R/Al₂O₃=1˜45;
H₂O/Al₂O₃=100˜8000;
b) adding silica-alumina molecular sieve seed crystal having FAU or EMT topology to the initial gel mixture I obtained in step a) to obtain a mixture II;
c) placing the mixture II obtained in step b) in a sealed reactor to perform crystallization, wherein a crystallization temperature ranges from 80 to 180° C., the crystallization pressure is autogenous pressure, and a crystallization time ranges from 0.1 to 15 days; and after the crystallization is completed, separating, washing and drying the obtained product to obtain the high-silica Y molecular sieve having FAU topology;
wherein, the number of moles of silicon source is calculated by SiO₂; the number of moles of aluminum source is calculated by Al₂O₃; the number of moles of templating agent R is calculated by the number of moles of R itself; and the number of moles of alkali metal source is calculated by the number of moles of corresponding metal oxide M₂O.

As an embodiment, the synthesis process of the high-silica Y molecular sieve having FAU topology is as follows:
a) preparation of the initial gel mixture; mixing and stirring uniformly aluminum source, silicon source, alkali metal source, organic templating agent R and deionized water at room temperature to prepare the initial gel mixture according to the following ratio:
SiO₂/Al₂O₃=10˜200;
M₂O/Al₂O₃=0˜30, wherein M is at least one of alkali metal elements;
R/Al₂O₃=1˜45:
H₂O/Al₂O₃=100˜8000;
b) adding silica-alumina molecular sieve seed crystal hiving FAU or EMT topology to the initial gel mixture obtained in step a), and then stirring uniformly; wherein the weight ratio of the added seed crystal to the silicon source in the initial gel mixture ranges from 0.01:1 to 0.3:1;
c) performing crystallization of the mixture obtained in step b) under the autogenous pressure and a temperature ranging from 80 to 180° C. for a time ranging from 0.1 to 15 days, and after the crystallization is completed, filtering and separating the obtained solid product, washing, the solid product with deionized water to be neutrality, and drying the solid product to obtain the Y molecular sieve.

According to further aspect of the present application, a directing agent method for synthesizing high silica Y molecular sieve having FAU topology Y provided.

The method for synthesizing high-silica Y molecular sieve having FAU topology is characterized in that it comprises the following steps:
a) mixing the raw materials I containing aluminum source A¹, silicon source Si¹, alkali metal source M¹, organic templating agent R¹ and water, and aging to obtain directing agent;
wherein, the aluminum source A¹, silicon source Si¹, alkali metal source M¹, organic templating agent R¹ and water in the raw materials I have the following molar ratios:
SiO₂/Al₂O₃=5˜31;
M¹₂O/Al₂O₃=0˜7, atm M¹ is least one of alkali meal elements;
R¹/Al₂O₃=1˜40;
H₂O/Al₂O₃=100˜600;
b) mixing raw materials II containing aluminum source A² silicon source Si², alkali metal source M² organic templating agent R², and water to prepare an initial gel;
wherein, the aluminum source A². silicon source Si², alkali metal source M², organic templating agent R² and water in the raw materials II have the following molar ratios:
SiO₂/Al₂O₃=10˜200;
M²₂O/Al₂O₃=3˜30. wherein M² is at least one of alkali metal elements;
R²/Al₂O₃=1˜40;
H₂O/Al₂O₃=100˜600;
c) adding the directing agent in step a) to the initial gel in step b) and after mixing uniformly, placing the obtained mixture in a sealed reactor for crystallization to obtain the high-silica Y molecular sieve having FAU topology.
wherein the number of moles of silicon source Si¹ and Si² is respectively calculated by SiO₂, the number of moles of source A¹ and A² is respectively calculated by Al₂O₃; the number of moles of templating agent R¹ and R² is respectively calculated by the number of moles of themselves: and the number of moles of alkali metal source M¹ and M² is respectively calculated by the number of moles of corresponding metal oxide M¹₂O and M²₂O.

Optionally the aluminum source A¹, silicon source Si¹, alkali metal source M¹, organic templating agent R¹ and water in the raw materials I in step a) have the following molar ratios:
SiO²/Al₂O₃=5˜30;
M¹₂O/Al₂O₃=₀˜3, wherein M¹ is at least one of alkali meal elements;
R¹/Al₂O₃=5˜40;
H₂O/Al₂O₃=100˜600.

Optionally, the upper limit of the molar ratio of SiO₂/Al₂O₃ is till 6.0, 7.0, 8.0, 9.0, 10, 11, 12, 13, 14, 15, 20 or 30 and the lower limit thereof is 5.0, 6.0, 7.0, 8.0, 9.0, 10, 11, 12, 13, 14, 15 or 20.

Optionally, the upper limit of the molar ratio of M₂O/Al₂O₃ in step a) is 0.5. 1.8, 2.0, 3.0, 4.0, 4.5, 4.8 or 5.0, and the lower limit thereof is 0.1, 0.5, 1.8, 2.0, 3.0, 4.0, 4.5 or 4.8.

Optionally, the upper limit of the molar ratio of R/Al₂O₃ in step a) is 2, 3, 4, 5, 6, 7, 8, 9, 10, 11, 12, 13, 14, 15, 16, 17, 18, 19, 20, 22, 25, 28, 29, 30, 32, 35, 34, 38 or 40, and the lower limit thereof is 1, 2, 3, 4, 5, 6, 7, 8, 9, 10, 11, 12, 13, 14, 15, 16, 17, 18, 19, 20, 22, 25, 28, 29, 30, 32, 35, 34, or 38.

Optionally, the upper limit of the molar ratio of H₂O/Al₂O₃ in step a) is 150, 180, 200, 250, 300, 350, 400, 450, 500, 550 or 600. and the lower limit thereof is 100, 150, 180, 200, 250, 300, 350, 400, 450, 500, or 550.

Optionally, the silicon sources Si¹ and Si² in step a) and step b) are independently at least one of methyl orthosilicate, ethyl orthosilicate, silica soL solid silica gel, fumed silica, and sodium silicate,
the aluminum sources A¹ and A² in step a) and step b) are independently at least one of sodium aluminate, aluminum oxide, aluminum hydroxide, aluminum isopropoxide, aluminum 3-butoxide, aluminum chloride, aluminum sulfate, aluminum nitrate and pseudo-boehmite,
the alkali metal sources M¹ and M² step a) and step b) are independently at least one of sodium hydroxide, potassium hydroxide, and cesium hydroxide.

Optionally, the organic templating agents R¹ and R² in step a) and step b) are independently one of nitrogen-containing heterocyclic compounds and derivative thereof and quaternary ammonium compounds;
the structural formula of the quaternary ammonium compound is as shown in formula II;

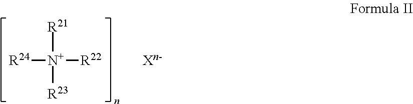

wherein, in formula II R²¹, R²², R²³ and R²⁴ independently at least one of C₁˜C₁₂ alkyl C₁˜C₁₂ alkoxy, C₁˜C₁₂ hydroxyalkyl, aryl and adamantyl; X^{t}^{ₙ} is one of OH⁻, Cl⁻, Br⁻, I⁻, NO₃⁻, HSO₄⁻, H₂PO₃⁻, SO₄²⁻, HPO₃²⁻, and PO₃³⁻.

Optionally, R¹ and R² are independently at least one of tetramethylammonium hydroxide, tetraethylammonium hydroxide, tetrapropylammonium hydroxide, tetrahexylammonium hydroxide, tetrapentylammonium hydroxide, tetrahexylammonium hydroxide tetrapropylammonium bromide, tetrabutylammonium chloride, tetrapentylammonium bromide, tripropyl-isoburylammonium bromide, triburyl-cyclohexylammonium hydroxide, dibutyl-dihexyl ammonium hydroxide, choline, triethyl-hydroxyethyl ammonium hydroxide, tripropyl-hydroxyethyl ammonium hydroxide, tributyl-hydroxyethyl ammonium hydroxide, tributyl-benzyl ammonium hydroxide, triethyl-benzyl ammonium hydroxide, tripropyl-benzyl ammonium hydroxide, N,N,N-triethyl-adamantyl ammonium chloride, and N,N,N-tripropyl-adamantyl ammonium chloride.

Optionally, R¹ is at least one of tetramethylammonium hydroxide, tetraethylammonium hydroxide, tetrapropylammonium hydroxide and choline:
R² is at least one of tetraethylammonium hydroxide, tetrapropylammonium hydroxide, tetrabutylammonium hydroxide, tetrapentylammonium hydroxide, tetrahexylammonium hydroxide, tetrapropylammonium bromide, tetrabutylammonium chloride, tetrapentylammonium bromide, tripropyl-isobutylammonium bromide, tributyl-cyclohexylammonium hydroxide, dibutyl-dihexyl ammonium hydroxide, choline, triethyl-hydroxyethyl ammonium hydroxide, tripropyl-hydroxyethyl ammonium hydroxide, tributyl-hydroxyethyl ammonium hydroxide, tributyl-benzyl ammonium hydroxide, triethyl-benzyl ammonium hydroxide, tripropyl-benzyl ammonium hydroxide, N,N,N-triethyl-adamantyl ammonium chloride, and N,N,N-tripropyl-adamantyl ammonium chloride.

Optionally, R¹ one of quaternary ammonium compounds;
the structural formula of the quaternary ammonium compound is as shown in formula II;

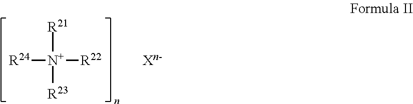

in formula II, R²¹, R²², R²³, and R²⁴ are independently at least one of C₁˜C₁₂ alkyl, C₁˜C₁₂ alkoxy, C₁˜C₁₂ hydroxyalkyl, aryl, and adamantyl; Xⁿ⁻ is one of OH⁻, Cl⁻, Br⁻, I⁻, NO²⁻, HSO₄⁻, H₂PO₃⁻, SO₄⁻, HPO₃⁻, and PO₃³⁻:
R² is at least one of nitrogen-containing heterocyclic compounds and derivatives thereof.

Optionally, R¹ at least one of tetramethylammonium hydroxide tetraethylammonium hydroxide, tetrapropylammonium hydroxide and choline.

Optionally, R² is at least one of pyridine, N-methylpyridine, N-ethylpyridine, N-propylpyridine, N-butylpyridine, N-ethyl-3-butylpyridine, 1-ethyl-2-propylpyridine hydroxide, piperidine N,N-dimethylpiperidine, N,N-dimethyl-3,5-diethylpiperidine hydroxide, N,N-dimethyl-3,5-dipropylpiperidine hydroxide, N,N-diethyl-3,5-dipropylpiperidine hydroxide, N,N-diethyl-2,6-dimethylpiperidine hydroxide, N,N-dimethyl-2,6-diethylpiperidine hydroxide, imidazole, 1-ethyl-3-butylimidazole hydroxide, 1-ethyl-3-butyl-4-propylimidazole hydroxide, 1-benzyl-3-methylimidazole hydroxide, 1-benzyl-3-ethylimidazole hydroxide, 1-benzyl-3-butylimidazole hydroxide piperazine, N-methylpiperazine, 1,4-dipropylpiperazine, 1-methyl-4-ethylpiperazine, and 1-ethyl-4-butyl-5-methylpiperazine.

Optionally, an aging temperature in step a) rangs from 25 to 140° C. for an aging time in a range from 0.5 to 30 days.

Optionally, the upper limit of the aging temperature is 30° C., 35° C., 40° C., 45° C., 50° C., 55° C., 60° C., 65° C., 70° C., 75° C., 80° C., 85° C., 90° C., 95° C., 100° C., 110° C., 120° C., 130° C. or 140° C., and the low kit limit is 20° C., 30° C., 35° C., 40° C., 45° C., 50° C., 55° C., 60° C., 65° C., 70° C., 75° C., 80° C., 85° C., 90° C., 95° C., 100° C., 110° C. 120° C., or 130° C.

Optionally, the upper limit of aging time is 1 day, 2 days, 3 days, 4 days, 5 days, 6 days, days, 8 days, 9 days, 10 days, 11 days, 12 days, 13 days, 14 days, 15 days, 18 days, 20 days, 25 days or 30 days, and the lower limit thereof is 0.5 day, 1 day, 2 days, 3 days, 4 days, 5 days, 6 days, 7 days, 8 days, 9 days, 10 days, 11 days, 12 days, 13 days, 14 days, 15 days, 18 days, 20 days or 25 days.

Optionally, as aging temperature in step a) range from 25 to 140° C. far as aging time in a range from 1 to 30 days.

Optionally, an aging temperature in step a) ranges from 30 to 120° C. for an aging time in a range from 1 to 25 days.

Optionally, the aging in step a) is a two-stage aging, the temperature for the first stage aging ranges firm 30 to 40° C., the time for the first stage aging ranges from 0.5 to 5 days while the temperature for the second stage aging ranges from 50 to 100° C., and the time for second stage aging ranges from 2 to 8 days.

Optionally, step a) comprises: mixing the aluminum source A¹, the alkali metal source M¹, the organic templating agent R¹ and water uniformly, adding the silicon source S¹ therein. stirring, mixing and it aging, wherein an aging temperature ranges from 25 to 140° C., and an aging time ranges from 1 to 30 days to obtain the directing agent.

Optionally, the aluminum source A², the silicon source Si², the alkali metal source M², the organic templating agent R², and water in step b) have the following molar ratios:
SiO₂/Al₂O₃=10˜200:
M²₂O/Al₂O₃=0˜30, wherein M² is at least one of alkali metal elements;
R²/Al₂O₃=1˜45;
H₂O/Al₂O₃=100˜6000.

Optionally, the aluminum source A², silicon source Si², alkali metal source M², organic templating agent R², and water in the raw material II in step b) have the following molar ratios:
SiO₂/Al₂O₃=10˜200;
M²₂O/Al₂O₃=0˜30, wherein M² if is at least one of alkali metal elements;
R²/Al₂O₃=1˜45;
H₂O/Al₂O₃=100˜4000.

Optionally, the upper limit of the molar ratio of SiO₂/Al₂O₃ in step b) is 15, 20, 30, 40, 45, 50, 60, 70, 80, 90, 100, 110, 120, 130, 140, 150, 160, 170, 180, 190 or 200: and the lower limit thereof is 10, 15, 20, 30, 40, 45, 50, 60, 70, 80, 90, 100, 110, 120, 130, 140, 150, 160, 170, 180, or 190.

Optionally the upper limit of the molar ratio of M₂O/Al₂O₃ in step b) 1.8, 2.0, 3.0, 4.0, 4.5, 4.8, 5.0. 6.0, 7.0, 8.0. 9.0, 10, 11, 12, 13, 14, 15, 16, 17, 18, 19, 20, 22, 25, 28, 29 or 30, and the lower limit hereof is 0.1, 1.8, 2.0, 3.0, 4.0, 4.5, 4.5, 5.0, 6.0, 7.0, 8.0, 9.0, 10, 11, 12, 13, 14, 15, 16, 17, 18, 19, 20, 22, 25, or 28.

Optionally, the upper limit of the molar ratio of R/Al₂O₃ in step b) is 2, 3, 3.6, 4, 4.5, 4.8, 5, 5.2, 6, 7, 8, 9, 10, 11, 12, 13, 14, 15, 16, 17, 18, 19, 20, 22, 25, 28, 29, 30, 32, 35, 38, 40, 42 or 45, and the bitter limit thereof is 1, 2, 3, 3.6, 4, 4.5, 4.8, 5, 5.2, 6, 7, 8, 9, 10, 11, 12, 13, 14, 15, 16, 17, 18, 19, 20, 22, 25, 28, 29, 30, 32, 35, 38, 40, or 42.

Optionally the upper limit of the molar ratio of H₂O/Al₂O₃ in step b) is 200, 300, 400, 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3200, 3500, 3800, 4000, 5000 or 6000, and the lower limit thereof is 100, 200, 300, 400, 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3200, 3500, 3800, 4000 or 5000.

Optionally the weight ratio of the silica in the directing agent to the silica in the initial gel in step c) ranges from 0.01:1 to 0.3:1.

Optionally the weight ratio of the silica in the directing agent to the silica in the initial gel in step c) is airy one of the following mike or a range ratio defined by any two ratios; 0.01:1, 0.02:1, 0.03:1, 0.04:1, 0.05:1, 0.06:1, 0.07:1, 0.08:1, 0.091, 0.1:1, 0.11:1, 0.12:1, 0.13:1, 0.14:1, 0.15:1, 0.16:1, 0.23:1, 0.25:1, 0.30:1.

Optionally, the weight ratio of the silica in the directing agent to the silica in the initial gel in step c) ranges from 0.01:1 to 0.3:1.

Optionally, the weight ratio of the silica in the directing agent to the silica in the initial gel in step c) ranges from 0.01:1 to 0.2:1.

Optionally, a crystallization temperature in step c) ranges from 90 to 180° C. for the crystallization time in a rage from 1 to 15 days.

Optionally, the upper limit of the crystallization temperature is 100° C., 120° C., 140° C., 160° C., or 180° C. while the lower limit of the crystallization temperature 90° C., 100° C., 110° C., 140° C., or 150° C.

Optionally the upper limit of the crystallization time in step c) is 2 days, 3 days, 4 days, 5 days, 6 days, 7 days, 8 days, 9 days, 10 days, 11 days, 12 days, 13 days, 14 days or 15 days, and the lower limit thereof is 2 days, 3 days, 4 days, 5 days, 6 days, 7 days, 8 days, 9 days, 10 days, 11 days, 12 days, 13 days or 14 days.

Optionally, a crystallization temperature in step c) ranges from 90 to 140° C. for the crystallization time in a range from 3 to 15 days.

Optionally, the crystallization in step c) is performed dynamically or statically.

Optionally, the crystallization in step c) is performed in a combination of dynamical and statical manners.

Optionally, the crystallization in step c) is rotational crystallization.

Optionally, step c) includes: adding the directing agent in step a) to the initial gel in step b), stirring and mixing, and then placing the obtained mixture in a sealed reactor to perform crystallization to obtain the high-silica Y molecular sieve having FAU topology.

Optionally, in step c), the stirring is performed for 1 to 48 hours.

Optionally, the upper limit of the stirring time is 48 hours, 44 hours, 40 hours, 36 hours, 32 hours, 28 hours, 24 hours, 20 hours, 16 hours, 12 hours, 8 hours, 4 hours or 2 hours, and the lower limit thereof is 1 hour, 2 hours, 4 hours, 8 hours, 12 hours, 16 hours, 20 hours, 24 hours, 28 hours, 32 hours, 36 hours, 40 hours or 44 hours.

Optionally, step c) includes: adding the directing agent in step a) to the initial gel in step b), mixing uniformly and placing the obtained mixture in a sealed reactor to perform crystallization, wherein a crystallization temperature ranges from 90 to 140° C., and a crystallization time ranges from 3 to 15 days; after the crystallization is completed, separating, washing, and drying the obtained solid to obtain the high-silica Y molecular sieve having FAU topology.

Optionally, the method comprises the following steps:
a) mixing the raw materials I containing aluminum source A¹, silica source Si¹, alkali metal source M¹, organic templating agent R¹ and water, and aging to obtain a directing agent;
wherein, the aluminum source A¹, silicon source Si¹, alkali metal source M¹, organic templating agent R¹ and water in the raw materials I have the following molar ratios:
SiO₂/Al₂O₃=5˜30;
M¹₂O/Al₂O₃=0˜5, wherein M¹ is at least one of alkali metal elements;
R¹/Al₂O₃=5˜40;
H₂O/Al₂O₃=100˜600.
b) mixing the raw materials II containing aluminum source A², silicon source Si², alkali metal source M², organic templating agent R², and water to prepare the initial gel;
the aluminum source A², silicon source Si², alkali metal source M², organic templating agent R², and water in the raw materials II have the following molar ratios:
SiO₂/Al₂O₃=5˜30;
M²₂O/Al₂O₃=0˜30, wherein M² is at least one of alkali metal elements;
R²/Al₂O₃=1˜45;
H₂O/Al₂O₃=100˜6000.
c) adding the directing agent in step a) to the initial gel in step b), mixing uniformly and placing the obtained mixture in a sealed reactor to perform crystallization, wherein a crystallization temperature ranges from 90 to 180° C., and a crystallization time ranges from 2 to 15 days; after the crystallization is completed, separating, washing, and drying the obtained solid to obtain the high-silica Y molecular sieve having FAU topology.
wherein, the number of mole of silicon source Si¹ and Si² is respectively calculated by SiO₂; the number of moles of aluminum source A¹ and A² respectively calculated by Al₂O₃; the number of moles of templating agent R¹ and R² is respectively calculated by the number of moles of themselves; and the number of moles of alkali metal source M¹ and M² is respectively calculated by the number of moles of corresponding metal made M¹₂O and M²₂O.

As an embodiment, the synthesis process of the high-silica molecular sieve is as follows:
a) preparation of directing agent mixing and stirring aluminum source, silicon source, organic templating agent R¹ and deionized water for 2 hours according to following molar ratio 1Al₂O₃:(5˜30) SiO₂: (0˜7) M¹₂O:(1˜40) R¹:(100˜600) H₂O to obtain a uniform mixture, and then stirring/standing the obtained mixture at a temperature range from 25 to 140° C. for a time ranging from 1 to 30 days to obtain the directing agent.
b) preparation of synthetic gel: mixing and stirring aluminum source, silicon source, sodium hydroxide organic templating agent R² and deionized water according to the following ratio uniformly at room temperature to obtain the initial gel
SiO₂/Al₂O₃=10˜200;
M²₂O/Al₂O₃=0˜30, wherein M² is at least one of alkali metal elements;
R²/Al₂O₃=1˜45;
H₂O/Al₂O₃=100˜8000.
then adding a certain amount of the directing agent in step a) therein and stirring for a time ranging from 1 to 4 hours to obtain the synthetic gel;
c) synthesis of high-silica Y molecular sieve: performing crystallization of the above synthetic gel at a temperature ranging from 90 to 180° C. under autogenous pressure for a time ranging form 2 to 15 days, after the crystallization is completed, filtering and separating the obtained solid product, washing the solid product with deionized water to be neutrality, and drying the solid product to obtain the high-silica Y molecular sieve.

According to another aspect of the present application, there is provided use of the high-silica Y molecular sieve prepared by the above method in fluid catalytic cracking (FCC), wherein the prepared molecular sieve has a high silica alumina oxide ratio ranging from 7 to 30, good hydrothermal/thermal stability, and has good catalytic reaction ativity.

The anhydrous chemical constitution of the molecular sieve is shown in formula I:

kM.mR1.mR2.(SiₓAl_{y})O_{z} Formula I
wherein, M is at least one of alkali metal elements;
R1 and R2 represent organic templating agents;
k represents the number of moles of alkali metal element M per mole (SiₓAl_{y})O_{z} k=0˜0.02.
m and n represents the number of moles of templates agars R1 and R2 per mole of (SiₓAl_{y})O_{z}, m=0˜0.20, n=0.01˜0.20.
x and y respectively represent the mole fractions of Si and Al, 2x/y=7˜40, and x−y=1;
R1 and R2 are independently one of nitrogen-containing heterocyclic compound and derivatives thereof, and quaternary ammonium compounds;

the structural formula of the quaternary ammonium compound is as shown in formula II;

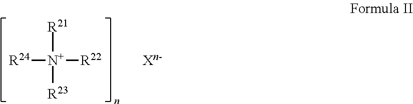

wherein, in formula II, R²¹, R²², R²³ and R²⁴ are independently at least one of C₁˜C¹² alkyl, C₁˜C₁₂ alkoxy, C₁˜C₁₂ hydroxyalkyl, aryl and adamantyl;

Xⁿ⁻ is one of OH⁻, Cl⁻, Br⁻, I⁻, NO₃⁻, HSO₄⁻, H₂PO₃⁻, SO₄²⁻, HPO₃²⁻, and PO₃³⁻.

Optionally, m=0.01˜0.20.

Optionally, k=0.01˜0.15; m=0.01˜0.1; n=0.02˜0.15.

Optionally k=0.02˜0.13; m=0.01˜0.04; n=0.03˜0.08.

Optionally the “C₁˜C₁₂ alkyl” includes “C₁˜C₁₂ phenyl alkyl”.

Optionally, the “aryl” includes “C₇˜C₁₂ aryl”.

Optionally, the “C₇˜C₁₂ aryl” includes “C₇˜C₁₂ alkyl aryl”.

Optionally, M is at least one of Na, K, and Cs, and 2x/y=7˜30.

Optionally, M is at least one of Na, K, and Cs, and 2x/y=8˜30.

Optionally, the upper limit of 2x/y is 8, 9, 10, 11, 12, 13, 14, 15, 16, 17, 18, 19, 20, 21, 22, 23, 24, 25, 26, 27, 28, 29 or 30, and the lower limit thereof is 7, 8, 9, 10, 11, 12, 13, 14, 15, 16, 17, 18, 19, 20, 22, 23, 24, 25, 26, 27, 28 or 29.

Optionally, R1 and R2 are independently one of quaternary ammonium compounds,

Optionally, R1 and R2 are independently at least one of tetramethylammonium hydroxide tetraethylammonium hydroxide, tetrapropylammonium hydroxide tetrabutylammonium hydroxide, tetrapentylammonium hydroxide, tetrahexylammonium hydroxide, tetrapropylammonium bromide, tetrabutylammonium chloride, tetrapentylammonium bromide, tripropyl-isobutylammonium bromide, tributyl-cyclohexylammonium hydroxide, dibutyl-dihexyl ammonium hydroxide, choline, triethyl-hydroxyethyl hydroxide, tripropyl-hydroxyethyl ammonium hydroxide, tributyl-hydroxyethyl ammonium hydroxide tributyl-benzyl ammonium hydroxide, triethyl-benzyl ammonium hydroxide, tripropyl-benzyl ammonium hydroxide, N,N,N-triethyl-adamantyl ammonium chloride, and N,N,N-tripropyl-adamantyl ammonium chloride.

Optionally R1 is at least one of tetramethylammonium hydroxide, tetraethylammonium hydroxide, tetrapropylammonium hydroxide, and choline;
R2 is at least one of tetraethylammonium hydroxide, tetrapropylammonium hydroxide, tetrabutylammonium hydroxide, tetrapentylammonium hydroxide, tetrahexylammonium hydroxide, tetrapropylammonium bromide, tetrabutylammonium chloride, tetrapentylammonium bromide, tripropyl-isobutyl ammonium hydroxide, tributyl-cyclohexylammonium hydroxide, dibutyl-dihexyl ammonium hydroxide, choline, triethyl-hydroxyethyl ammonium hydroxide, tripropyl-hydroxyethyl ammonium hydroxide, tributyl-hydroxyethyl ammonium hydroxide, tributyl-benzyl ammonium hydroxide, triethyl-benzyl ammonium hydroxide, tripropyl-benzyl ammonium hydroxide, N,N,N-triethyl-adamantyl ammonium chloride, and N,N,N-tripropyl-adamantyl ammonium chloride.

Optionally, R1 is at least one of quaternary ammonium compound and R2 is at least one of nitrogen-containing heterocyclic compounds and derivatives thereof.

Optionally, R1 is at least one of tetramethylammonium hydroxide, tetraethylammonium hydroxide, tetrapropylammonium hydroxide and choline;
R² is at least one of nitrogen-containing heterocyclic compounds and derivatives thereof.

Optionally, R² is at least one of pyridine, N-methylpyridine, N-ethylpyridine, N-propylpyridine, N-butylpyridine, N-ethyl-3-butylpyridine, 1-ethyl-2-propylpyridine hydroxide, piperidine, N,N-dimethylpiperidine, N,N-dimethyl-3,5-diethylpiperidine hydroxide, N,N-dimethyl-3,5-dipropylpiperidine hydroxide, N,N-diethyl-3,5-dipropylpiperidine hydroxide, N,N-diethyl-2,6-dimethylpiperidine hydroxide, N,N-dimethyl-2,6-diethylpiperidine hydroxide, imidazole, 1-ethyl-3-butylimidazole hydroxide, 1-ethyl-3-butyl-4-propylimidazole hydroxide, 1-benzyl-3-methylimidazole hydroxide, 1-benzyl-3-ethylimidazole hydroxide, 1-benzyl-3-butylimidazole hydroxide, piperidine, N-methylpiperazine, 1,4-dipropylpiperazine, 1-methyl-4-ethylpiperazine, and 1-ethyl-4-butyl-5-methylpiperazine.

Optionally, the high-silica Y molecular sieve having FAU topology is an octahedral structure.

Optionally the particle size of the high-silica Y molecular sieve having FAU topology ranges from 50 mn to 2500 nm.

According to another aspect of the present application, there is provided a catalyst. The high-silica Y molecular sieve having FAU topology prepared according to the method described in the preset application can be used as a fluidized catalytic cracking catalyst and, support and catalyst for dual-function catalysis reaction such as hydrocracking, hydrogenation desulfurization and so on.

In the present application, dynamic crystallization means that the slurry in the crystallization reactor is in a non-stationary state, and static crystallization means that the slurry in the crystallization reactor is in a stationary state.

In the context of the present application, the term “silica-alumina ratio” refers to the molar ratio of silicon to aluminium in terms of SiO₂ and Al₂O₃ in the molecular sieve, which has the same meaning as “2x/y” and “silicon-aluminum oxide ratio”.

In the present application, C₁˜C₁₂, C₇˜C₁₂ and the like all refer to the number of carbon atoms contained in the group. For example, “C₁˜C₁₂ alkyl” refers to an alkyl having 1˜12 carbon atoms.

In the present application, “alkyl” is a group formed by the loss of any hydrogen atom on —OH group of the molecule of an alkane compound. The alkane compound includes straight chain alkanes, branched chain alkanes, cycloalkanes, and branched cycloalkanes.

In the present application, “alkoxy” is a group formed by the loss of hydrogen atoms on —OH group of the molecule of an alkyl alcohol compound. For example, the methoxy —OCH₇ is formed by the loss of the hydrogen atom on the —OH group of the CH₇OH molecule.

In the present application, “hydroxyalkyl” is a group formed by the loss of any one hydrogen atom on non —OH group of the molecule of an alkyl alcohol compound. For example, the hydroxymethyl HOCH₇ is formed by the loss of the hydrogen atom on the methyl of the CH₇OH molecule.

In the present application, “aryl” is a group formed by the loss of one hydrogen atom in the aromatic ring of an aromatic compound. For example, p-methylphenyl is formed by the loss of the hydrogen atom on para position of methyl on the benzene ring.

In the present application, “alkylphenyl” refers to a group formed by the loss of a hydrogen atom on a bezene ring containing substituent. For example, p-methylphenyl is formed by the loss of the hydrogen atom on para position of methyl on the benzene ring.

In the present application, “phenylalkyl” refers to a group formed by the loss of one hydrogen atom of the alkyl substituent on the benzene ring. For example, the benzyl group (benzyl) is formed by the loss of one hydrogen atom of the methyl on toluene.

### BRIEF DESCRIPTION OF DRAWINGS

FIG. 1 is X-ray diffraction (XRD) spectrum of sample X #1.

FIG. 2 is scanning electron not microscope (SEM) image of sample X #1.

FIG. 3 is silicon nuclear magnetic (²⁹Si-NMR) spectrum of sample X #1.

FIG. 4 is X-ray diffraction (XRD) spectrum of sample V #1.

FIG. 5 is X-ray diffraction (XRD) spectrum of sample X1.

FIG. 6 is scanning electron microscole (SEM) image of sample X1.

FIG. 7 is silicon nuclear magnetic (²⁹Si-NMR) spectrum of sample X1.

FIG. 8 is X-ray diffraction (XRD) spectrum of the comparative sample V1.

FIG. 9 is X-ray diffraction (XRD) spectrum of sample Y #1.

FIG. 10 is scanning electron microscope (SEM) image of sample Y #1.

FIG. 11 is silicon nuclear magnetic (²⁹Si-NMR) spectrum of sample Y #1.

FIG. 12 is X-ray diffraction (XRD) spectrum of sample S1.

FIG. 13 is X-ray diffraction (XRD) spectrum of simple T1.

FIG. 14 is an X-ray diffraction (XRD) spectrum of sample Y1.

FIG. 15 is scanning electron scope (SEM) image of sample Y1.

FIG. 16 is silicon electron microscope (²⁹Si-NMR) spectrum of sample Y1.

FIG. 17 is X-ray diffraction (XRD) spectrum of the comparative sample S1.

FIG. 18 is X-ray diffraction (XRD) spectrum of the comparative sample T1.

### DETAILED DESCRIPTION

The present application will be described in detail below with reference to the examples, but the present application is not limited to these examples.

The analysis methods in the examples of the present application are as follows.

The X-ray powder diffraction phase analysis (XRD) of the product adopts to XPert PRO X-ray diffraction from PANalytical, the Netherlands. Cu target, Kα radiation source (λ=0.15418 nm), voltage 40 KV, current mA.

The instrument used in the scanning electron microscope (SEM) test is Hirachi SU8020 emission scanning electron microscope, and the accelerating voltage is 2 kV.

The elemental constitution was measured by Philips Magix 2424 X-ray fluorescence analyzer (XRF).

The silicon nuclear magnet (²⁹Si-NMR) experiment was carried out on a Braker Avance III 600 (14.1 Tesla) spectrometer using a 7 mm double resonance probe with a rotation speed of 6 kHz. Using high-power proton decoupling program, sampling times are 1024, ×4 pulse width is 2.5 μs, sampling delay is 10 s, and 4,4-dimethyl-4-propanesulfonate (DSS) is used as chemical shift reference which is calibrated to be 0 ppm.

The carbon nuclear magnetic (¹³C MAS NMR) experiment was carried out on a Braker Avance III 600 (14.1 Tesla) spectrometer using a 4 mm triple resonance probe with a rotation speed of 12 kHz, wherein amantadine was used as the chemical shift reference which was calibrated to be 0 ppm.

### Example 1: Preparation of Sample X #1

Preparation of synthetic gel: 0.7 g sodium aluminate (Al₂O₃:48.3 wt %, Na₂O: 35.3 wt %, China National Pharmaceutical (Group) Shanghai chemical Reagent Company), 0.20 g sodium hydroxide, 13.0 g tetrapropylammonium (25 wt %) were dissolved in 2.40 g deionized water and stirred until to be clear. 13.3 g silica gel (SiO₂: 30 wt %, Shenyang Chemical Co., Ltd) was added therein dropwise and stirred for 0.5 hour. Then 0.4 g Y zeolite as seed crystal with silica-alumina ratio of 3 was added, and stirring was continued for 2 hours.

Synthesis of high-silica Y zeolite: The synthetic gel was transferred into a stainless-steel reactor, and was subject to rotational crystallization at 130° C. for 5 days. After the crystallization was completed, the obtained solid was separated from liquid, washed to be neutrality, then dried at 100° C. for 12 hours. The obtained sample was denoted as sample X #1.

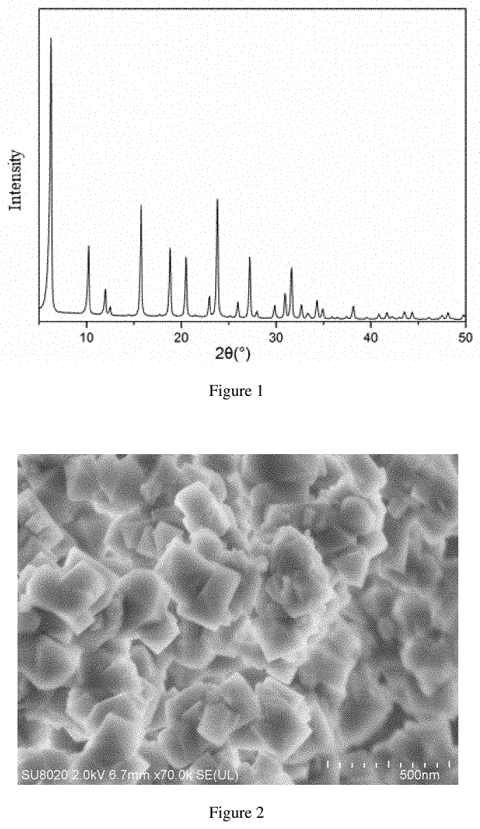

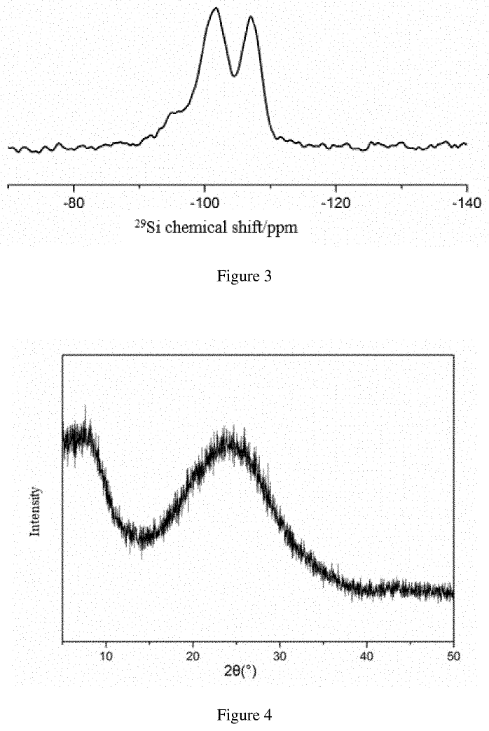

X-ray diffraction (XRD) spectrum of sample X #1 is shown in FIG. 1, demonstrating that the sample X #1 is molecular sieve having FAU framework structure. Scanning electron microscope (SEM) image thereof is shown in FIG. 2, demonstrating that the particles of sample X #1 are small pieces with a size rangy from 50 nm to 200 nm. ²⁹Si MAS NMR spectrum thereof is shown in FIG. 3. The firting calculation shows that the silica-alumina ratio in the framework is consistent with the calculation results conducted by XRF. According to the XRF and ¹³C MAS NMR normalization analysis, the element of constitution of sample X #1 is 0.07Na.0.07R2¹.(Si_{0.86}Al_{0.14})O₂, where R2¹ is tetrapropylammonium hydroxide.

### Example 2 Preparation of Samples X #2-X #30

The preparation process of any one of samples X #2-X #30 is the same as that of Example 1. The raw materials for preparing samples X #2-X #30, molar ratio thereof, addition amount of seed crystal (weight ratio of seed crystal to SiO₂ in gel), crystallization conditions, crystal structure, silica-alumina ration (the silica-alumina ratio of the obtained product is measured by X-ray fluorescence analyzer (XRF)) and the product constitutent are shown in Table 1.

Samples X #1-X #20 were prepared using silica-alumina molecular sieves having FAU topology as seed crystals, of which silica-alumina ratios were 3, 2.8. 3. 3.5, 45. 6. 6, 6, 6, 7, 70, 10. 4. 5, 6, 8, 3.5, 35, 12. 20 respectively, and which were purchased from Zibo Rumxin Chemical Technology Co., Ltd. Samples X #21-X #30 were prepared using silica-alumina molecular sieves having EMT topology as seed crystals, of which silica-alumina ratios were 10, 8, 8.5, 7, 7, 8, 21, 7, 8, 22 respectively, and which were purchased from Henan Huanyu Molecular Sieve Co., Ltd.

### Comparative Example 1 Preparation of Comparative Samples V #1-V #30

The specific types of raw materials for preparing synthetic gel, molar ratio thereof, preparation process and crystallization conditions are the same as those of sample X #1 in Example 1, except than the seed crystal addition step is omitted. The specific types of raw materials, molar ratio thereof, crystallization conditions, and crystal structure of the product are shown in Table 2. The obtained samples are denoted as comparative samples V #1-V #30.

### Example 3 Characterization and Analysis of Sample X #1-X #30 and Comparative Samples V #1-V #30

The phases of samples X #1-X #30 and comparative samples V #1-V #30 were analyzed by X-ray diffraction method.

The results show that each of the samples X #1-X #30 prepared in Examples 1 and 2 is Y molecular sieve with both high purity and high crystallinity. The XRD spectrum of sample X #1 as typical representative is shorn in FIG. 1, SEM image thereof is shown in FIG. 2, and Si NMR thereof is shown in FIG. 3. The XRD spectrum result of any one of samples X #2-X30 is close to FIG. 1. In other words, the diffraction peak positions and shapes are substantially identical. The relative peak intensity fluctuates within ±5% depending on the change of synthesis conditions, demonstrating that any of samples X #1-X #30 has the structural characteristics of Y zeolite and has no impurities. The silica-alumina ratio of any sample is much higher than that of conventional Y zeolite. The introduction of organic templating agent is the key to the synthesis of high-silica Y zeolite.

Each of V #1-V #30 as products in Table 2 is amorphous, and the XRD spectrum of the comparative sample V #1 as typical represenative is shown in FIG. 4. It can be seen that during the synthesis of high-silica Y zeolite, in addition to the organic templating agent, the introduction of seed crystal is also necessary.

TABLE 1
Types of raw materials, molar ratio thereof, addition amount of seed crystal, crystallization conditions,
crystal structure, silica-alumina ratio and product constitution of samples X#1-X#30

| | | Addition | | | | | | |
|---|---|---|---|---|---|---|---|---|
| | | amount | Crystal- | | Crystal- | | Silica- | |
| | | of seed | lization | | lization | Crystal | alumina | |
| Sample | Initial gel constitution | crystal | temperature | | time | structure | ratio | Product constitution |
| X#1 | 20SiO₂¹:1Al₂O₃ [symbol] :2.0Na₂O:4.8R2¹:360H₂O | 1% | 130° | C. | Dynamic | FAU | 12 | 0.07Na0.07R2¹(Si [symbol] Al [symbol] )O₂ |
| | | | | | 5 days | | | |
| X#2 | 15SiO₂¹:1Al₂O₃ [symbol] :1.8Na₂O:3.6R2¹:200H₂O | 3% | 130° | C. | Static | FAU | 9 | 0.09Na0.09R2¹(Si [symbol] Al [symbol] )O₂ |
| | | | | | 4 days | | | |
| X#3 | 20SiO₂¹:1Al₂O₃ [symbol] :1.8Na₂O:5.2R2¹:400H₂O | 12% | 110° | C. | Dynamic | FAU | 11 | 0.07Na0.08R2¹(Si [symbol] Al [symbol] )O₂ |
| | | | | | 6 days | | | |
| X#4 | 50SiO₂¹:1Al₂O₃ [symbol] :8.0Na₂O:13R2²:800H₂O | 8% | 140° | C. | Dynamic | FAU | 15 | 0.03Na0.07R2²(Si [symbol] Al [symbol] )O₂ |
| | | | | | 8 days | | | |
| X#5 | 20SiO₂²:1Al₂O₃ [symbol] :3.0Na₂O:5R2²:400H₂O | 15% | 120° | C. | Static | FAU | 8 | 0.08Na0.12R2²(Si [symbol] Al [symbol] )O₂ |
| | | | | | 6 days | | | |
| X#6 | 20SiO₂²:1Al₂O₃ [symbol] :3Na₂O:4.5R2³:400H₂O | 10% | 130° | C. | Static | FAU | 11 | 0.07Na0.08R2 [symbol] (Si [symbol] Al [symbol] )O₂ |
| | | | | | 3 days | | | |
| X#7 | 200SiO₂²:1Al₂O₃ [symbol] :25Na₂O:45R2 [symbol] :3000H₂O | 12% | 120° | C. | Dynamic | FAU | 28 | 0.02Na0.05R2 [symbol] (Si [symbol] Al [symbol] )O₂ |
| | | | | | 8 days | | | |
| X#8 | 50SiO₂²:1Al₂O₃ [symbol] :7Na₂O:11R2 [symbol] :800H₂O | 8% | 140° | C. | Dynamic | FAU | 18 | 0.03Na0.07R2 [symbol] (Si [symbol] Al [symbol] )O₂ |
| | | | | | 6 days | | | |
| X#9 | 60SiO₂²:1Al₂O₃ [symbol] :8.0Na₂O:15R2 [symbol] :900H₂O | 9% | 140° | C. | Dynamic | FAU | 20 | 0.03Na0.06R2 [symbol] (Si [symbol] Al [symbol] )O₂ |
| | | | | | 2 days | | | |
| X#10 | 100SiO₂²:1Al₂O₃ [symbol] :20Cs₂O:10R2⁴:800H₂O | 5% | 180 | | Dynamic | FAU | 35 | 0.01Cs0.02R2⁴(Si [symbol] Al [symbol] )O₂ |
| | | | | | 0.2 day | | | |
| X#11 | 30SiO₂²:1Al₂O₃ [symbol] :4.0Na₂O:7R2⁴:500H₂O | 14% | 120° | C. | Static | FAU | 13 | 0.07Na0.06R2⁴(Si [symbol] Al [symbol] )O₂ |
| | | | | | 3 days | | | |
| X#12 | 150SiO₂²:1Al₂O₃ [symbol] :15K₂O:20R2⁴:1500H₂O | 16% | 160° | C. | Dynamic | FAU | 40 | 0.01K0.01R2⁴(Si [symbol] Al [symbol] )O₂ |
| | | | | | 0.5 day | | | |
| X#13 | 30SiO₂²:1Al₂O₃ [symbol] :4.0Na₂O:7R2 [symbol] :500H₂O | 20% | 100° | C. | Static | FAU | 13 | 0.09Na0.06R2 [symbol] (Si [symbol] Al [symbol] )O₂ |
| | | | | | 8 days | | | |
| X#14 | 100SiO₂²:1Al₂O₃ [symbol] :12Na₂O:25R2 [symbol] :2000H₂O | 16% | 120° | C. | Dynamic | FAU | 20 | 0.04Na0.05R2 [symbol] (Si [symbol] Al [symbol] )O₂ |
| | | | | | 5 days | | | |
| X#15 | 150SiO₂¹:1Al₂O₃ [symbol] :15Na₂O:35R2 [symbol] :2800H₂O | 17% | 120° | C. | Dynamic | FAU | 25 | 0.03Na0.04R2 [symbol] (Si [symbol] Al [symbol] )O₂ |
| | | | | | 5 days | | | |
| X#16 | 80SiO₂¹:1Al₂O₃ [symbol] :10Na₂O:18R2 [symbol] :1500H₂O | 10% | 110° | C. | Dynamic | FAU | 18 | 0.04Na0.06R2 [symbol] (Si [symbol] Al [symbol] )O₂ |
| | | | | | 5 days | | | |
| X#17 | 100SiO₂¹:1Al₂O₃ [symbol] :12Na₂O:23R2 [symbol] :1800H₂O | 9% | 115° | C. | Dynamic | FAU | 20 | 0.03Na0.06R2 [symbol] (Si [symbol] Al [symbol] )O₂ |
| | | | | | 5 days | | | |
| X#18 | 60SiO₂¹:1Al₂O₃ [symbol] :7Na₂O:15R2 [symbol] :1100H₂O | 7% | 130° | C. | Dynamic | FAU | 15 | 0.06Na0.06R2 [symbol] (Si [symbol] Al [symbol] )O₂ |
| | | | | | 3 days | | | |
| X#19 | 45SiO₂ [symbol] :1Al₂O₃ [symbol] :4Na₂O:9R2 [symbol] :800H₂O | 13% | 120° | C. | Static | FAU | 14 | 0.06Na0.06R2 [symbol] (Si [symbol] Al [symbol] )O₂ |
| | | | | | 8 days | | | |
| X#20 | 10SiO₂ [symbol] :1Al₂O₃ [symbol] :0.1Na₂O:5R2 [symbol] :150H₂O | 16% | 90° | C. | Static | FAU | 7 | 0.13Na0.09R2 [symbol] (Si [symbol] Al [symbol] )O₂ |
| | | | | | 15 days | | | |
| X#21 | 15SiO₂ [symbol] :1Al₂O₃ [symbol] :1.8Na₂O:5R2 [symbol] :200H₂O | 10% | 140° | C. | Static | FAU | 8 | 0.11Na0.09R2⁷(Si [symbol] Al [symbol] )O₂ |
| | | | | | 5 days | | | |
| X#22 | 20SiO₂ [symbol] :1Al₂O₃ [symbol] :1.8Na₂O:4.8R2 [symbol] :400H₂O | 12% | 110° | C. | Static | FAU | 12 | 0.09Na0.05R2⁸(Si [symbol] Al [symbol] )O₂ |
| | | | | | 5 days | | | |
| X#23 | 50SiO₂ [symbol] :1Al₂O₃ [symbol] :5Na₂O:12R2 [symbol] :800H₂O | 12% | 120° | C. | Dynamic | FAU | 20 | 0.03Na0.06R2⁸(Si [symbol] Al [symbol] )O₂ |
| | | | | | 3 days | | | |
| X#24 | 20SiO₂ [symbol] :1Al₂O₃ [symbol] :4.0Na₂O:4R2 [symbol] :400H₂O | 15% | 140° | C. | Dynamic | FAU | 12 | 0.08Na0.06R2 [symbol] (Si [symbol] Al [symbol] )O₂ |
| | | | | | 5 days | | | |
| X#25 | 15SiO₂⁴:1Al₂O₃ [symbol] :3.0Na₂O:4R2 [symbol] :280H₂O | 10% | 110° | C. | Dynamic | FAU | 10 | 0.09Na0.08R2 [symbol] (Si [symbol] Al [symbol] )O₂ |
| | | | | | 4 days | | | |
| X#26 | 100SiO₂⁴:1Al₂O₃ [symbol] :10Na₂O:18R2¹⁰:2000H₂O | 12% | 120° | C. | Dynamic | FAU | 20 | 0.04Na0.05R2¹⁰(Si [symbol] Al [symbol] )O₂ |
| | | | | | 5 days | | | |
| X#27 | 150SiO₂⁴:1Al₂O₃ [symbol] :15Na₂O:30R2¹⁰:2800H₂O | 11% | 120° | C. | Dynamic | FAU | 30 | 0.02Na0.04R2¹⁰(Si [symbol] Al [symbol] )O₂ |
| | | | | | 8 days | | | |
| X#28 | 80SiO₂⁴:1Al₂O₃ [symbol] :10Na₂O:15R2¹¹:1500H₂O | 10% | 120° | C. | Dynamic | FAU | 16 | 0.04Na0.07R2¹¹(Si [symbol] Al [symbol] )O₂ |
| | | | | | 4 days | | | |
| X#29 | 40SiO₂⁴:1Al₂O₃ [symbol] :5Na₂O:10R2¹¹:1500H₂O | 9% | 120° | C. | Dynamic | FAU | 12 | 0.06Na0.08R2¹¹(Si [symbol] Al [symbol] )O₂ |
| | | | | | 5 days | | | |
| X#30 | 150SiO₂⁴:1Al₂O₃ [symbol] :14Na₂O:25R2¹¹:2500H₂O | 10% | 120° | C. | Dynamic | FAU | 25 | 0.02Na0.05R2¹¹(Si [symbol] Al [symbol] )O₂ |
| | | | | | 3 days | | | |

Note:
Al₂O₃¹: Alumina:
Al₂O₃²: Aluminum isopropoxide:
Al₂O₃³: Sodium aluminate:
Al₂O₃⁴: Aluminum nitrate:
Al₂O₃⁵: Aluminum 2-butoxide:
Al₂O₃⁶: Aluminum sulfate:
Al₂O₃⁷: Aluminum powder:
SiO₂¹: Silica sol:
SiO₂²: Ethyl orthosilicate:
SiO₂³: Fumed silica:
SiO₂⁴: Silica gel
R2¹: Tetrapropylammonium hydroxide
R2²: Triethylhexylammonium hydroxide
R2³: Triethylbenzylammonium hydroxide
R2⁴: N,N,N-tripropyl adamantylammonium hydroxide
R2⁵: Dipropyldibutylammonium hydroxide
R2⁶: Benzyltriporpylammonium hydroxide
R2⁷: Choline
R2⁸: Tetrabutylammonium hydroxide
R2⁹: Tetrahexylammonium hydroxide
R2¹⁰: Tributyl-hydroxyethyl ammonium hydroxide
R2¹¹: Tripropyl-hydroxyethylammonium hydroxide [symbol]
indicates data missing or illegible when filed

TABLE 2
Types of raw materials, molar ratio thereof, crystallization conditions,
and crystal structure of samples V#1-V#30

| | | Crystallization | | Crystallization | Crystal |
|---|---|---|---|---|---|
| Sample | Initial gel constitution | temperature | | manner and time | structure |
| V#1 | 20SiO₂ [symbol] :1Al₂O₃ [symbol] :2.0Na₂O:4.8R2 [symbol] :360H₂O | 130° | C. | Dynamic 5 days | Amorphous |
| V#2 | 15SiO₂ [symbol] :1Al₂O₃ [symbol] :1.8Na₂O:3.6R2 [symbol] :200H₂O | 130° | C. | Static 4 days | Amorphous |
| V#3 | 20SiO₂ [symbol] :1Al₂O₃ [symbol] :1.8Na₂O:5.2R2 [symbol] :400H₂O | 110° | C. | Dynamic 6 days | Amorphous |
| V#4 | 50SiO₂ [symbol] :1Al₂O₃ [symbol] :8.0Na₂O:13R2²:800H₂O | 140° | C. | Dynamic 8 days | Amorphous |
| V#5 | 20SiO₂²:1Al₂O₃²:3.0Na₂O:5R2 [symbol] :400H₂O | 120° | C. | Static 6 days | Amorphous |
| V#6 | 20SiO₂²:1Al₂O₃ [symbol] :3Na₂O:4.5R2 [symbol] :400H₂O | 130° | C. | Static 3 days | Amorphous |
| V#7 | 200SiO₂²:1Al₂O₃²:25Na₂O:45R2 [symbol] :3000H₂O | 120° | C. | Dynamic 8 days | Amorphous |
| V#8 | 50SiO₂²:1Al₂O₃²:7Na₂O:11R2 [symbol] :800H₂O | 140° | C. | Dynamic 6 days | Amorphous |
| V#9 | 60SiO₂²:1Al₂O₃²:8.0Na₂O:15R2 [symbol] :900H₂O | 140° | C. | Dynamic 2 days | Amorphous |
| V#10 | 100SiO₂²:1Al₂O₃²:20Cs₂O:10R2⁴:800H₂O | 180 | | Dynamic 0.2 day | Amorphous |
| V#11 | 30SiO₂²:1Al₂O₃ [symbol] :4.0Na₂O:7R2⁴:500H₂O | 120° | C. | Static 3 days | Amorphous |
| V#12 | 150SiO₂²:1Al₂O₃ [symbol] :15K₂O:20R2⁴:1500H₂O | 160° | C. | Dynamic 0.5 day | Amorphous |
| V#13 | 30SiO₂²:1Al₂O₃ [symbol] :4.0Na₂O:7R2⁵:500H₂O | 100° | C. | Static 8 days | Amorphous |
| V#14 | 100SiO₂²:1Al₂O₃ [symbol] :12Na₂O:25R2⁵:2000H₂O | 120° | C. | Dynamic 5 days | Amorphous |
| V#15 | 150SiO₂²:1Al₂O₃ [symbol] :15Na₂O:35R2⁵:2800H₂O | 120° | C. | Dynamic 5 days | Amorphous |
| V#16 | 80SiO₂²:1Al₂O₃ [symbol] :10Na₂O:18R2⁵:1500H₂O | 110° | C. | Dynamic 5 days | Amorphous |
| V#17 | 100SiO₂ [symbol] :1Al₂O₃ [symbol] :12Na₂O:23R2⁶:1800H₂O | 115° | C. | Dynamic 5 days | Amorphous |
| V#18 | 60SiO₂ [symbol] :1Al₂O₃ [symbol] :7Na₂O:15R2⁶:1100H₂O | 130° | C. | Dynamic 3 days | Amorphous |
| V#19 | 45SiO₂ [symbol] :1Al₂O₃ [symbol] :4Na₂O:9R2⁶:800H₂O | 120° | C. | Static 8 days | Amorphous |
| V#20 | 10SiO₂²:1Al₂O₃ [symbol] :0.1Na₂O:5R2 [symbol] :150H₂O | 90° | C. | Static 15 days | Amorphous |
| V#21 | 15SiO₂ [symbol] :1Al₂O₃ [symbol] :1.8Na₂O:5R2⁷:200H₂O | 140° | C. | Static 5 days | Amorphous |
| V#22 | 20SiO₂ [symbol] :1Al₂O₃ [symbol] :1.8Na₂O:4.8R2⁸:400H₂O | 110° | C. | Static 5 days | Amorphous |
| V#23 | 50SiO₂ [symbol] :1Al₂O₃ [symbol] :5Na₂O:12R2 [symbol] :800H₂O | 120° | C. | Dynamic 3 days | Amorphous |
| V#24 | 20SiO₂ [symbol] :1Al₂O₃ [symbol] :4.0Na₂O:4R2⁹:400H₂O | 140° | C. | Dynamic 5 days | Amorphous |
| V#25 | 15SiO₂⁴:1Al₂O₃ [symbol] :3.0Na₂O:4R2⁹:280H₂O | 110° | C. | Dynamic 4 days | Amorphous |
| V#26 | 100SiO₂⁴:1Al₂O₃ [symbol] :10Na₂O:18R2¹⁰:2000H₂O | 120° | C. | Dynamic 5 days | Amorphous |
| V#27 | 150SiO₂⁴:1Al₂O₃ [symbol] :15Na₂O:30R2¹⁰:2800H₂O | 120° | C. | Dynamic 8 days | Amorphous |
| V#28 | 80SiO₂⁴:1Al₂O₃⁷:10Na₂O:15R2¹¹:1500H₂O | 120° | C. | Dynamic 4 days | Amorphous |
| V#29 | 40SiO₂⁴:1Al₂O₃⁷:5Na₂O:10R2¹¹:1500H₂O | 120° | C. | Dynamic 5 days | Amorphous |
| V#30 | 150SiO₂⁴:1Al₂O₃ [symbol] :14Na₂O:25R2 [symbol] :2500H₂O | 120° | C. | Dynamic 3 days | Amorphous |

Note:
Al₂O₃¹: Alumina:
Al₂O₃²: Aluminum isopropoxide:
Al₂O₃³: Sodium aluminate:
Al₂O₃⁴: Aluminum nitrate:
Al₂O₃⁵: Aluminum 2-butoxide:
Al₂O₃⁶: Aluminum sulfate:
Al₂O₃⁷: Aluminum powder:
SiO₂¹: Silica sol:
SiO₂²: Ethyl orthosilicate:
SiO₂³: Fumed silica:
SiO₂⁴: Silica gel:
R2¹: Tetrapropylammonium hydroxide
R2²: Triethylhexylammonium hydroxide
R2³: Triethylbenzylammonium hydroxide
R2⁴: N,N,N-tripropyl adamantylammonium hydroxide
R2⁵: Dipropyldibutylammonium hydroxide
R2⁶: Benzyltripropylammonium hydroxide
R2⁷: Choline
R2⁸: Tetrabutylammonium hydroxide
R2⁹: Tetrahexylammonium hydroxide
R2¹⁰: Tributyl-hydroxyethyl ammonium hydroxide
R2¹¹: Tripropyl-hydroxyethylammonium hydroxide [symbol]
indicates data missing or illegible when filed

TABLE 3
Types of raw materials, molar ratio thereof, addition amount of seed crystal, crystallization
conditions, and crystal structure, silica- alumina ratio, and constitution of samples X1-X30

| | | Addition | | | | | | |
|---|---|---|---|---|---|---|---|---|
| | | amount | Crystal- | | Crystal- | | silica- | |
| | | of seed | lization | | lization | Crystal | alumina | |
| Sample | Initial gel constitution | crystal | temperature | | time | structure | ratio | constitution |
| X1 | 20SiO₂¹:1Al₂O₃¹:2.0Na₂O:4.8R¹:360H₂O | 10% | 130° | C. | Dynamic | FAU | 12 | 0.07Na•0.07R¹(Si [symbol] Al [symbol] )O₂ |
| | | | | | 5 days | | | |
| X2 | 15SiO₂¹:1Al₂O₃¹:1.8Na₂O:3.6R¹:200H₂O | 10% | 130° | C. | Static | FAU | 9 | 0.09Na•0.09R¹(Si [symbol] Al [symbol] )O₂ |
| | | | | | 4 days | | | |
| X3 | 20SiO₂¹:1Al₂O₃¹:1.8Na₂O:5.2R¹:400H₂O | 12% | 110° | C. | Dynamic | FAU | 11 | 0.07K•0.08R¹(Si [symbol] Al [symbol] )O₂ |
| | | | | | 6 days | | | |
| X4 | 50SiO₂¹:1Al₂O₃ [symbol] :8.0Na₂O:13R²:800H₂O | 8% | 140° | C. | Dynamic | FAU | 15 | 0.03Na•0.07R²(Si [symbol] Al [symbol] )O₂ |
| | | | | | 8 days | | | |
| X5 | 20SiO₂²:1Al₂O₃²:3.0Na₂O:5R²:400H₂O | 15% | 120° | C. | Static | FAU | 8 | 0.08Na•0.12R²(Si [symbol] Al [symbol] )O₂ |
| | | | | | 5 days | | | |
| X6 | 20SiO₂²:1Al₂O₃ [symbol] :3Na₂O:4.5R¹:400H₂O | 10% | 130° | C. | Static | FAU | 11 | 0.07Na•0.08R [symbol] (Si [symbol] Al [symbol] )O₂ |
| | | | | | 3 days | | | |
| X7 | 200SiO₂²:1Al₂O₃²:25Na₂O:45R2 [symbol] :6000H₂O | 12% | 120° | C. | Dynamic | FAU | 28 | 0.02Na•0.05R [symbol] (Si [symbol] Al [symbol] )O₂ |
| | | | | | 8 days | | | |
| X8 | 50SiO₂²:1Al₂O₃²:7Na₂O:11R¹:800H₂O | 8% | 140° | C. | Dynamic | FAU | 18 | 0.03Na•0.07R [symbol] (Si [symbol] Al [symbol] )O₂ |
| | | | | | 5 days | | | |
| X9 | 60SiO₂²:1Al₂O₃²:8.0Na₂O:15R¹:900H₂O | 9% | 140° | C. | Dynamic | FAU | 20 | 0.03Na•0.06R [symbol] (Si [symbol] Al [symbol] )O₂ |
| | | | | | 5 days | | | |
| X10 | 15SiO₂²:1Al₂O₃²:4R⁴:200H₂O | 5% | 120° | C. | Static | FAU | 9 | 0.018R⁴(Si [symbol] Al [symbol] )O₂ |
| | | | | | 8 days | | | |
| X11 | 30SiO₂²:1Al₂O₃ [symbol] :4.0Na₂O:7R⁴:500H₂O | 14% | 120° | C. | Static | FAU | 13 | 0.07Na•0.06R⁴(Si [symbol] Al [symbol] )O₂ |
| | | | | | 10 days | | | |
| X12 | 20SiO₂²:1Al₂O₃ [symbol] :2.5Na₂O:5R⁴:400H₂O | 16% | 120° | C. | Static | FAU | 10 | 0.09Na•0.08R⁴(Si [symbol] Al [symbol] )O₂ |
| | | | | | 12 days | | | |
| X13 | 30SiO₂²:1Al₂O₃ [symbol] :4.0Na₂O:7R2 [symbol] :500H₂O | 20% | 100° | C. | Static | FAU | 13 | 0.09Na•0.06R [symbol] (Si [symbol] Al [symbol] )O₂ |
| | | | | | 8 days | | | |
| X14 | 100SiO₂²:1Al₂O₃ [symbol] :12Na₂O:25R2 [symbol] :2000H₂O | 16% | 120° | C. | Dynamic | FAU | 20 | 0.04Na•0.05R [symbol] (Si [symbol] Al [symbol] )O₂ |
| | | | | | 5 days | | | |
| X15 | 150SiO₂ [symbol] :1Al₂O₃²:15Na₂O:35R2 [symbol] :2800H₂O | 17% | 120° | C. | Dynamic | FAU | 25 | 0.03Na•0.04R [symbol] (Si [symbol] Al [symbol] )O₂ |
| | | | | | 5 days | | | |
| X16 | 80SiO₂ [symbol] :1Al₂O₃ [symbol] :10Na₂O:18R2 [symbol] :1500H₂O | 10% | 110° | C. | Dynamic | FAU | 18 | 0.04Na•0.06R [symbol] (Si [symbol] Al [symbol] )O₂ |
| | | | | | 5 days | | | |
| X17 | 100SiO₂ [symbol] :1Al₂O₃ [symbol] :12Cs2O:23R [symbol] :1800H₂O | 9% | 115° | C. | Dynamic | FAU | 20 | 0.03Cs•0.06R [symbol] (Si [symbol] Al [symbol] )O₂ |
| | | | | | 5 days | | | |
| X18 | 60SiO₂ [symbol] :1Al₂O₃ [symbol] :7Na₂O:15R [symbol] :1100H₂O | 7% | 130° | C. | Dynamic | FAU | 15 | 0.06Na•0.06R [symbol] (Si [symbol] Al [symbol] )O₂ |
| | | | | | 3 days | | | |
| X19 | 45SiO₂ [symbol] :1Al₂O₃ [symbol] :4Na₂O:9R [symbol] :800H₂O | 13% | 120° | C. | Static | FAU | 14 | 0.06Na•0.06R [symbol] (Si [symbol] Al [symbol] )O₂ |
| | | | | | 8 days | | | |
| X20 | 10SiO₂ [symbol] :1Al₂O₃ [symbol] :0.1Na₂O:5R [symbol] :150H₂O | 16% | 90° | C. | Static | FAU | 7 | 0.13Na•0.09R [symbol] (Si [symbol] Al [symbol] )O₂ |
| | | | | | 15 days | | | |
| X21 | 15SiO₂ [symbol] :1Al₂O₃ [symbol] :1.8Na₂O:5R [symbol] :200H₂O | 10% | 140° | C. | Static | FAU | 8 | 0.11Na•0.09R [symbol] (Si [symbol] Al [symbol] )O₂ |
| | | | | | 5 days | | | |
| X22 | 20SiO₂ [symbol] :1Al₂O₃ [symbol] :1.8Na₂O:4.8R⁸:400H₂O | 12% | 110° | C. | Static | FAU | 12 | 0.09Na•0.05R [symbol] (Si [symbol] Al [symbol] )O₂ |
| | | | | | 5 days | | | |
| X23 | 50SiO₂ [symbol] :1Al₂O₃ [symbol] :5Na₂O:12R⁸:800H₂O | 12% | 160° | C. | Dynamic | FAU | 20 | 0.03Na•0.06R [symbol] (Si [symbol] Al [symbol] )O₂ |
| | | | | | 1 day | | | |
| X24 | 20SiO₂³:1Al₂O₃ [symbol] :4.0Na₂O:4R⁹:400H₂O | 15% | 140° | C. | Dynamic | FAU | 12 | 0.08Na•0.06R [symbol] (Si [symbol] Al [symbol] )O₂ |
| | | | | | 3 days | | | |
| X25 | 15SiO₂⁴:1Al₂O₃⁶:3.0Na₂O:4R⁹:280H₂O | 10% | 110° | C. | Dynamic | FAU | 10 | 0.09Na•0.08R [symbol] (Si [symbol] Al [symbol] )O₂ |
| | | | | | 5 days | | | |
| X26 | 100SiO₂⁴:1Al₂O₃⁶:10Na₂O:18R¹⁰:2000H₂O | 12% | 120° | C. | Dynamic | FAU | 20 | 0.04Na•0.05R¹⁰(Si [symbol] Al [symbol] )O₂ |
| | | | | | 5 days | | | |
| X27 | 150SiO₂⁴:1Al₂O₃⁷:15Na₂O:30R¹⁰:2800H₂O | 11% | 120° | C. | Dynamic | FAU | 30 | 0.02Na•0.04R¹⁰(Si [symbol] Al [symbol] )O₂ |
| | | | | | 8 days | | | |
| X28 | 80SiO₂⁴:1Al₂O₃ [symbol] :10Na₂O:15R1¹:1500H₂O | 10% | 120° | C. | Dynamic | FAU | 16 | 0.04Na•0.07R¹¹(Si [symbol] Al [symbol] )O₂ |
| | | | | | 7 days | | | |
| X29 | 40SiO₂⁴:1Al₂O₃ [symbol] :5Na₂O:10R1¹:1500H₂O | 9% | 120° | C. | Dynamic | FAU | 12 | 0.06Na•0.08R¹¹(Si [symbol] Al [symbol] )O₂ |
| | | | | | 5 days | | | |
| X30 | 150SiO₂⁴:1Al₂O₃⁷:14Na₂O:25R1¹:2500H₂O | 10% | 180° | C. | Dynamic | FAU | 25 | 0.02Na•0.05R¹¹(Si [symbol] Al [symbol] )O₂ |
| | | | | | 0.5 day | | | |

Note:
Al₂O₃¹: Alumina:
Al₂O₃²: Aluminum isopropoxide:
Al₂O₃³: Sodium aluminate:
Al₂O₃⁴: Aluminum nitrate:
Al₂O₃⁵: Aluminum tri-sec-butoxide:
Al₂O₃⁶: Aluminum sulfate:
Al₂O₃⁷: Aluminum powder:
SiO₂¹: Silica sol:
SiO₂²: Ethyl orthosilicate:
SiO₂³: Fumed silica:
SiO₂⁴: Silica gel
R¹: N,N-dimethyl-3,5-dipropylpiperidine hydroxide
R²: N,N-diethyl-2,6-dimethylpiperidine hydroxide
R³: N,N-diethyl-3,5-dipropylpiperidine hydroxide
R⁴: N-ethyl-3-butylpyridine
R⁵: N,N-diethyl-3,5-dipropylpiperidine hydroxide
R⁶: 1,4-dipropylpiperazine
R⁷: N-methylpyridine
R⁸: N-ethyl-3-butylpyridine
R⁹: 1-ethyl-3-butylimidazole hydroxide
R¹⁰: 1-ethyl-4-gutyl-5-methylpiperazine
R¹¹: 1-ethyl-3-butyl-4-propylimidazole hydroxide [symbol]
indicates data missing or illegible when filed

TABLE 4
Types of raw materials, molar ratio thereof, crystallization
conditions, and crystal structure of samples V1-V30

| | | Crystallization | | Crystallization | Crystal |
|---|---|---|---|---|---|
| Sample | Initial gel constitution | temperature | | manner and time | structure |
| V1 | 20SiO₂ [symbol] :1Al₂O₃ [symbol] :2.0Na₂O:4.8R [symbol] :360H₂O | 130° | C. | Dynamic 5 days | Amorphous |
| V2 | 15SiO₂ [symbol] :1Al₂O₃¹:1.8Na₂O:3.6R [symbol] :200H₂O | 130° | C. | Static 4 days | Amorphous |
| V3 | 20SiO₂ [symbol] :1Al₂O₃²:1.8K₂O:5.2R [symbol] :400H₂O | 110° | C. | Dynamic 6 days | Amorphous |
| V4 | 50SiO₂ [symbol] :1Al₂O₃ [symbol] :8.0Na₂O:13R [symbol] :800H₂O | 140° | C. | Dynamic 8 days | Amorphous |
| V5 | 20SiO₂²:1Al₂O₃²:3.0Na₂O:5R [symbol] :400H₂O | 120° | C. | Static 6 days | Amorphous |
| V6 | 20SiO₂ [symbol] :1Al₂O₃ [symbol] :3Na₂O:4.5R [symbol] :400H₂O | 130° | C. | Static 3 days | Amorphous |
| V7 | 200SiO₂ [symbol] :1Al₂O₃ [symbol] :25Na₂O:45R [symbol] :6000H₂O | 120° | C. | Dynamic 8 days | Amorphous |
| V8 | 50SiO₂ [symbol] :1Al₂O₃ [symbol] :7Na₂O:11R [symbol] :800H₂O | 140° | C. | Dynamic 6 days | Amorphous |
| V9 | 60SiO₂ [symbol] :1Al₂O₃ [symbol] :8.0Na₂O:15R2 [symbol] :900H₂O | 140° | C. | Dynamic 6 days | Amorphous |
| V10 | 15SiO₂ [symbol] :1Al₂O₃ [symbol] :4R⁴:200H₂O | 120° | C. | Static 8 days | Amorphous |
| V11 | 30SiO₂ [symbol] :1Al₂O₃ [symbol] :4.0Na₂O:7R [symbol] :500H₂O | 120° | C. | Static 10 days | Amorphous |
| V12 | 20SiO₂ [symbol] :1Al₂O₃ [symbol] :2.5Na₂O:5R [symbol] :400H₂O | 120° | C. | Static 12 days | Amorphous |
| V13 | 30SiO₂ [symbol] :1Al₂O₃ [symbol] :4.0Na₂O:7R [symbol] :500H₂O | 100° | C. | Static 8 days | Amorphous |
| V14 | 100SiO₂ [symbol] :1Al₂O₃ [symbol] :12Na₂O:25R [symbol] :2000H₂O | 120° | C. | Dynamic 5 days | Amorphous |
| V15 | 150SiO₂ [symbol] :1Al₂O₃ [symbol] :15Na₂O:35R [symbol] :2800H₂O | 120° | C. | Dynamic 5 days | Amorphous |
| V16 | 80SiO₂ [symbol] :1Al₂O₃ [symbol] :10Na₂O:18R [symbol] :1500H₂O | 110° | C. | Dynamic 5 days | Amorphous |
| V17 | 100SiO₂ [symbol] :1Al₂O₃ [symbol] :12Cs₂O:23R [symbol] :1800H₂O | 115° | C. | Dynamic 5 days | Amorphous |
| V18 | 60SiO₂ [symbol] :1Al₂O₃ [symbol] :7Na₂O:15R [symbol] :1100H₂O | 130° | C. | Dynamic 3 days | Amorphous |
| V19 | 45SiO₂ [symbol] :1Al₂O₃ [symbol] :4Na₂O:9R [symbol] :800H₂O | 120° | C. | Static 8 days | Amorphous |
| V20 | 10SiO₂ [symbol] :1Al₂O₃ [symbol] :0.1Na₂O:1.5R [symbol] :150H₂O | 90° | C. | Static 15 days | Amorphous |
| V21 | 15SiO₂ [symbol] :1Al₂O₃ [symbol] :1.8Na₂O:5R [symbol] :200H₂O | 140° | C. | Static 5 days | Amorphous |
| V22 | 20SiO₂ [symbol] :1Al₂O₃ [symbol] :1.8Na₂O:4.8R [symbol] :400H₂O | 110° | C. | Static 5 days | Amorphous |
| V23 | 50SiO₂ [symbol] :1Al₂O₃ [symbol] :5Na₂O:12R [symbol] :800H₂O | 160° | C. | Dynamic 1 day | Amorphous |
| V24 | 20SiO₂ [symbol] :1Al₂O₃ [symbol] :4.0Na₂O:4R [symbol] :400H₂O | 140° | C. | Dynamic 3 days | Amorphous |
| V25 | 15SiO₂ [symbol] :1Al₂O₃ [symbol] :3Na₂O:4R [symbol] :280H₂O | 110° | C. | Dynamic 5 days | Amorphous |
| V26 | 100SiO₂ [symbol] :1Al₂O₃ [symbol] :10Na₂O:18R [symbol] :2000H₂O | 120° | C. | Dynamic 5 days | Amorphous |
| V27 | 150SiO₂ [symbol] :1Al₂O₃ [symbol] :15Na₂O:30R [symbol] :2800H₂O | 120° | C. | Dynamic 8 days | Amorphous |
| V28 | 80SiO₂ [symbol] :1Al₂O₃ [symbol] :10Na₂O:15R1¹:1500H₂O | 120° | C. | Dynamic 7 days | Amorphous |
| V29 | 40SiO₂ [symbol] :1Al₂O₃ [symbol] :5Na₂O:10R1¹:1500H₂O | 120° | C. | Dynamic 5 days | Amorphous |
| V30 | 150SiO₂ [symbol] :1Al₂O₃ [symbol] :14Na₂O:25R [symbol] :2500H₂O | 180° | C. | Dynamic 0.5 day | Amorphous |

Note:
Al₂O₃¹: Alumina:
Al₂O₃²: Aluminum isopropoxide:
Al₂O₃³: Sodium aluminate:
Al₂O₃⁴: Aluminum nitrate:
Al₂O₃⁵: Aluminum tri-sec-butoxide:
Al₂O₃⁶: Aluminum sulfate:
Al₂O₃⁷: Aluminum powder:
SiO₂¹: Silica sol:
SiO₂²: Ethyl orthosilicate:
SiO₂³: Fumed silica:
SiO₂⁴: Silica gel
R¹: N,N-dimethyl-3,5-dipropylpiperidine hydroxide
R²: N,N-diethyl-2,6-dimethylpiperidine hydroxide
R³: N,N-diethyl-3,5-dipropylpiperidine hydroxide
R⁴: N-ethyl-3-butylpyridine
R⁵: N,N-diethyl-3,5-dipropylpiperidine hydroxide
R⁶: 1,4-dipropylpiperazine
R⁷: N-methylpyridine
R⁸: N-ethyl-3-butylpyridine
R⁹: 1-ethyl-3-butylimidazole hydroxide
R¹⁰: 1-ethyl-4-gutyl-5-methylpiperazine
R¹¹: 1-ethyl-3-butyl-4-propylimidazole hydroxide [symbol]
indicates data missing or illegible when filed

### Example 4 Preparation of Sample X1

Preparation of synthetic gel: 0.7 g sodium aluminate (Al₂O₃:48.3 wt %, Na₂O: 36.3 wt %, China National Pharmaceutical (Group) Shanghai Chemical Reagent Company), 0.20 g sodium hydroxide, 13.74 g N,N-dimethyl-3,5-dipropylpiperidine hydroxide (25 wt %.) were dissolved in 1.82 g deionized water and stirred until to be clear. 13.3 g silica sol (SiO₂:30 wt % Shenyang Chemical Co., Ltd.) was added therein dropwise and stirred for 2 hours. Then 0.4 g Y zeolite as seed crystal with silica-alumina ratio of 3 was added, and stirring was continued for 2 hours.

Synthesis at high-silica Y zeolite: The synthesis gel was transferred into a stainless-steel reactor, and was subject to rotational crystallization at 130° C. for 5 days. After the crystallization was completed, the obtained solid was separated from liquid, washed to be neutrality, then dried at 100° C. for 12 hours. The obtained sample was denoted as sample X1.

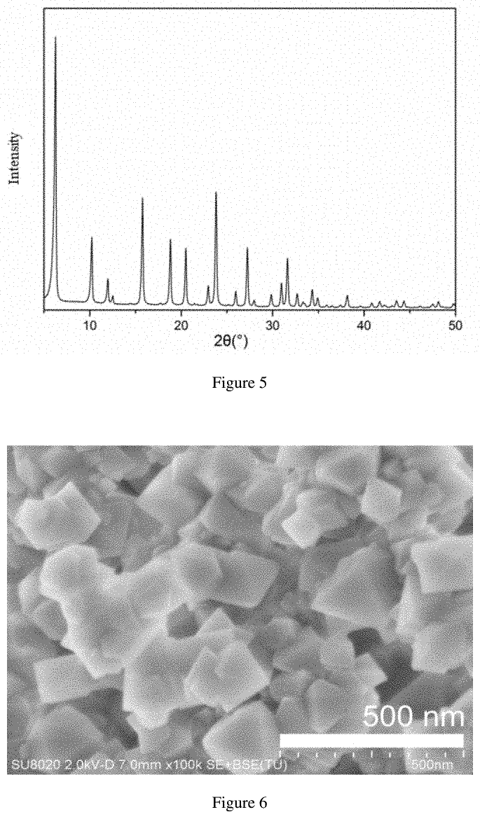

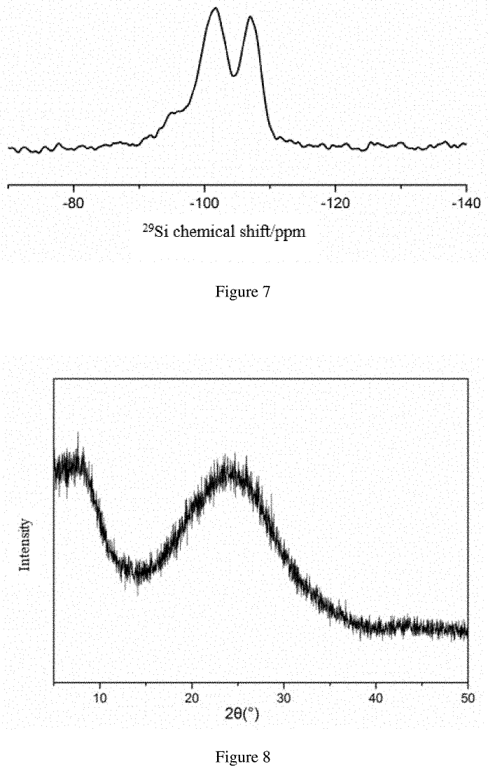

X-ray diffraction (XRD) spectrum of sample X1 is shown in FIG. 5. demonstrating that the sample X1 is molecular sieve having FAU framework structure. Scanning electron microscope (SEM) image thereof is shown in FIG. 6, demonstrating that the particles of sample X1 are small pieces with a size ranging from 50 nm to 200 nm. ²⁹Si MAS NMR spectrum thereof is shown in FIG. 7. The fitting calculation shows that the silica-alumina ratio in the framework is consistent with the calculation results conducted by XRF. According to the XRF and ¹³C MAS NMR normalization analysis, the element constitution of sample X1 is 0.07Na.0.07R¹.(SiO_{0.86}Al_{0.14})O₂, where R¹ is N,N-dimethyl-3,5-dipropylpiperidine hydroxide.

### Example 5: Preparation of Samples

The preparation process of any one of sample X2-X30 is the same as that of Example 4. The raw materials for preparing samples X2-X30, molar ratio thereof, addition amount of seed crystal (weight ratio of seed crystal to SiO₂ in gel), crystallization conditions, crystal structure, silica-alumina ratio (the silica-alumina radio of the obtained product is measured by X-ray fluorescence analyzer (XRF)) and the product constitution are shown in Table 3.

Samples X1-X20 were prepared using silica-alumina to molecular sieves having FAU topology as seed crystals, of which silica-alumina ratios were 3, 2.8, 3.5, 40, 5, 6.6, 6, 6, 7, 92, 10, 3.5, 4. 6, 8, 4. 35, 12, 20 respectively, and which were purchased from Zibo Runxin Chemical Technology Co., Ltd. Samples X21-X30 were prepared using silica-alumina molecular sieves having EMT topology as seed crystals, of which silica-alumina ratios were 7, 7, 8.5, 7, 8, 10, 21, 32.8 and 7 respectively, and which were purchased from Henan Purchased by Hnamyu Molecular Steve Co., Ltd.

### Comparative Example 2: Preparation of Comparative Samples V1-V30

The preparation process of any one of samples V1-V30 is the same as that of Example 4, except that there is no seed crystal addition step. Types of raw materials, molar ratio thereof, crystallization conditions, and crystal structure of samples V1-V30 are shown in Table 4. The samples obtained are denoted as comparative samples V1-V30.

### Example 6: Characterization and Analysis of Sample X1-X30 and Comparative Samples V1-V30

The phases of sample X1-X30 and comparative samples V1-V30 were analyzed by X-ray diffraction method.

The results show that each of the samples X1-X30 prepared in Examples 4 and 5 is Y molecular sieve with both high purity and high crystallinity. The XRD spectrum of sample X1 as typical representative is shown in FIG. 5. SEM image thereof is shown in FIG. 6, and Si NWR thereof is shown in FIG. 7. The XRD spectrum result of any one of samples X2-X30 is close to FIG. 1. In other words, the diffraction peak positions and shapes are substantially identical. The relative peak intensity fluctuates within ±5% depending on the change of synthesis conditions, demonstrating that any of samples X1-X30 has the structural characteristics of Y zeolite and has no impurities. The silica-alumina ratio of any sample is much higher than that of conventional Y zeolite. It can be seen that during the synthesis of the high-silica Y molecular sieve according to the present application the introduction of nitrogen-containing heterocyclic templating agent is the key to the synthesis of the high-silica Y molecular sieve according to the present application.

In Table 4, each of the comparative samples V1-V30 is amorphous, and a XRD spectrum of the comparative sample V1 as typical representative is shown in FIG. 4. It can be seen that during the synthesis of high-silica Y zeolite, in addition to the introduction of nitrogen-containing heterocyclic templating agent, the introduction of seed crystal is also necessary.

TABLE 3
Types of raw materials, molar ratio thereof, addition amount of seed crystal, crystallization
conditions, and crystal structure, silica- alumina ratio, and constitution of samples X1-X30

| | | Addition | | | | | | |
|---|---|---|---|---|---|---|---|---|
| | | amount | Crystal- | | Crystal- | | silica- | |
| | | of seed | lization | | lization | Crystal | alumina | |
| Sample | Initial gel constitution | crystal | temperature | | time | structure | ratio | constitution |
| X1 | 20SiO₂¹:1Al₂O₃ [symbol] :2.0Na₂O:4.8R¹:360H₂O | 10% | 130° | C. | Dynamic | FAU | 12 | 0.07Na•0.07R¹(Si [symbol] Al [symbol] )O₂ |
| | | | | | 5 days | | | |
| X2 | 15SiO₂¹:1Al₂O₃ [symbol] :1.8Na₂O:3.6R¹:200H₂O | 10% | 130° | C. | Static | FAU | 9 | 0.09Na•0.09R¹(Si [symbol] Al [symbol] )O₂ |
| | | | | | 4 days | | | |
| X3 | 20SiO₂¹:1Al₂O₃²:1.8Na₂O:5.2R¹:400H₂O | 12% | 110° | C. | Dynamic | FAU | 11 | 0.07K•0.08R¹(Si [symbol] Al [symbol] )O₂ |
| | | | | | 6 days | | | |
| X4 | 50SiO₂¹:1Al₂O₃ [symbol] :8.0Na₂O:13R²:800H₂O | 8% | 140° | C. | Dynamic | FAU | 15 | 0.03Na•0.07R²(Si [symbol] Al [symbol] )O₂ |
| | | | | | 8 days | | | |
| X5 | 20SiO₂²:1Al₂O₃²:3.0Na₂O:5R²:400H₂O | 15% | 120° | C. | Static | FAU | 8 | 0.08Na•0.12R²(Si [symbol] Al [symbol] )O₂ |
| | | | | | 6 days | | | |
| X6 | 20SiO₂²:1Al₂O₃ [symbol] :3Na₂O:4.5R¹:400H₂O | 10% | 130° | C. | Static | FAU | 11 | 0.07Na•0.08R [symbol] (Si [symbol] Al [symbol] )O₂ |
| | | | | | 3 days | | | |
| X7 | 200SiO₂²:1Al₂O₃²:25Na₂O:45R2³:6000H₂O | 12% | 120° | C. | Dynamic | FAU | 28 | 0.02Na•0.05R [symbol] (Si [symbol] Al [symbol] )O₂ |
| | | | | | 8 days | | | |
| X8 | 50SiO₂²:1Al₂O₃²:7Na₂O:11R¹:800H₂O | 8% | 140° | C. | Dynamic | FAU | 18 | 0.03Na•0.07R [symbol] (Si [symbol] Al [symbol] )O₂ |
| | | | | | 6 days | | | |
| X9 | 60SiO₂²:1Al₂O₃²:8.0Na₂O:15R¹:900H₂O | 9% | 140° | C. | Dynamic | FAU | 20 | 0.03Na•0.06R [symbol] (Si [symbol] Al [symbol] )O₂ |
| | | | | | 5 days | | | |
| X10 | 15SiO₂²:1Al₂O₃ [symbol] :4R⁴:200H₂O | 5% | 120° | C. | Static | FAU | 9 | 0.018R⁴(Si [symbol] Al [symbol] )O₂ |
| | | | | | 8 days | | | |
| X11 | 30SiO₂²:1Al₂O₃ [symbol] :4.0Na₂O:7R⁴:500H₂O | 14% | 120° | C. | Static | FAU | 13 | 0.07Na•0.06R⁴(Si [symbol] Al [symbol] )O₂ |
| | | | | | 10 days | | | |
| X12 | 20SiO₂²:1Al₂O₃ [symbol] :2.5Na₂O:5R⁴:400H₂O | 16% | 120° | C. | Static | FAU | 10 | 0.09Na•0.08R⁴(Si [symbol] Al [symbol] )O₂ |
| | | | | | 12 days | | | |
| X13 | 30SiO₂²:1Al₂O₃ [symbol] :4.0Na₂O:7R¹:500H₂O | 20% | 100° | C. | Static | FAU | 13 | 0.09Na•0.06R [symbol] (Si [symbol] Al [symbol] )O₂ |
| | | | | | 8 days | | | |
| X14 | 100SiO₂²:1Al₂O₃ [symbol] :12Na₂O:25R2 [symbol] :2000H₂O | 16% | 120° | C. | Dynamic | FAU | 20 | 0.04Na•0.05R [symbol] (Si [symbol] Al [symbol] )O₂ |
| | | | | | 5 days | | | |
| X15 | 150SiO₂ [symbol] :1Al₂O₃²:15Na₂O:35R2 [symbol] :2800H₂O | 17% | 120° | C. | Dynamic | FAU | 25 | 0.03Na•0.04R [symbol] (Si [symbol] Al [symbol] )O₂ |
| | | | | | 5 days | | | |
| X16 | 80SiO₂ [symbol] :1Al₂O₃²:10Na₂O:18R2 [symbol] :1800H₂O | 10% | 110° | C. | Dynamic | FAU | 18 | 0.04Na•0.06R [symbol] (Si [symbol] Al [symbol] )O₂ |
| | | | | | 5 days | | | |
| X17 | 100SiO₂ [symbol] :1Al₂O₃ [symbol] :12Cs₂O:23R [symbol] :1800H₂O | 9% | 115° | C. | Dynamic | FAU | 20 | 0.03Cs•0.06R [symbol] (Si [symbol] Al [symbol] )O₂ |
| | | | | | 5 days | | | |
| X18 | 60SiO₂ [symbol] :1Al₂O₃ [symbol] :7Na₂O:15R [symbol] :1100H₂O | 7% | 130° | C. | Dynamic | FAU | 15 | 0.06Na•0.06R [symbol] (Si [symbol] Al [symbol] )O₂ |
| | | | | | 3 days | | | |
| X19 | 45SiO₂ [symbol] :1Al₂O₃ [symbol] :4Na₂O:9R [symbol] :800H₂O | 13% | 120° | C. | Static | FAU | 14 | 0.06Na•0.06R [symbol] (Si [symbol] Al [symbol] )O₂ |
| | | | | | 8 days | | | |
| X20 | 10SiO₂ [symbol] :1Al₂O₃ [symbol] :0.1Na₂O:5R [symbol] :150H₂O | 16% | 90° | C. | Static | FAU | 7 | 0.13Na•0.09R [symbol] (Si [symbol] Al [symbol] )O₂ |
| | | | | | 15 days | | | |
| X21 | 15SiO₂ [symbol] :1Al₂O₃ [symbol] :1.8Na₂O:5R [symbol] :200H₂O | 10% | 140° | C. | Static | FAU | 8 | 0.11Na•0.09R⁷(Si [symbol] Al [symbol] )O₂ |
| | | | | | 5 days | | | |
| X22 | 20SiO₂ [symbol] :1Al₂O₃ [symbol] :1.8Na₂O:4.8R⁸:400H₂O | 12% | 110° | C. | Static | FAU | 12 | 0.09Na•0.05R⁸(Si [symbol] Al [symbol] )O₂ |
| | | | | | 5 days | | | |
| X23 | 50SiO₂ [symbol] :1Al₂O₃ [symbol] :5Na₂O:12R [symbol] :800H₂O | 12% | 160° | C. | Dynamic | FAU | 20 | 0.03Na•0.06R⁸(Si [symbol] Al [symbol] )O₂ |
| | | | | | 1 day | | | |
| X24 | 20SiO₂ [symbol] :1Al₂O₃ [symbol] :4.0Na₂O:4R [symbol] :400H₂O | 15% | 140° | C. | Dynamic | FAU | 12 | 0.08Na•0.06R [symbol] (Si [symbol] Al [symbol] )O₂ |
| | | | | | 3 days | | | |
| X25 | 15SiO₂⁴:1Al₂O₃ [symbol] :3.0Na₂O:4R⁹:280H₂O | 10% | 110° | C. | Dynamic | FAU | 10 | 0.09Na•0.08R⁹(Si [symbol] Al [symbol] )O₂ |
| | | | | | 5 days | | | |
| X26 | 100SiO₂⁴:1Al₂O₃⁶:10Na₂O:18R¹⁰:2000H₂O | 12% | 120° | C. | Dynamic | FAU | 20 | 0.04Na•0.05R¹⁰(Si [symbol] Al [symbol] )O₂ |
| | | | | | 5 days | | | |
| X27 | 150SiO₂⁴:1Al₂O₃⁷:15Na₂O:30R¹⁰:2800H₂O | 11% | 120° | C. | Dynamic | FAU | 30 | 0.02Na•0.04R¹⁰(Si [symbol] Al [symbol] )O₂ |
| | | | | | 8 days | | | |
| X28 | 80SiO₂⁴:1Al₂O₃⁷:10Na₂O:15R¹¹:1500H₂O | 10% | 120° | C. | Dynamic | FAU | 16 | 0.04Na•0.07R¹¹(Si [symbol] Al [symbol] )O₂ |
| | | | | | 7 days | | | |
| X29 | 40SiO₂⁴:1Al₂O₃⁷:5Na₂O:10R¹¹:1500H₂O | 9% | 120° | C. | Dynamic | FAU | 12 | 0.06Na•0.08R¹¹(Si [symbol] Al [symbol] )O₂ |
| | | | | | 5 days | | | |
| X30 | 150SiO₂⁴:1Al₂O₃⁷:14Na₂O:25R [symbol] :2500H₂O | 10% | 180° | C. | Dynamic | FAU | 25 | 0.02Na•0.05R¹¹(Si [symbol] Al [symbol] )O₂ |
| | | | | | 0.5 day | | | |

Note:
Al₂O₃¹: Alumina:
Al₂O₃²: Aluminum isopropoxide:
Al₂O₃³: Sodium aluminate:
Al₂O₃⁴: Aluminum nitrate:
Al₂O₃⁵: Aluminum tri-sec-butoxide:
Al₂O₃⁶: Aluminum sulfate:
Al₂O₃⁷: Aluminum powder:
SiO₂¹: Silica sol:
SiO₂²: Ethyl orthosilicate:
SiO₂³: Fumed silica:
SiO₂⁴: Silica gel
R¹: N,N-dimethyl-3,5-dipropylpiperidine hydroxide
R²: N,N-diethyl-2,6-dimethylpiperidine hydroxide
R³: N,N-diethyl-3,5-dipropylpiperidine hydroxide
R⁴: N-ethyl-3-butylpyridine
R⁵: N,N-diethyl-3,5-dipropylpiperidine hydroxide
R⁶: 1,4-dipropylpiperazine
R⁷: N-methylpyridine
R⁸: N-ethyl-3-butylpyridine
R⁹: 1-ethyl-3-butylimidazole hydroxide
R¹⁰: 1-ethyl-4-gutyl-5-methylpiperazine
R¹¹: 1-ethyl-3-butyl-4-propylimidazole hydroxide [symbol]
indicates data missing or illegible when filed

TABLE 4
Types of raw materials, molar ratio thereof, crystallization
conditions, and crystal structure of samples V1-V30

| | | Crystallization | | Crystallization | Crystal |
|---|---|---|---|---|---|
| Sample | Initial gel constitution | temperature | | manner and time | structure |
| V1 | 20SiO₂¹:1Al₂O₃ [symbol] :2.0Na₂O:4.8R¹:360H₂O | 130° | C. | Dynamic 5 days | Amorphous |
| V2 | 15SiO₂¹:1Al₂O₃ [symbol] :1.8Na₂O:3.6R¹:200H₂O | 130° | C. | Static 4 days | Amorphous |
| V3 | 20SiO₂¹:1Al₂O₃²:1.8Na₂O:5.2R¹:400H₂O | 110° | C. | Dynamic 6 days | Amorphous |
| V4 | 50SiO₂¹:1Al₂O₃ [symbol] :8.0Na₂O:13R²:800H₂O | 140° | C. | Dynamic 8 days | Amorphous |
| V5 | 20SiO₂²:1Al₂O₃²:3.0Na₂O:5R²:400H₂O | 120° | C. | Static 6 days | Amorphous |
| V6 | 20SiO₂²:1Al₂O₃ [symbol] :3Na₂O:4.5R¹:400H₂O | 130° | C. | Static 3 days | Amorphous |
| V7 | 200SiO₂²:1Al₂O₃²:25Na₂O:45R2³:6000H₂O | 120° | C. | Dynamic 8 days | Amorphous |
| V8 | 50SiO₂²:1Al₂O₃²:7Na₂O:11R¹:800H₂O | 140° | C. | Dynamic 6 days | Amorphous |
| V9 | 60SiO₂²:1Al₂O₃²:8.0Na₂O:15R¹:900H₂O | 140° | C. | Dynamic 6 days | Amorphous |
| V10 | 15SiO₂²:1Al₂O₃ [symbol] :4R⁴:200H₂O | 120° | C. | Static 8 days | Amorphous |
| V11 | 30SiO₂²:1Al₂O₃ [symbol] :4.0Na₂O:7R⁴:500H₂O | 120° | C. | Static 10 days | Amorphous |
| V12 | 20SiO₂²:1Al₂O₃ [symbol] :2.5Na₂O:5R⁴:400H₂O | 120° | C. | Static 12 days | Amorphous |
| V13 | 30SiO₂²:1Al₂O₃ [symbol] :4.0Na₂O:7R¹:500H₂O | 100° | C. | Static 8 days | Amorphous |
| V14 | 100SiO₂²:1Al₂O₃ [symbol] :12Na₂O:25R2 [symbol] :2000H₂O | 120° | C. | Dynamic 5 days | Amorphous |
| V15 | 150SiO₂ [symbol] :1Al₂O₃²:15Na₂O:35R2 [symbol] :2800H₂O | 120° | C. | Dynamic 5 days | Amorphous |
| V16 | 80SiO₂ [symbol] :1Al₂O₃²:10Na₂O:18R2 [symbol] :1800H₂O | 110° | C. | Dynamic 5 days | Amorphous |
| V17 | 100SiO₂ [symbol] :1Al₂O₃ [symbol] :12Cs₂O:23R [symbol] :1800H₂O | 115° | C. | Dynamic 5 days | Amorphous |
| V18 | 60SiO₂ [symbol] :1Al₂O₃ [symbol] :7Na₂O:15R [symbol] :1100H₂O | 130° | C. | Dynamic 3 days | Amorphous |
| V19 | 45SiO₂ [symbol] :1Al₂O₃ [symbol] :4Na₂O:9R [symbol] :800H₂O | 120° | C. | Static 8 days | Amorphous |
| V20 | 10SiO₂ [symbol] :1Al₂O₃ [symbol] :0.1Na₂O:5R [symbol] :150H₂O | 90° | C. | Static 15 days | Amorphous |
| V21 | 15SiO₂ [symbol] :1Al₂O₃ [symbol] :1.8Na₂O:5R [symbol] :200H₂O | 140° | C. | Static 5 days | Amorphous |
| V22 | 20SiO₂ [symbol] :1Al₂O₃ [symbol] :1.8Na₂O:4.8R⁸:400H₂O | 110° | C. | Static 5 days | Amorphous |
| V23 | 50SiO₂ [symbol] :1Al₂O₃ [symbol] :5Na₂O:12R [symbol] :800H₂O | 160° | C. | Dynamic 1 day | Amorphous |
| V24 | 20SiO₂ [symbol] :1Al₂O₃ [symbol] :4.0Na₂O:4R [symbol] :400H₂O | 140° | C. | Dynamic 3 days | Amorphous |
| V25 | 15SiO₂⁴:1Al₂O₃ [symbol] :3.0Na₂O:4R⁹:280H₂O | 110° | C. | Dynamic 5 days | Amorphous |
| V26 | 100SiO₂⁴:1Al₂O₃⁶:10Na₂O:18R¹⁰:2000H₂O | 120° | C. | Dynamic 5 days | Amorphous |
| V27 | 150SiO₂⁴:1Al₂O₃⁷:15Na₂O:30R¹⁰:2800H₂O | 120° | C. | Dynamic 8 days | Amorphous |
| V28 | 80SiO₂⁴:1Al₂O₃⁷:10Na₂O:15R¹¹:1500H₂O | 120° | C. | Dynamic 7 days | Amorphous |
| V29 | 40SiO₂⁴:1Al₂O₃⁷:5Na₂O:10R¹¹:1500H₂O | 120° | C. | Dynamic 5 days | Amorphous |
| V30 | 150SiO₂⁴:1Al₂O₃⁷:14Na₂O:25R [symbol] :2500H₂O | 180° | C. | Dynamic 0.5 day | Amorphous |

Note:
Al₂O₃ [symbol] ¹: Alumina:
Al₂O₃ [symbol] ²: Aluminum isopropoxide:
Al₂O₃ [symbol] ³: Sodium aluminate:
Al₂O₃ [symbol] ⁴: Aluminum nitrate:
Al₂O₃ [symbol] ⁵: Aluminum tri-sec-butoxide:
Al₂O₃ [symbol] ⁶: Aluminum sulfate:
Al₂O₃ [symbol] ⁷: Aluminum powder:
SiO₂¹: Silica sol:
SiO₂²: Ethyl orthosilicate:
SiO₂³: Fumed silica:
SiO₂⁴: Silica gel
R¹: N,N-dimethyl-3,5-dipropylpiperidine hydroxide
R²: N,N-diethyl-2,6-dimethylpiperidine hydroxide
R³: N,N-diethyl-3,5-dipropylpiperidine hydroxide
R⁴: N-ethyl-3-butylpyridine
R⁵: N,N-diethyl-3,5-dipropylpiperidine hydroxide
R⁶: 1,4-dipropylpiperazine
R⁷: N-methylpyridine
R⁸: N-ethyl-3-butylpyridine
R⁹: 1-ethyl-3-butylimidazole hydroxide
R¹⁰: 1-ethyl-4-gutyl-5-methylpiperazine
R¹¹: 1-ethyl-3-butyl-4-propylimidazole hydroxide [symbol]
indicates data missing or illegible when filed

### Example 7: Preparation of Sample Y #1

Preparation of directing agent 1.3 g sodium hydroxide (analytical purity, Tianjin Koenion Chemical Reagent Co., Ltd.) and 1.7 g alumina (chemical purity, China National Pharmaceutical (Group) Shanghai Chemical Reagent Co., Ltd.) were dissolved in 84.1 g tetraethylammonium hydroxide (35 wt % aqueous solution, Aladdin reagent (Shanghai) Co., Ltd.) and stirred until to be clear. 34.7 g ethyl orthosilicate was added therein dropwise (chemical purity. China pharmaceutical (Group) Shanghai chemical reagent company) and stirred for 2 hours. The obtained solution was allowed to stand at 50° C. for 12 hours to perform aging, and then stand at 100° C. for 45 hours.

Preparation of synthetic gel: 0.7 g sodium aluminate (Al₂O₃: 48.3 wt %, Na₂O: 34.3 wt %, China National Pharmaceutical (Grow) Shanghai Chemical Reagent Company), 0.20 g sodium hydroxide, and 9.8 g tetrapropylammonium hydroxide (25 wt %) were dissolved in 4.8 g deionized water and stirred until to be clear. 13.3 g silica sol (SiO₂: 30 wt %, Shenyang Chemical Co., Ltd.) was added therein dropwise and stirred far 2 hours. Then 4.9 g the above-mentioned directing agent was added therein and stirred for 3 hours.

Synthesis of high-silica Y molecular sieve: The synthetic gel was transferred into a stainless-steel reactor, and was subject to rotational crystallization at 130° C. for 5 days. After the crystallization was completed, the obtained solid was separated from liquid, washed to be neutrality, then dried at 100° C. for 12 hours. The obtained sample was denoted as sample Y #1.

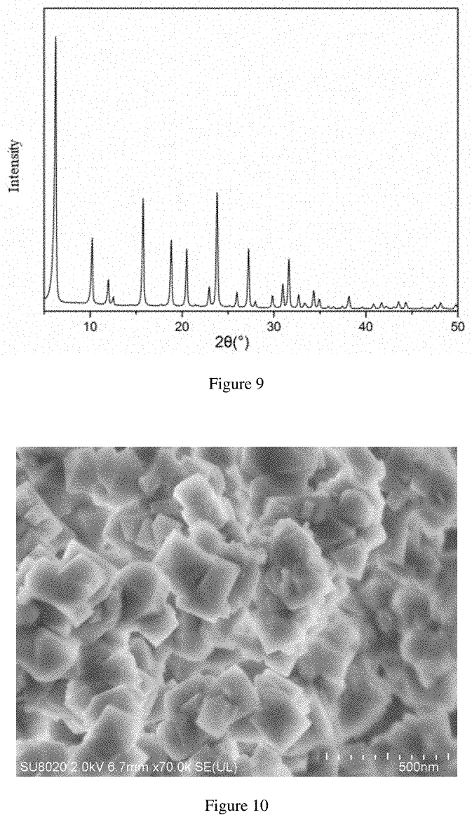

X-ray diffraction (XRD) spectrum of sample Y #1 is shown in FIG. 9. demonstrating that the sample Y #1 is molecular sieve having FAU framework structure. Scanning electron microscope (SEM) image thereof is shown in FIG. 10. demonstrating that the particles of sample Y #1 are small pieces with a size ranging from 50 nm to 200 nm. ²⁹Si MAS NMR spectrum thereof is shown in FIG. 11. The fitting calculation shows that the silica-alumina ratio in the framework is consistent with the calculation results conducted by XRF. According to the XRF and ¹³C MAS NMR normalization analysis, the element constitution of sample Y #1 is 0.07Na.0.02R1².0.05R2¹ (Si_{0.85}Al_{0.14})O₂, where R1² is tetraethylammonium hydroxide, R2¹ is tetrapropylammonium hydroxide.

### Example 8: Preparation of Samples Y #2-Y #30

The preparation process of any one of samples Y #2-Y #30 is the same as that of Example 7. The raw materials for preparing samples Y #2-Y #30, molar ratio thereof, crystallization conditions, crystal structure, and silica-alumina ratio (the silica-alumina ratio of the obtained product is measured by X-ray fluorescence analyzer (XRF)) are shown in Table 5. Aging temperature and time for preparing directing agent, aging manner, addition amount of directing agent and sample constitution are shown in Table 6.

TABLE 5
Types of raw materials, molar ratio thereof, crystallization conditions, crystal structure, and silica-alumina ratio of samples Y#1-Y#30

| | | | | | | | Silica- |
|---|---|---|---|---|---|---|---|
| | | | Crystal- | | Crystal- | | alumina |
| | | | lization | | lization | Crystal | ratio of |
| Sample | Directing agent constitution | Initial gel constitution | temperature | | time | structure | product |
| Y#1 | 10SiO₂¹:1Al₂O₃¹:1Na₂O:12R1²:180H₂O | 20SiO₂¹:1Al₂O₃¹:2.0Na₂O:3.6R2¹:360H₂O | 130° | C. | Dynamic | FAU | 12 |
| | | | | | 5 days | | |
| Y#2 | 10SiO₂¹:1Al₂O₃¹:1Na₂O:10R1¹:180H₂O | 15SiO₂¹:1Al₂O₃¹:1.8Na₂O:3R2¹:200H₂O | 130° | C. | Static | FAU | 9 |
| | | | | | 4 days | | |
| Y#3 | 30SiO₂:1Al₂O₃⁴:1.5K2O:30R1¹:600H₂O | 20SiO₂¹:1Al₂O₃²:1.8K2O:4R2¹:400H₂O | 110° | C. | Dynamic | FAU | 11 |
| | | | | | 6 days | | |
| Y#4 | 20SiO₂¹:1Al₂O₃¹:10R1¹:8R1¹:400H₂O | 50SiO₂¹:1Al₂O₃¹:8.0Na₂O:9R2²:800H₂O | 160° | C. | Dynamic | FAU | 15 |
| | | | | | 3 days | | |
| Y#5 | 10SiO₂²:1Al₂O₃²:0.5Na₂O:10R1¹:200H₂O | 20SiO₂²:1Al₂O₃²:4.0Na₂O:4R2²:400H₂O | 120° | C. | Static | FAU | 8 |
| | | | | | 6 days | | |
| Y#6 | 10SiO₂²:1Al₂O₃²:0.5Na₂O:14R1²:200H₂O | 20SiO₂²:1Al₂O₃²:4.0Na₂O:4R2 [symbol] :400H₂O | 130° | C. | Static | FAU | 11 |
| | | | | | 3 days | | |
| Y#7 | 10SiO₂²:1Al₂O₃¹:1Cs2O:10R1¹:180H₂O | 200SiO₂²:1Al₂O₃²:25Cs2O:40R2¹:3000H₂O | 120° | C. | Dynamic | FAU | 28 |
| | | | | | 8 days | | |
| Y#8 | 30SiO₂²:1Al₂O₃⁴:1.5Na₂O:35R1²:600H₂O | 50SiO₂²:1Al₂O₃²:8.0Na₂O:6R2 [symbol] :800H₂O | 140° | C. | Dynamic | FAU | 18 |
| | | | | | 6 days | | |
| Y#9 | 30SiO₂²:1Al₂O₃⁴:1.0Na₂O:34R1⁴:600H₂O | 60SiO₂²:1Al₂O₃²:9.0Na₂O:8R2 [symbol] :900H₂O | 140° | C. | Dynamic | FAU | 20 |
| | | | | | 6 days | | |
| Y#10 | 15SiO₂ [symbol] :1Al₂O₃ [symbol] :1.8Na₂O:12R1¹:180H₂O | 15SiO₂²:1Al₂O₃²:1.8Na₂O:4R2⁴:200H₂O | 120° | C. | Static | FAU | 9 |
| | | | | | 8 days | | |
| Y#11 | 10SiO₂ [symbol] :1Al₂O₃²:1Na₂O:10R1 [symbol] :180H₂O | 30SiO₂²:1Al₂O₃ [symbol] :5.0Na₂O:6R2⁴:500H₂O | 120° | C. | Static | FAU | 13 |
| | | | | | 10 days | | |
| Y#12 | 15SiO₂ [symbol] :1Al₂O₃ [symbol] :1.8Na₂O:12R1¹:180H₂O | 20SiO₂²:1Al₂O₃ [symbol] :3.0Na₂O:5R2⁴:400H₂O | 120° | C. | Static | FAU | 10 |
| | | | | | 12 days | | |
| Y#13 | 10SiO₂ [symbol] :1Al₂O₃²:1Na₂O:10R1 [symbol] :180H₂O | 30SiO₂²:1Al₂O₃ [symbol] :5.0Na₂O:6R2 [symbol] :500H₂O | 100° | C. | Static | FAU | 13 |
| | | | | | 8 days | | |
| Y#14 | 15SiO₂¹:1Al₂O₃ [symbol] :1Na₂O:10R1¹:200H₂O | 100SiO₂²:1Al₂O₃ [symbol] :12Na₂O:20R2 [symbol] :2000H₂O | 120° | C. | Dynamic | FAU | 20 |
| | | | | | 5 days | | |
| Y#15 | 10SiO₂¹:1Al₂O₃ [symbol] :2Na₂O:8R1⁴:100H₂O | 150SiO₂¹:1Al₂O₃²:15Na₂O:28R2 [symbol] :2800H₂O | 120° | C. | Dynamic | FAU | 25 |
| | | | | | 5 days | | |
| Y#16 | 15SiO₂¹:1Al₂O₃²:15R1¹:250H₂O | 80SiO₂ [symbol] :1Al₂O₃²:10Na₂O:15R2 [symbol] :1500H₂O | 110° | C. | Dynamic | FAU | 18 |
| | | | | | 5 days | | |
| Y#17 | 30SiO₂¹:1Al₂O₃¹:20R1¹:600H₂O | 100SiO₂¹:1Al₂O₃ [symbol] :12Na₂O:20R2⁶:180H₂O | 115° | C. | Dynamic | FAU | 20 |
| | | | | | 5 days | | |
| Y#18 | 5SiO₂ [symbol] :1Al₂O₃ [symbol] :1Na₂O:10R1¹:100H₂O | 60SiO₂ [symbol] :1Al₂O₃ [symbol] :5Na₂O:12R2⁶:1100H₂O | 130° | C. | Dynamic | FAU | 15 |
| | | | | | 8 days | | |
| Y#19 | 15SiO₂¹:1Al₂O₃¹:1.8Na₂O:10R1¹:100H₂O | 45SiO₂ [symbol] :1Al₂O₃ [symbol] :4Na₂O:8R2⁶:800H₂O | 120° | C. | Static | FAU | 14 |
| | | | | | 8 days | | |
| Y#20 | 20SiO₂⁴:1Al₂O₃⁴:5Na₂O:18R1¹:400H₂O | 10SiO₂¹:1Al₂O₃²:0.1Na₂O:4R2⁷:150H₂O | 90° | C. | Static | FAU | 7 |
| | | | | | 15 days | | |
| Y#21 | 10SiO₂⁴:1Al₂O₃⁷:0.5Na₂O:8R1 [symbol] :200H₂O | 15SiO₂¹:1Al₂O₃²:1.8Na₂O:3R2⁷:200H₂O | 140° | C. | Static | FAU | 8 |
| | | | | | 5 days | | |
| Y#22 | 15SiO₂²:1Al₂O₃⁷:0.5Na₂O:12R1 [symbol] :280H₂O | 20SiO₂¹:1Al₂O₃²:1.8Na₂O:4R2⁸:400H₂O | 110° | C. | Static | FAU | 12 |
| | | | | | 5 days | | |
| Y#23 | 12SiO₂¹:1Al₂O₃⁷:0.5Na₂O:10R1⁴:200H₂O | 50SiO₂¹:1Al₂O₃ [symbol] :5Na₂O:8R2⁸:800H₂O | 120° | C. | Dynamic | FAU | 20 |
| | | | | | 6 days | | |
| Y#24 | 20SiO₂⁴:1Al₂O₃ [symbol] :0.5Na₂O:18R1 [symbol] :400H₂O | 20SiO₂ [symbol] :1Al₂O₃ [symbol] :4.0Na₂O:4R2⁹:400H₂O | 140° | C. | Dynamic | FAU | 12 |
| | | | | | 5 days | | |
| Y#25 | 10SiO₂¹:1Al₂O₃ [symbol] :0.5Na₂O:8R1 [symbol] :400H₂O | 15SiO₂⁴:1Al₂O₃ [symbol] :3.0Na₂O:4R2 [symbol] :280H₂O | 110° | C. | Dynamic | FAU | 10 |
| | | | | | 5 days | | |
| Y#26 | 8SiO₂ [symbol] :1Al₂O₃ [symbol] :8R1¹:150H₂O | 100SiO₂⁴:1Al₂O₃⁷:10Na₂O:18R2¹⁰:2000H₂O | 120° | C. | Dynamic | FAU | 20 |
| | | | | | 5 days | | |
| Y#27 | 10SiO₂ [symbol] :1Al₂O₃ [symbol] :2Na₂O:7R1 [symbol] :180H₂O | 150SiO₂⁴:1Al₂O₃⁷:15Na₂O:30R2¹⁰:2800H₂O | 120° | C. | Dynamic | FAU | 30 |
| | | | | | 8 days | | |
| Y#28 | 9SiO₂²:1Al₂O₃ [symbol] :0.5Na₂O:8R1 [symbol] :150H₂O | 80SiO₂⁴:1Al₂O₃ [symbol] :10Na₂O:15R2¹¹:1500H₂O | 120° | C. | Dynamic | FAU | 16 |
| | | | | | 7 days | | |
| Y#29 | 25SiO₂⁴:1Al₂O₃ [symbol] :1Na₂O:8R1²:480H₂O | 40SiO₂⁴:1Al₂O₃ [symbol] :5Na₂O:10R2 [symbol] :1500H₂O | 120° | C. | Dynamic | FAU | 12 |
| | | | | | 5 days | | |
| Y#30 | 30SiO₂⁴:1Al₂O₃ [symbol] :3Na₂O:40R1 [symbol] :600H₂O | 150SiO₂⁴:1Al₂O₃⁷:14Na₂O:25R2¹¹:2500H₂O | 180° | C. | Dynamic | FAU | 25 |
| | | | | | 3 days | | |

Note:
Al₂O₃¹: Alumina:
Al₂O₃²: Aluminum isopropoxide:
Al₂O₃³: Sodium aluminate:
Al₂O₃⁴: Aluminum nitrate:
Al₂O₃⁵: Aluminum 2-butoxide:
Al₂O₃⁶: Aluminum sulfate:
Al₂O₃⁷: Aluminum powder:
SiO₂¹: Silica sol:
SiO₂²: Ethyl orthosilicate:
SiO₂³: Fumed silica:
SiO₂⁴: Silica gel:
R1¹: Tetramethylammonium hydroxide:
R1²: Tetraethylammonium hydroxide:
R1³: Tetrapropylammonium hydroxide:
R1⁴: Choline:
R2¹: Tetrapropylammonium hydroxide
R2²: Triethylhexylammonium hydroxide
R2³: Triethylbenzylammonium hydroxide
R2⁴: N,N,N-tripropylamacrylammonium hydroxide:
R2⁵: Dipropyldibutyl ammonium hydroxide
R2⁶: Benzyltriporpylammonium hydroxide
R2⁷: Choline:
R2⁸: Tetrabutylammonium hydroxide
R2⁹: Tetrahexylammonium hydroxide
R2¹⁰: Butyl-hydroxyethylammonium hydroxide
R2¹¹: Tripropyl-hydroxyethylammonium hydroxide [symbol]
indicates data missing or illegible when filed

TABLE 6
Aging temperature and time for preparing directing agent, addition amount
of directing agent and sample constitution of samples Y#1-Y#30

| | | Addition | |
|---|---|---|---|
| | | amount of | |
| | Aging time for preparing | directing | |
| Sample | directing agent | agent | Sample constitution |
| Y#1 | 40° C. 5 days + 60° C. 4 days | 8% | 0.07Na0.02R1²0.05R2¹(Si [symbol] Al [symbol] )O₂ |
| Y#2 | 120° C. 1 day | 15% | 0.09Na0.04R1 [symbol] 0.05R2¹(Si [symbol] Al [symbol] )O₂ |
| Y#3 | 40° C. 1 day + 80° C. 4 days | 10% | 0.07K0.03R1 [symbol] 0.05R2¹(Si [symbol] Al [symbol] )O₂ |
| Y#4 | 100° C. 2 days | 10% | 0.03Na0.04R1 [symbol] 0.05R2²(Si [symbol] Al [symbol] )O₂ |
| Y#5 | 90° C. 3 days | 20% | 0.08Na0.04R1 [symbol] 0.08R2²(Si [symbol] Al [symbol] )O₂ |
| Y#6 | 80° C. 5 days | 10% | 0.07Na0.04R1 [symbol] 0.06R2³(Si [symbol] Al [symbol] )O₂ |
| Y#7 | 40° C. 0.5 day + 80° C. 2 days | 5% | 0.02Cs0.01R1 [symbol] 0.04R2 [symbol] (Si [symbol] Al [symbol] )O₂ |
| Y#8 | 40° C. 0.5 day + 60° C. 2 days | 8% | 0.03Na0.04R1 [symbol] 0.04R2³(Si [symbol] Al [symbol] )O₂ |
| Y#9 | 30° C. 3 days + 100° C. 2 days | 10% | 0.03Na0.02R1 [symbol] 0.04R2³(Si [symbol] Al [symbol] )O₂ |
| Y#10 | 30° C. 3 days + 50° C. 8 days | 12% | 0.09Na0.04R1 [symbol] 0.05R2⁴(Si [symbol] Al [symbol] )O₂ |
| Y#11 | 40° C. 15 days | 1% | 0.07Na0.02R1 [symbol] 0.04R2⁴(Si [symbol] Al [symbol] )O₂ |
| Y#12 | 30° C. 25 days | 5% | 0.09Na0.02R1 [symbol] 0.06R2⁴(Si [symbol] Al [symbol] )O₂ |
| Y#13 | 100° C. 5 days | 15% | 0.09Na0.02R1 [symbol] 0.05R2 [symbol] (Si [symbol] Al [symbol] )O₂ |
| Y#14 | 80° C. 7 days | 2% | 0.04Na0.01R1 [symbol] 0.04R2 [symbol] (Si [symbol] Al [symbol] )O₂ |
| Y#15 | 110° C. 1.5 days | 18% | 0.03Na0.01R1³0.03R2 [symbol] (Si [symbol] Al [symbol] )O₂ |
| Y#16 | 90° C. 3 days | 18% | 0.04Na0.02R1 [symbol] 0.04R2 [symbol] (Si [symbol] Al [symbol] )O₂ |
| Y#17 | 80° C. 5 days | 18% | 0.03Na0.02R1 [symbol] 0.04R2⁶(Si [symbol] Al [symbol] )O₂ |
| Y#18 | 60° C. 8 days | 8% | 0.06Na0.02R1 [symbol] 0.04R2⁶(Si [symbol] Al [symbol] )O₂ |
| Y#19 | 40° C. 11 days | 11% | 0.06Na0.02R1⁴0.04R2⁶(Si [symbol] Al [symbol] )O₂ |
| Y#20 | 80° C. 7 days | 3% | 0.13Na0.04R1 [symbol] 0.05R2⁷(Si [symbol] Al [symbol] )O₂ |
| Y#21 | 80° C. 7 days | 10% | 0.11Na0.04R1 [symbol] 0.05R2⁷(Si [symbol] Al [symbol] )O₂ |
| Y#22 | 100° C. 5 days | 10% | 0.09Na0.02R1 [symbol] 0.03R2⁸(Si [symbol] Al [symbol] )O₂ |
| Y#23 | 110° C. 2 days | 10% | 0.03Na0.02R1⁴0.04R2⁸(Si [symbol] Al [symbol] )O₂ |
| Y#24 | 70° C. 7 days | 18% | 0.08Na0.01R1 [symbol] 0.05R2⁹(Si [symbol] Al [symbol] )O₂ |
| Y#25 | 80° C. 5 days | 8% | 0.09Na0.04R1 [symbol] 0.04R2⁹(Si [symbol] Al [symbol] )O₂ |
| Y#26 | 60° C. 8 days | 9% | 0.04Na0.02R1 [symbol] 0.03R2¹⁰(Si [symbol] Al [symbol] )O₂ |
| Y#27 | 120° C. 1 day | 20% | 0.02Na0.01R1 [symbol] 0.03R2¹⁰(Si [symbol] Al [symbol] )O₂ |
| Y#28 | 110° C. 3 days | 10% | 0.04Na0.04R1 [symbol] 0.03R2¹¹(Si [symbol] Al [symbol] )O₂ |
| Y#29 | 110° C. 3 days | 10% | 0.06Na0.03R1 [symbol] 0.05R2¹¹(Si [symbol] Al [symbol] )O₂ |
| Y#30 | 80° C. 7 days | 10% | 0.02Na0.01R1 [symbol] 0.04R2¹¹(Si [symbol] Al [symbol] )O₂ |

Note:
R1¹: tetramethylammonium hydroxide:
R1²: Tetraethylammonium hydroxide:
R1³: Tetrapropylammonium hydroxide:
R1⁴: Choline:
R2¹: tetrapropylammonium hydroxide
R2²: Triethyl-hexylammonium hydroxide
R2³: Triethylbenzylammonium hydroxide
R2⁴: N,N,N-tripropyladamantylammonium hydroxide:
R2⁵: Dipropyl-dibutylammonium hydroxide:
R2⁶: Triporpyl-benzylammonium hydroxide
R2⁷: Choline
R2⁸: Tetrabutylammonium hydroxide
R2⁹: Tetrahexylammonium hydroxide
R2¹⁰: Tributyl-hydroxyethyl ammonium hydroxide
R2¹¹: Tripropyl-hydroxyethylammonium hydroxide [symbol]
indicates data missing or illegible when filed

### Comparative Example 3: Preparation of Comparative Samples S #1-S #30

The specific types of raw materials for preparing synthetic gel, molar ratio thereof, preparation process and crystallization conditions are the same as those in the preparation of sample Y #1 in Example 7. There is no directing agent preparation step, and there is not addition of directing agent in the subsequent gel synthesis step. The type of raw materials, molar ratio thereof, crystallization conditions, and crystal structures of product are shown in Table 7. The obtained samples are denoted as comparative samples S #1-S #30.

TABLE 7
Types of raw materials, molar ratio thereof, crystallization conditions,
and crystal structure of samples S#1-S#30

| | | Crystallization | | Crystallization | Product |
|---|---|---|---|---|---|
| Sample | Initial gel constitution | temperature | | time | structure |
| S#1 | 20SiO₂¹:1Al₂O₃³:2.0Na₂O:3.6R2¹:360H₂O | 130° | C. | Dynamic 5 days | Amorphous |
| S#2 | 15SiO₂¹:1Al₂O₃ [symbol] :1.8Na₂O:3R2¹:200H₂O | 130° | C. | Static 4 days | Amorphous |
| S#3 | 20SiO₂¹:1Al₂O₃²:1.8K₂O:4R2¹:400H₂O | 110° | C. | Dynamic 6 days | Amorphous |
| S#4 | 50SiO₂¹:1Al₂O₃ [symbol] :8.0Na₂O:9R2²:800H₂O | 150° | C. | Dynamic 3 days | Amorphous |
| S#5 | 20SiO₂²:1Al₂O₃²:3.0Na₂O:4R2²:400H₂O | 120° | C. | Static 6 days | Amorphous |
| S#6 | 20SiO₂²:1Al₂O₃ [symbol] :4.0Na₂O:4R2 [symbol] :400H₂O | 130° | C. | Static 3 days | Amorphous |
| S#7 | 200SiO₂²:1Al₂O₃²:25Cs₂O:40R2 [symbol] :3000H₂O | 120° | C. | Dynamic 8 days | Amorphous |
| S#8 | 50SiO₂²:1Al₂O₃²:8.0Na₂O:6R2 [symbol] :800H₂O | 140° | C. | Dynamic 6 days | Amorphous |
| S#9 | 60SiO₂²:1Al₂O₃²:9.0Na₂O:8R2 [symbol] :900H₂O | 140° | C. | Dynamic 6 days | Amorphous |
| S#10 | 15SiO₂²:1Al₂O₃²:1.8Na₂O:4R2 [symbol] :200H₂O | 120° | C. | Static 8 days | Amorphous |
| S#11 | 30SiO₂²:1Al₂O₃ [symbol] :5.0Na₂O:6R2 [symbol] :500H₂O | 120° | C. | Static 10 days | Amorphous |
| S#12 | 20SiO₂²:1Al₂O₃ [symbol] :3.0Na₂O:5R2 [symbol] :400H₂O | 120° | C. | Static 12 days | Amorphous |
| S#13 | 30SiO₂²:1Al₂O₃ [symbol] :5.0Na₂O:6R2 [symbol] :500H₂O | 100° | C. | Static 8 days | Amorphous |
| S#14 | 100SiO₂²:1Al₂O₃ [symbol] :12Na₂O:20R2 [symbol] :2000H₂O | 120° | C. | Dynamic 5 days | Amorphous |
| S#15 | 150SiO₂ [symbol] :1Al₂O₃ [symbol] :15Na₂O:28R2 [symbol] :2800H₂O | 120° | C. | Dynamic 5 days | Amorphous |
| S#16 | 80SiO₂ [symbol] :1Al₂O₃ [symbol] :10Na₂O:15R2 [symbol] :1500H₂O | 110° | C. | Dynamic 5 days | Amorphous |
| S#17 | 100SiO₂ [symbol] :1Al₂O₃ [symbol] :12Na₂O:20R2⁶:1800H₂O | 115° | C. | Dynamic 5 days | Amorphous |
| S#18 | 60SiO₂ [symbol] :1Al₂O₃ [symbol] :5Na₂O:12R2⁶:1100H₂O | 130° | C. | Dynamic 8 days | Amorphous |
| S#19 | 45SiO₂ [symbol] :1Al₂O₃ [symbol] :4Na₂O:8R2⁶:800H₂O | 120° | C. | Static 8 days | Amorphous |
| S#20 | 10SiO₂³:1Al₂O₃²:0.1Na₂O:4R2⁷:150H₂O | 90° | C. | Static 15 days | Amorphous |
| S#21 | 15SiO₂³:1Al₂O₃²:1.8Na₂O:3R2⁷:200H₂O | 140° | C. | Static 5 days | Amorphous |
| S#22 | 20SiO₂³:1Al₂O₃ [symbol] :1.8Na₂O:4R2⁸:400H₂O | 110° | C. | Static 5 days | Amorphous |
| S#23 | 50SiO₂³:1Al₂O₃ [symbol] :5Na₂O:8R2⁸:800H₂O | 120° | C. | Dynamic 6 days | Amorphous |
| S#24 | 20SiO₂³:1Al₂O₃ [symbol] :4.0Na₂O:4R2⁹:400H₂O | 140° | C. | Dynamic 5 days | Amorphous |
| S#25 | 15SiO₂⁴:1Al₂O₃⁶:3.0Na₂O:4R2⁹:280H₂O | 110° | C. | Dynamic 5 days | Amorphous |
| S#26 | 100SiO₂⁴:1Al₂O₃⁶:10Na₂O:18R2¹⁰:2000H₂O | 120° | C. | Dynamic 5 days | Amorphous |
| S#27 | 150SiO₂⁴:1Al₂O₃⁷:15Na₂O:30R2¹⁰:2800H₂O | 120° | C. | Dynamic 8 days | Amorphous |
| S#28 | 80SiO₂⁴:1Al₂O₃⁷:10Na₂O:15R2¹¹:1500H₂O | 120° | C. | Dynamic 7 days | Amorphous |
| S#29 | 40SiO₂⁴:1Al₂O₃⁷:5Na₂O:10R2¹¹:1500H₂O | 120° | C. | Dynamic 5 days | Amorphous |
| S#30 | 150SiO₂⁴:1Al₂O₃⁷:14Na₂O:25R2¹¹:2500H₂O | 180° | C. | Dynamic 3 days | Amorphous |

Note:
Al₂O₃¹: alumina:
Al₂O₃²: Aluminum isopropoxide:
Al₂O₃³: Sodium aluminate:
Al₂O₃⁴: Aluminum nitrate:
Al₂O₃⁵: Aluminum 2-butoxide:
Al₂O₃⁶: Aluminum sulfate:
Al₂O₃⁷: Aluminum powder:
SiO₂¹: silica sol:
SiO₂²: Ethyl orthosilicate:
SiO₂³: fumed silica:
SiO₂⁴: Silica gel:
R2¹: tetrapropylammonium hydroxide:
R2²: Triethyl-hexylammonium hydroxide:
R2³: triethyl-benzylammonium hydroxide:
R2⁴: N,N,N-tripropyladamantylammonium hydroxide:
R2⁵: Dipropyldibutyl ammonium hydroxide:
R2⁶: Benzyltriporpylammonium hydroxide
R2⁷: Choline
R2⁸: Tetrabutylammonium hydroxide
R2⁹: Tetrahexylammonium hydroxide
R2¹⁰: Tributyl-hydroxyethyl ammonium hydroxide
R2¹¹: Tripropyl-hydroxyethylammonium hydroxide [symbol]
indicates data missing or illegible when filed

### Comparative Example 4: Preparation of Comparative Samples T #1-T #30

The specific types of raw materials, molar ratio thereof, preparation process and crystallization conditions are the same as those of sample Y #1 in Example 7, except that after the batching step of the directing agent is completed, only stirring at room temperature for 2 hours without aging was performed. The types of raw materials, molar ratio thereof, crystallization conditions, addition amount of directing agent, and the crystal structure of the prepared product are shown in Table 8. The obtained samples were denoted a comparative samples T #1-T #30.

TABLE 8
Types of raw materials, addition amount of directing agent, molar ratio thereof,
crystallization conditions, and crystal structure of samples T#1-T#30

| | | Addition | | | | | |
|---|---|---|---|---|---|---|---|
| | | amount of | | Crystal- | | Crystal- | |
| Sam- | | directing | | lization | | lization | Crystal |
| ple | Directing agent constitution | agent | Initial gel constitution | temperature | | time | structure |
| T#1 | 10SiO₂¹:1Al₂O₃¹:1Na₂O:12R1²:180H₂O | 8% | 20SiO₂¹:1Al₂O₃¹:2.0Na₂O:3.6R2¹:360H₂O | 130° | C. | Dynamic | Amorphous |
| | | | | | | 5 days | |
| T#2 | 10SiO₂¹:1Al₂O₃¹:1Na₂O:10R1 [symbol] :180H₂O | 15% | 15SiO₂¹:1Al₂O₃¹:1.8Na₂O:3R2¹:200H₂O | 130° | C. | Static | Amorphous |
| | | | | | | 4 days | |
| T#3 | 30SiO₂:1Al₂O₃ [symbol] :1.5K2O:30R1¹:600H₂O | 10% | 20SiO₂¹:1Al₂O₃²:1.8K2O:4R2¹:400H₂O | 110° | C. | Dynamic | Amorphous |
| | | | | | | 6 days | |
| T#4 | 20SiO₂¹:1Al₂O₃¹:10R1 [symbol] :8R1¹:400H₂O | 10% | 50SiO₂¹:1Al₂O₃ [symbol] :8.0Na₂O:9R2²:800H₂O | 160° | C. | Dynamic | Amorphous |
| | | | | | | 3 days | |
| T#5 | 10SiO₂²:1Al₂O₃²:0.5Na₂O:10R1 [symbol] :200H₂O | 20% | 20SiO₂²:1Al₂O₃²:3.0Na₂O:4R2²:400H₂O | 120° | C. | Static | Amorphous |
| | | | | | | 6 days | |
| T#6 | 10SiO₂²:1Al₂O₃²:0.5Na₂O:10R1²:200H₂O | 10% | 20SiO₂²:1Al₂O₃ [symbol] :4.0Na₂O:4R2 [symbol] :40020H₂O | 130° | C. | Static | Amorphous |
| | | | | | | 3 days | |
| T#7 | 10SiO₂²:1Al₂O₃¹:1Cs2O:10R1 [symbol] :180H₂O | 5% | 200SiO₂²:1Al₂O₃²:25Cs2O:40R2 [symbol] :3000H₂O | 120° | C. | Dynamic | Amorphous |
| | | | | | | 8 days | |
| T#8 | 30SiO₂²:1Al₂O₃⁴:1.5Na₂O:35R1²:600H₂O | 8% | 50SiO₂²:1Al₂O₃²:8.0Na₂O:6R2 [symbol] :800H₂O | 140° | C. | Dynamic | Amorphous |
| | | | | | | 6 days | |
| T#9 | 30SiO₂²:1Al₂O₃⁴:1.0Na₂O:34R1⁴:600H₂O | 10% | 60SiO₂²:1Al₂O₃²:9.0Na₂O:8R2 [symbol] :900H₂O | 140° | C. | Dynamic | Amorphous |
| | | | | | | 6 days | |
| T#10 | 15SiO₂ [symbol] :1Al₂O₃ [symbol] :1.8Na₂O:12R1 [symbol] :180H₂O | 12% | 15SiO₂²:1Al₂O₃²:1.8Na₂O:4R2⁴:200H₂O | 120° | C. | Static | Amorphous |
| | | | | | | 8 days | |
| T#11 | 10SiO₂ [symbol] :1Al₂O₃²:1Na₂O:10R1 [symbol] :180H₂O | 1% | 30SiO₂²:1Al₂O₃ [symbol] :5.0Na₂O:6R2⁴:500H₂O | 120° | C. | Static | Amorphous |
| | | | | | | 10 days | |
| T#12 | 15SiO₂³:1Al₂O₃¹:1.8Na₂O:12R1 [symbol] :180H₂O | 5% | 20SiO₂²:1Al₂O₃ [symbol] :3.0Na₂O:5R2⁴:400H₂O | 120° | C. | Static | Amorphous |
| | | | | | | 12 days | |
| T#13 | 10SiO₂³:1Al₂O₃²:1Na₂O:10R1 [symbol] :180H₂O | 15% | 30SiO₂²:1Al₂O₃ [symbol] :5.0Na₂O:6R2³:500H₂O | 100° | C. | Static | Amorphous |
| | | | | | | 8 days | |
| T#14 | 15SiO₂¹:1Al₂O₃ [symbol] :1Na₂O:10R1 [symbol] :200H₂O | 2% | 100SiO₂²:1Al₂O₃¹:12Na₂O:20R2 [symbol] :2000H₂O | 120° | C. | Dynamic | Amorphous |
| | | | | | | 5 days | |
| T#15 | 10SiO₂¹:1Al₂O₃ [symbol] :2Na₂O:8R1 [symbol] :100H₂O | 18% | 150SiO₂¹:1Al₂O₃²:15Na₂O:28R2 [symbol] :2800H₂O | 120° | C. | Dynamic | Amorphous |
| | | | | | | 5 days | |
| T#16 | 15SiO₂¹:1Al₂O₃²:15R1¹:250H₂O | 18% | 80SiO₂¹:1Al₂O₃²:10Na₂O:15R2 [symbol] :1500H₂O | 110° | C. | Dynamic | Amorphous |
| | | | | | | 5 days | |
| T#17 | 30SiO₂¹:1Al₂O₃ [symbol] :20R1¹:600H₂O | 18% | 100SiO₂ [symbol] :1Al₂O₃ [symbol] :12Na₂O:20R2⁶:1800H₂O | 115° | C. | Dynamic | Amorphous |
| | | | | | | 5 days | |
| T#18 | 5SiO₂ [symbol] :1Al₂O₃ [symbol] :1Na₂O:10R1¹:100H₂O | 8% | 60SiO₂¹:1Al₂O₃¹:5Na₂O:12R2 [symbol] :1100H₂O | 130° | C. | Dynamic | Amorphous |
| | | | | | | 8 days | |
| T#19 | 15SiO₂¹:1Al₂O₃¹:1.8Na₂O:12R1⁴:180H₂O | 11% | 45SiO₂¹:1Al₂O₃¹:4Na₂O:8R2⁶:800H₂O | 120° | C. | Static | Amorphous |
| | | | | | | 8 days | |
| T#20 | 20SiO₂⁴:1Al₂O₃⁴:5Na₂O:18R1¹:400H₂O | 3% | 10SiO₂ [symbol] :1Al₂O₃ [symbol] :0.1Na₂O:4R2⁷:150H₂O | 90° | C. | Static | Amorphous |
| | | | | | | 15 days | |
| T#21 | 10SiO₂⁴:1Al₂O₃⁷:0.5Na₂O:8R1¹:200H₂O | 10% | 15SiO₂ [symbol] :1Al₂O₃²:1.8Na₂O:3R2⁷:200H₂O | 140° | C. | Static | Amorphous |
| | | | | | | 5 days | |
| T#22 | 15SiO₂²:1Al₂O₃⁷:0.5Na₂O:12R1 [symbol] :280H₂O | 10% | 20SiO₂ [symbol] :1Al₂O₃ [symbol] :1.8Na₂O:4R2⁸:400H₂O | 110° | C. | Static | Amorphous |
| | | | | | | 5 days | |
| T#23 | 12SiO₂ [symbol] :1Al₂O₃ [symbol] :0.5Na₂O:10R1⁴:200H₂O | 10% | 50SiO₂ [symbol] :1Al₂O₃ [symbol] :5Na₂O:8R2⁸:800H₂O | 120° | C. | Dynamic | Amorphous |
| | | | | | | 5 days | |
| T#24 | 20SiO₂⁴:1Al₂O₃ [symbol] :0.5Na₂O:18R1¹:400H₂O | 18% | 20SiO₂ [symbol] :1Al₂O₃ [symbol] :4.0Na₂O:4R2 [symbol] :400H₂O | 140° | C. | Dynamic | Amorphous |
| | | | | | | 5 days | |
| T#25 | 10SiO₂ [symbol] :1Al₂O₃ [symbol] :0.5Na₂O:8R1¹:400H₂O | 8% | 15SiO₂⁴:1Al₂O₃ [symbol] :3.0Na₂O:4R2⁹:280H₂O | 110° | C. | Dynamic | Amorphous |
| | | | | | | 5 days | |
| T#26 | 8SiO₂ [symbol] :1Al₂O₃ [symbol] :8R1¹:150H₂O | 9% | 100SiO₂⁴:1Al₂O₃⁷:10Na₂O:18R2¹⁰:2000H₂O | 120° | C. | Dynamic | Amorphous |
| | | | | | | 5 days | |
| T#27 | 10SiO₂ [symbol] :1Al₂O₃ [symbol] :2Na₂O:7R1¹:180H₂O | 20% | 150SiO₂⁴:1Al₂O₃⁷:15Na₂O:30R2¹⁰:2800H₂O | 120° | C. | Dynamic | Amorphous |
| | | | | | | 8 days | |
| T#28 | 9SiO₂²:1Al₂O₃⁶:0.5Na₂O:8R1 [symbol] :150H₂O | 10% | 80SiO₂⁴:1Al₂O₃ [symbol] :10Na₂O:15R2¹¹:1500H₂O | 120° | C. | Dynamic | Amorphous |
| | | | | | | 7 days | |
| T#29 | 25SiO₂⁴:1Al₂O₃⁶:1Na₂O:8R1²:480H₂O | 10% | 40SiO₂⁴:1Al₂O₃ [symbol] :5Na₂O:10R2¹¹:1500H₂O | 120° | C. | Dynamic | Amorphous |
| | | | | | | 5 days | |
| T#30 | 30SiO₂⁴:1Al₂O₃⁶:3Na₂O:40R1¹:600H₂O | 10% | 150SiO₂⁴:1Al₂O₃⁷:14Na₂O:25R2¹¹:2500H₂O | 180° | C. | Dynamic | Amorphous |
| | | | | | | 3 days | |

Note:
Al₂O₃¹: Alumina:
Al₂O₃²: Aluminum isopropoxide:
Al₂O₃³: Sodium aluminate:
Al₂O₃⁴: Aluminum nitrate:
Al₂O₃⁵: Aluminum 2-butoxide.
Al₂O₃⁶: Aluminum sulfate:
Al₂O₃⁷: Aluminum powder:
SiO₂¹: Silica sol:
SiO₂²: Ethyl orthosilicate:
SiO₂³: Fumed silica:
SiO₂⁴: Silica gel:
R1¹: Tetramethylammonium hydroxide:
R1²: Tetraethylammonium hydroxide:
R1³: Tetrapropylammonium hydroxide:
R1⁴: Choline:
R2¹: Tetrapropylammonium hydroxide:
R2²: Triethylhexylammonium hydroxide:
R2³: Triethylbenzylammonium hydroxide:
R2⁴: N,N,N-tripropylamacrylammonium hydroxide
R2⁵: Dipropyldibutyl ammonium hydroxide:
R2⁶: Benzyltriporpylammonium hydroxide
R2⁷: Choline:
R2⁸: Tetrabutylammonium hydroxide
R2⁹: Tetrahexylammonium hydroxide
R2¹⁰: Tributyl-hydroxyethyl ammonium hydroxide
R2¹¹: Tripropyl-hydroxyethylammonium hydroxide [symbol]
indicates data missing or illegible when filed

### Example 9: Characterization and Analysis of Samples Y #1-Y #30 and Comparative Samples S #1 and T #1

The phase of samples Y #1-Y #30 and comparative samples S #1-S #30 and T #1-T #30 were analyzed by X-ray diffraction method.

The result show that the each of samples Y #1-Y #30 prepared in Examples 7 and 8 is Y molecular sieve with both high purity and high crystallinity. The XRD spectrum of sample Y #1 as typical representative is shown in FIG. 9. SEM image thereof is shown in FIG. 10, and Si NMR thereof is shown in FIG. 11. The XRD spectrum result of any one of samples Y #2-Y #30 is close to FIG. 9. In other words, the diffraction peak positions and shapes are substantially identical. The relative peak intensity fluctuates within ±5% depending on the change of synthesis conditions, demonstrating that any of samples Y #1-Y #30 has the structural characteristics of Y zeolite and has no impurities.

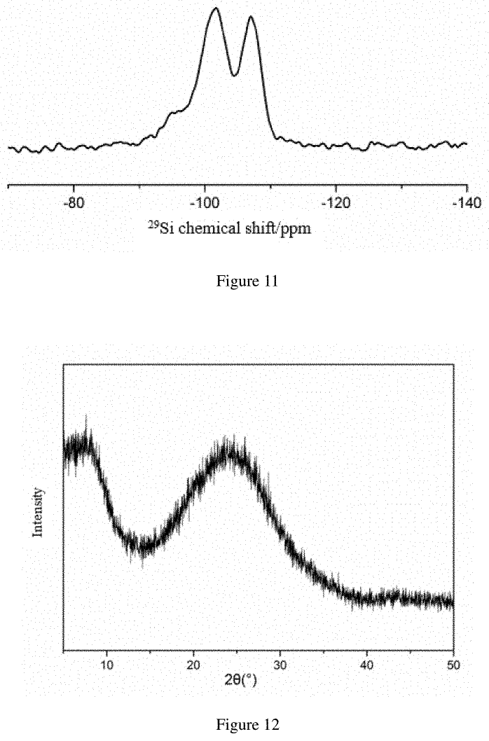

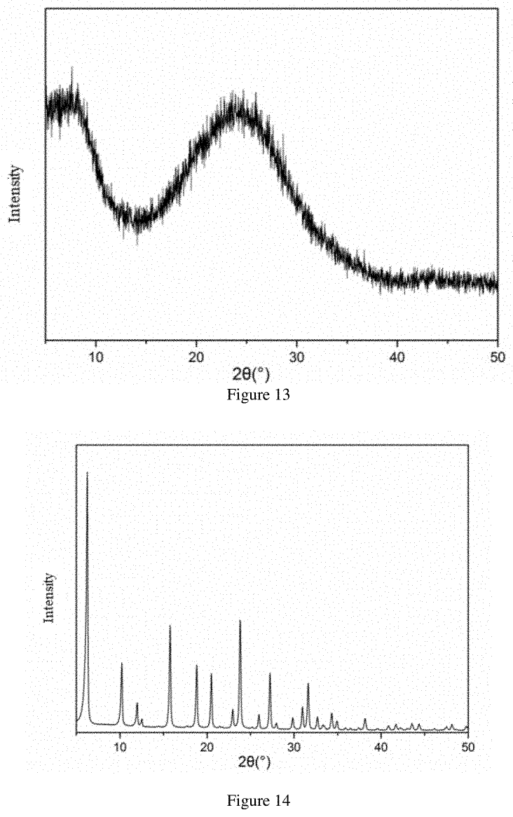

The comparative samples S #1-S #30 and the comparative samples T #1-T #30 in Table 7 and Table 8 am amorphous. The XRD spectra of the comparative sample S #1 and the comparative sample T #1 are shown in FIGS. 12 and 13, respectively. It can be seen that, during the synthesis of high-silica Y molecular sieve, the addition of a directing agent is necessary, and high-temperature aging must be carried out during preparation of the directing agent to induce crystallization, which is the key to the synthesis of high-silica Y molecular sieve.

### Example 10 Preparation of Sample Y1

Preparation of directing agent: 1.3 g sodium hydroxide (analytical parity, Tianjin Kocniou Chemical Reagent Co., Ltd.) and 1.7 g alumina (chemical purity. China National Pharmaceutical (Group) Shanghai Chemical Reagent Co., Ltd.) were dissolved in 84.1 g tetraethylammonium hydroxide (35 wt % aqueous solution, Aladdin reagent (Shanghai) Co., Ltd.) and stirred until to be clear. 34.7 g ethyl orthosilicate was added therein dropwise (chemical purity. China pharmaceutical (Group) Shanghai chemical reagent company) and stirred for 2 hours. The obtained solution was allowed to stand at 50° C. for 12 hours to perform aging and then to stand at 70° C. for 2 days.

Preparation of synthetic gel: 0.7 g sodium aluminate (Al₂O₃: 48.3 wt %, Na₂O: 36.3 wt %, China National Pharmaceutical (Group) Shanghai Chemical Reagan Company), 0.20 g sodium hydroxide, and 10.30 g N,N-dimethyl-3,5-dipropylpiperidine hydroxide (25 wt %) were dissolved in 4.4 g deionized water and stirred until to be clear. 13.3 g silica sol (SiO₂: 30 wt %, Shenyang Chemical Co., Ltd.) was added thereof dropwise and stirred for 2 hours. Then 4.9 g the above-motored directing agent was added therein and stirred for 3 hours.

Synthesis of high-silica Y molecular sieve: The synthetic gel was transferred into a stainless-steel reactor, was placed at 120° C. for 5 days under autogenous pressure. Then the obtained solid was separated from liquid, washed to be neutrality, and dried at 100° C. for 12 hours. The obtained sample was denoted as sale Y1.

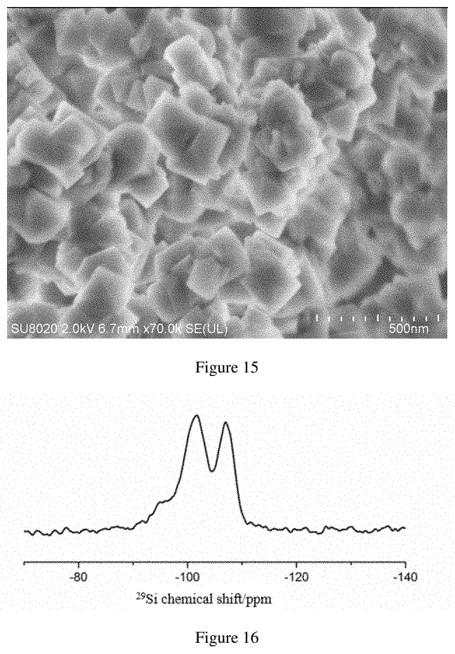

X-ray diffraction (XRD) spectrum of sample Y1 is shown in FIG. 14, demonstrating that the sample Y1 is molecular sieve having FAU framework structure. Scanning electron microscope (SEM) image thereof is shown in FIG. 15. demonstrating that the particles of sample Y1 are small pieces with a size ranging from 50 nm to 200 nm. ²⁹Si MAS NMR spectrum thereof is shown in FIG. 16. The fitting calculation shows that the silica-alumina ratio in the framework is consistent with the calculations results conducted by XRF. According to the XRF and ¹³C MAS NMR normalization analysis, the element constitution of sample Y1 is 0.07Na.0.02R1².0.05R2¹ (Si_{0.85}Al_{0.14})O₂, wherein, R1² is a tetraethylammonium hydroxide, R2¹ is N,N-dimethyl-3,5-dipropyl-piperidine hydroxide.

### Example 11: Preparation of Samples Y2-Y30

The preparation process of any one of samples Y2-Y30 is the same as that of Example 10. The raw materials for preparing samples Y2-Y30, molar ratio thereof, crystallization conditions, crystal structure, and silica-alumina ratio (the silica-alumina ratio of the obtained product is measured by X-ray fluorescence analyzer (XRF) are shown in Table 3. Aging temperature and time for preparing directing agent, addition amount of directing agent and sample constitution are shown in Table 10.

### Comparative Example 5: Preparation of Comparative Samples S1-S30

The specific preparation process is the same as that in the preparation of sample Y1 in Example 10, except that there is no directing agent preparation step, and there is not addition of directing agent in the subsequent gel synthesis step. The types of raw materials, molar ratio thereof, crystallization conditions and product structure of the prepared products are shown in Table 11. The samples obtained are denoted as comparative samples S1-S30.

### Comparative Example 6: Preparation of Comparative Samples T1-T30

The specific preparation process is the same as that m to preparation of sample Y1 in Example 10, except that after the batching step of the directing agent is completed, only stirring at room temperature for 2 hours without aging was performed. Types of raw materials, molar ratio thereof, crystallization conditions, addition amount of directing agent and product structure of each synthesized product are shown in Table 12. The samples obtained are denoted as comparative samples T1-T30.

### Example 12: Characterization and Analysis of Samples Y1-Y30 and Comparative Samples S1-S30 and T1-T30

The phases of samples Y1-Y30 and comparative samples S1-S30 and T1-T30 were analyzed by X-my diffraction method.

The results show that each of samples Y1-Y30 prepared in Examples 10 and 11 is Y molecular sieve with both high purity and high crystallinity. The XRD spectrum of sample Y1 as typical representative is shown in FIG. 14. SEM image thereof is shown in FIG. 15, and Si NMR thereof is shown in FIG. 16. The XRD spectrum result of my one of samples Y2-Y30 is close to FIG. 14. In other words, the diffraction peak positions and shapes are substantially identical. The relative peak intensity fluctuates within ±5% depending on the change of synthesis conditions, demonstrating that any of samples Y1-Y30 has the structural characteristics of Y zeolite and has no impurities.

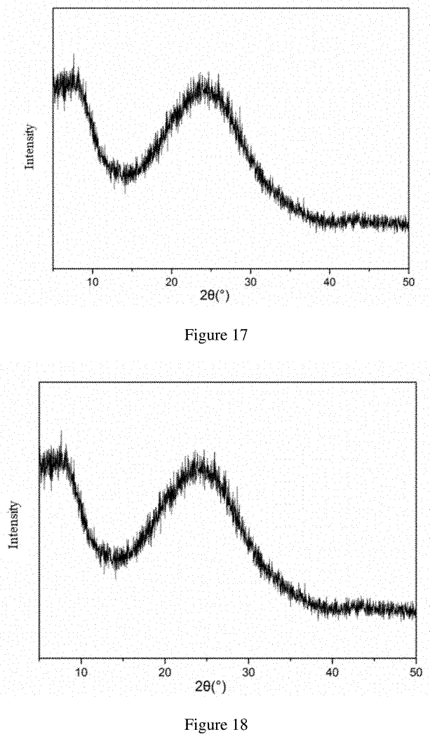

In tables 9 and 10, the comparative samples S1-S30 and the comparative samples T1-T30 are all amorphous. As a typical representative, the XRD spectra of the comparative sample S1 and the comparative sample T1 are shown in FIG. 17 and FIG. 18, respectively. It can be seen that during the synthesis of high-silica Y molecular sieve, the addition of a directing agent is necessary, and high-temperature aging must be carried out during preparation of the directing agent to induce crystallization, which is the key to the synthesis of high-silica Y molecular sieve.

TABLE 9
Types of raw materials, molar ratio thereof, crystallization conditions, and crystal structure of samples Y1-Y30

| | | | | | Crystal- | Crys- | |
|---|---|---|---|---|---|---|---|
| | | | Crystal- | | lization | tal | Silica- |
| Sam- | | | lization | | manner/ | struc- | Alumina |
| ple | Directing agent constitution | Initial gel constitution | temperature | | time | ture | ratio |
| Y1 | 10SiO₂¹:1Al₂O₃¹:1Na₂O:12R1²:180H₂O | 20SiO₂¹:1Al₂O₃¹:2.0Na₂O:3.6R2¹:360H₂O | 130° | C. | Dynamic | FAU | 12 |
| | | | | | 5 days | | |
| Y2 | 10SiO₂¹:1Al₂O₃¹:1Na₂O:10R1¹:180H₂O | 15SiO₂¹:1Al₂O₃¹:1.8Na₂O:3R2¹:200H₂O | 130° | C. | Static | FAU | 9 |
| | | | | | 4 days | | |
| Y3 | 30SiO₂:1Al₂O₃⁴:1.5Na₂O:30R1¹:600H₂O | 20SiO₂¹:1Al₂O₃²:1.8Na₂O:4R2¹:400H₂O | 110° | C. | Dynamic | FAU | 11 |
| | | | | | 6 days | | |
| Y4 | 20SiO₂¹:1Al₂O₃¹:10R1¹:8R1¹:400H₂O | 50SiO₂¹:1Al₂O₃ [symbol] :8.0Na₂O:9R2²:800H₂O | 140° | C. | Dynamic | FAU | 15 |
| | | | | | 8 days | | |
| Y5 | 10SiO₂²:1Al₂O₃²:0.5Na₂O:10R1¹:200H₂O | 20SiO₂²:1Al₂O₃²:3.0Na₂O:4R2²:400H₂O | 120° | C. | Static | FAU | 8 |
| | | | | | 6 days | | |
| Y6 | 10SiO₂²:1Al₂O₃²:0.5Na₂O:14R1²:200H₂O | 20SiO₂²:1Al₂O₃ [symbol] :4.0Na₂O:4R2 [symbol] :400H₂O | 130° | C. | Static | FAU | 11 |
| | | | | | 3 days | | |
| Y7 | 10SiO₂²:1Al₂O₃¹:1Na₂O:10R1 [symbol] :180H₂O | 200SiO₂²:1Al₂O₃²:25Na₂O:40R2 [symbol] :3000H₂O | 120° | C. | Dynamic | FAU | 29 |
| | | | | | 8 days | | |
| Y8 | 30SiO₂²:1Al₂O₃⁴:1.5Na₂O:35R1²:600H₂O | 50SiO₂²:1Al₂O₃²:8.0Na₂O:6R2 [symbol] :800H₂O | 140° | C. | Dynamic | FAU | 19 |
| | | | | | 6 days | | |
| Y9 | 30SiO₂²:1Al₂O₃⁴:1.0Na₂O:34R1⁴:600H₂O | 60SiO₂²:1Al₂O₃²:9.0Na₂O:8R2 [symbol] :900H₂O | 140° | C. | Dynamic | FAU | 20 |
| | | | | | 6 days | | |
| Y10 | 15SiO₂ [symbol] :1Al₂O₃ [symbol] :1.8Na₂O:12R1 [symbol] :180H₂O | 15SiO₂²:1Al₂O₃²:1.8Na₂O:4R2⁴:200H₂O | 120° | C. | Static | FAU | 9 |
| | | | | | 8 days | | |
| Y11 | 10SiO₂ [symbol] :1Al₂O₃²:1Na₂O:10R1 [symbol] :180H₂O | 30SiO₂²:1Al₂O₃ [symbol] :5.0Na₂O:6R2⁴:500H₂O | 120° | C. | Static | FAU | 13 |
| | | | | | 10 days | | |
| Y12 | 15SiO₂ [symbol] :1Al₂O₃ [symbol] :1.8Na₂O:12R1 [symbol] :180H₂O | 20SiO₂²:1Al₂O₃ [symbol] :3.0Na₂O:5R2⁴:400H₂O | 120° | C. | Static | FAU | 10 |
| | | | | | 12 days | | |
| Y13 | 10SiO₂ [symbol] :1Al₂O₃²:1Na₂O:10R1 [symbol] :180H₂O | 30SiO₂²:1Al₂O₃ [symbol] :5.0Na₂O:6R2 [symbol] :500H₂O | 100° | C. | Static | FAU | 13 |
| | | | | | 8 days | | |
| Y14 | 15SiO₂ [symbol] :1Al₂O₃ [symbol] :1Na₂O:10R1 [symbol] :200H₂O | 100SiO₂²:1Al₂O₃ [symbol] :12Na₂O:20R2 [symbol] :2000H₂O | 120° | C. | Dynamic | FAU | 20 |
| | | | | | 5 days | | |
| Y15 | 10SiO₂ [symbol] :1Al₂O₃ [symbol] :2Na₂O:8R1 [symbol] :100H₂O | 150SiO₂ [symbol] :1Al₂O₃²:15Na₂O:28R2 [symbol] :2800H₂O | 120° | C. | Dynamic | FAU | 25 |
| | | | | | 5 days | | |
| Y16 | 15SiO₂ [symbol] :1Al₂O₃²:15R1 [symbol] :150H₂O | 80SiO₂ [symbol] :1Al₂O₃²:10Na₂O:15R2 [symbol] :1500H₂O | 110° | C. | Dynamic | FAU | 18 |
| | | | | | 5 days | | |
| Y17 | 30SiO₂ [symbol] :1Al₂O₃ [symbol] :20R1 [symbol] :600H₂O | 100SiO₂ [symbol] :1Al₂O₃ [symbol] :12Na₂O:20R2 [symbol] :1800H₂O | 115° | C. | Dynamic | FAU | 20 |
| | | | | | 5 days | | |
| Y18 | 5SiO₂ [symbol] :1Al₂O₃ [symbol] :1Na₂O:10R1 [symbol] :100H₂O | 60SiO₂ [symbol] :1Al₂O₃ [symbol] :5Na₂O:12R2#Z,899⁶:1100H₂O | 130° | C. | Dynastic | FAU | 15 |
| | | | | | 8 days | | |
| Y19 | 15SiO₂ [symbol] :1Al₂O₃ [symbol] :1.8Na₂O:12R1⁴:180H₂O | 45SiO₂ [symbol] :1Al₂O₃ [symbol] :4Na₂O:8R2⁶:800H₂O | 120° | C. | Static | FAU | 14 |
| | | | | | 8 days | | |
| Y20 | 20SiO₂⁴:1Al₂O₃⁴:0.5Na₂O:18R1 [symbol] :400H₂O | 10SiO₂ [symbol] :1Al₂O₃²:0.1Na₂O:4R2⁷:150H₂O | 90° | C. | Static | FAU | 7 |
| | | | | | 15 days | | |
| Y21 | 10SiO₂⁴:1Al₂O₃⁷:0.5Na₂O:8R1 [symbol] :200H₂O | 15SiO₂ [symbol] :1Al₂O₃²:1.8Na₂O:3R2⁷:200H₂O | 140° | C. | Static | FAU | 8 |
| | | | | | 5 days | | |
| Y22 | 15SiO₂²:1Al₂O₃⁷:0.5Na₂O:12R1 [symbol] :280H₂O | 20SiO₂ [symbol] :1Al₂O₃ [symbol] :1.8Na₂O:4R2⁸:400H₂O | 110° | C. | Static | FAU | 12 |
| | | | | | 5 days | | |
| Y23 | 12SiO₂ [symbol] :1Al₂O₃⁷:0.5Na₂O:10R1⁴:200H₂O | 50SiO₂ [symbol] :1Al₂O₃ [symbol] :5Na₂O:8R2⁸:800H₂O | 120° | C. | Dynamic | FAU | 20 |
| | | | | | 6 days | | |
| Y24 | 20SiO₂⁴:1Al₂O₃ [symbol] :0.5Na₂O:18R1 [symbol] :400H₂O | 20SiO₂ [symbol] :1Al₂O₃ [symbol] :4.0Na₂O:4R2⁹:400H₂O | 140° | C. | Dynamic | FAU | 12 |
| | | | | | 5 days | | |
| Y25 | 10SiO₂ [symbol] :1Al₂O₃ [symbol] :0.5Na₂O:8R1 [symbol] :400H₂O | 15SiO₂⁴:1Al₂O₃ [symbol] :3.0Na₂O:4R2⁹:280H₂O | 110° | C. | Dynamic | FAU | 10 |
| | | | | | 5 days | | |
| Y26 | 8SiO₂ [symbol] :1Al₂O₃ [symbol] :8R1 [symbol] :150H₂O | 100SiO₂⁴:1Al₂O₃⁷:10Na₂O:18R2¹⁰:2000H₂O | 120° | C. | Dynamic | FAU | 20 |
| | | | | | 5 days | | |
| Y27 | 10SiO₂ [symbol] :1Al₂O₃ [symbol] :2Na₂O:7R1 [symbol] :180H₂O | 150SiO₂ [symbol] :1Al₂O₃⁷:15Na₂O:30R2¹⁰:2800H₂O | 120° | C. | Dynamic | FAU | 30 |
| | | | | | 8 days | | |
| Y28 | 9SiO₂²:1Al₂O₃⁶:0.5Na₂O:8R1 [symbol] :150H₂O | 80SiO₂⁴:1Al₂O₃ [symbol] :10Na₂O:15R21¹:1500H₂O | 120° | C. | Dynamic | FAU | 16 |
| | | | | | 7 days | | |
| Y29 | 25SiO₂⁴:1Al₂O₃⁶:1Na₂O:8R1²:180H₂O | 40SiO₂⁴:1Al₂O₃ [symbol] :5Na₂O:10R2¹¹:1500H₂O | 120° | C. | Dynamic | FAU | 12 |
| | | | | | 5 days | | |
| Y30 | 30SiO₂⁴:1Al₂O₃⁶:3Na₂O:40R1 [symbol] :600H₂O | 150SiO₂⁴:1Al₂O₃⁷:14Na₂O:25R2¹¹:2500H₂O | 120° | C. | Dynamic | FAU | 25 |
| | | | | | 6 days | | |

Note:
Al₂O₃¹: Alumina:
Al₂O₃²: Aluminum isopropoxide:
Al₂O₃³: Sodium aluminate:
Al₂O₃⁴: Aluminum nitrate:
Al₂O₃⁵: Aluminum tri-sec-butoxide:
Al₂O₃⁶: Aluminum sulfate:
Al₂O₃⁷: Aluminum powder:
SiO₂¹: Silica sol:
SiO₂²: Ethyl orthosilicate:
SiO₂³: Fumed silica:
SiO₂⁴: Silica gel:
R1¹: Tetramethylammonium hydroxide:
R1²: Tetraethylammonium hydroxide:
R1³: Tetrapropylammonium hydroxide:
R1⁴: Choline:
R2¹: N,N-dimethyl-3,5-dipropylpiperidine hydroxide:
R2²: N,N-diethyl-2,6-dimethylpiperidine hydroxide:
R2³: N,N-diethyl-3,5-dipropylpiperidine hydroxide:
R2⁴: N-ethyl-3-butylpyridine
R2⁵: N,N-diethyl-3,5-dipropylpiperidine hydroxide:
R2⁶: 1,4-dipropylpiperazine
R2⁷: N-methylpyridine.
R2⁸: N-ethyl-3-butylpyridine
R2⁹: 1-ethyl-3-butylimidazole hydroxide
R2¹⁰: 1-ethyl-4-gutyl-5-methylpiperazine
R2¹¹: 1-ethyl-3-butyl-4-propylimidazole hydroxide [symbol]
indicates data missing or illegible when filed

TABLE 10
Aging temperature and time for preparing directing agent, addition
amount of directing agent and sample constitution of samples Y1-Y30

| | | Addition | |
|---|---|---|---|
| | | amount of | |
| | Aging time for preparing | directing | |
| Sample | directing agent | agent | Sample constitution |
| Y1 | 40° C. 5 days + 60° C. 4 days | 8% | 0.07Na0.02R1²0.05R2¹(Si [symbol] Al [symbol] )O₂ |
| Y2 | 120° C. 1 day | 15% | 0.09Na0.04R1 [symbol] 0.05R2¹(Si [symbol] Al [symbol] )O₂ |
| Y3 | 40° C. 1 day + 80° C. 4 days | 10% | 0.07K0.03R1 [symbol] 0.05R2¹(Si [symbol] Al [symbol] )O₂ |
| Y4 | 100° C. 2 days | 10% | 0.03Na0.04R1 [symbol] 0.05R2²(Si [symbol] Al [symbol] )O₂ |
| Y5 | 90° C. 3 days | 20% | 0.08Na0.04R1 [symbol] 0.08R2²(Si [symbol] Al [symbol] )O₂ |
| Y6 | 80° C. 5 days | 10% | 0.07Na0.05R1²0.06R2³(Si [symbol] Al [symbol] )O₂ |
| Y7 | 40° C. 0.5 day + 80° C. 2 days | 5% | 0.02Na0.01R1 [symbol] 0.04R2³(Si [symbol] Al [symbol] )O₂ |
| Y8 | 40° C. 0.5 day + 60° C. 2 days | 8% | 0.03Na0.04R1²0.04R2³(Si [symbol] Al [symbol] )O₂ |
| Y9 | 30° C. 3 days + 100° C. 2 days | 10% | 0.03Na0.02R1⁴0.04R2³(Si [symbol] Al [symbol] )O₂ |
| Y10 | 30° C. 3 days + 50° C. 8 days | 12% | 0.09Na0.04R1 [symbol] 0.05R2⁴(Si [symbol] Al [symbol] )O₂ |
| Y11 | 40° C. 15 days | 7% | 0.07Na0.02R1 [symbol] 0.04R2⁴(Si [symbol] Al [symbol] )O₂ |
| Y12 | 30° C. 25 days | 5% | 0.09Na0.02R1 [symbol] 0.06R2⁴(Si [symbol] Al [symbol] )O₂ |
| Y13 | 100° C. 5 days | 15% | 0.09Na0.02R1 [symbol] 0.05R2⁵(Si [symbol] Al [symbol] )O₂ |
| Y14 | 80° C. 7 days | 10% | 0.04Na0.01R1 [symbol] 0.04R2⁵(Si [symbol] Al [symbol] )O₂ |
| Y15 | 110° C. 1.5 days | 18% | 0.03Na0.01R1 [symbol] 0.03R2⁵(Si [symbol] Al [symbol] )O₂ |
| Y16 | 90° C. 3 days | 18% | 0.04Na0.02R1 [symbol] 0.04R2⁵(Si [symbol] Al [symbol] )O₂ |
| Y17 | 80° C. 5 days | 18% | 0.03Na0.02R1 [symbol] 0.04R2⁶(Si [symbol] Al [symbol] )O₂ |
| Y18 | 60° C. 8 days | 8% | 0.06Na0.02R1 [symbol] 0.04R2⁶(Si [symbol] Al [symbol] )O₂ |
| Y19 | 40° C. 11 days | 11% | 0.06Na0.02R1 [symbol] 0.04R2⁶(Si [symbol] Al [symbol] )O₂ |
| Y20 | 80° C. 7 days | 5% | 0.13Na0.04R1 [symbol] 0.05R2⁷(Si [symbol] Al [symbol] )O₂ |
| Y21 | 80° C. 7 days | 10% | 0.11Na0.04R1 [symbol] 0.05R2⁷(Si [symbol] Al [symbol] )O₂ |
| Y22 | 100° C. 5 days | 10% | 0.09Na0.02R1 [symbol] 0.03R2⁸(Si [symbol] Al [symbol] )O₂ |
| Y23 | 110° C. 2 days | 10% | 0.03Na0.02R1 [symbol] 0.04R2⁸(Si [symbol] Al [symbol] )O₂ |
| Y24 | 70° C. 7 days | 18% | 0.08Na0.01R1 [symbol] 0.05R2⁹(Si [symbol] Al [symbol] )O₂ |
| Y25 | 80° C. 5 days | 8% | 0.09Na0.04R1 [symbol] 0.04R2⁹(Si [symbol] Al [symbol] )O₂ |
| Y26 | 60° C. 8 days | 9% | 0.04Na0.02R1 [symbol] 0.03R2¹⁰(Si [symbol] Al [symbol] )O₂ |
| Y27 | 120° C. 1 day | 20% | 0.02Na0.01R1 [symbol] 0.03R2¹⁰(Si [symbol] Al [symbol] )O₂ |
| Y28 | 110° C. 3 days | 10% | 0.04Na0.04R1 [symbol] 0.03R2¹¹(Si [symbol] Al [symbol] )O₂ |
| Y29 | 110° C. 3 days | 10% | 0.06Na0.03R1 [symbol] 0.05R2¹¹(Si [symbol] Al [symbol] )O₂ |
| Y30 | 80° C. 7 days | 10% | 0.02Na0.01R1 [symbol] 0.04R2¹¹(Si [symbol] Al [symbol] )O₂ |

Note:
R1¹: tetramethylammonium hydroxide:
R1²: Tetraethylammonium hydroxide:
R1³: Tetrapropylammonium hydroxide:
R1⁴: Choline:
R2¹: N,N-dimethyl-3,5-dipropylpiperidine hydroxide
R2²: N,N-diethyl-2,6-dimethylpiperidine hydroxide
R2³: N,N-diethyl-3,5-dipropylpiperidine hydroxide
R2⁴: N-ethyl-3-butylpyridine:
R2⁵: N,N-diethyl-3,5-dipropylpiperidine hydroxide:
R2⁶: 1,4-dipropylpiperazine
R2⁷: N-methylpyridine
R2⁸: N-ethyl-3-butylpyridine
R2⁹: 1-ethyl-3-butylimidazole hydroxide
R2¹⁰: 1-ethyl-4-gutyl-5-methylpiperazine
R2¹¹: 1-ethyl-3-butyl-4-propylimidazole hydroxide [symbol]
indicates data missing or illegible when filed

TABLE 11
Types of raw materials, molar ratio thereof, crystallization
conditions, and crystal structure of samples S1-S30

| | | Crystallization | | Crystallization | Product |
|---|---|---|---|---|---|
| Sample | Initial gel constitution | temperature | | time | structure |
| S1 | 20SiO₂¹:1Al₂O₃ [symbol] :2.0Na₂O:3.6R2 [symbol] :360H₂O | 130° | C. | Dynamic 5 days | Amorphous |
| S2 | 15SiO₂¹:1Al₂O₃ [symbol] :1.8Na₂O:3R2 [symbol] :200H₂O | 130° | C. | Static 4 days | Amorphous |
| S3 | 20SiO₂¹:1Al₂O₃²:1.8Na₂O:4R2 [symbol] :400H₂O | 110° | C. | Dynamic 6 days | Amorphous |
| S4 | 50SiO₂¹:1Al₂O₃ [symbol] :8.0Na₂O:9R2²:800H₂O | 140° | C. | Dynamic 8 days | Amorphous |
| S5 | 20SiO₂²:1Al₂O₃²:3.0Na₂O:4R2²:400H₂O | 120° | C. | Static 6 days | Amorphous |
| S6 | 20SiO₂²:1Al₂O₃ [symbol] :4.0Na₂O:4R2 [symbol] :400H₂O | 130° | C. | Static 3 days | Amorphous |
| S7 | 200SiO₂²:1Al₂O₃²:25Na₂O:40R2 [symbol] :3000H₂O | 120° | C. | Dynamic 8 days | Amorphous |
| S8 | 50SiO₂²:1Al₂O₃²:8.0Na₂O:6R2 [symbol] :800H₂O | 140° | C. | Dynamic 6 days | Amorphous |
| S9 | 60SiO₂²:1Al₂O₃²:9.0Na₂O:8R2 [symbol] :900H₂O | 140° | C. | Dynamic 6 days | Amorphous |
| S10 | 15SiO₂²:1Al₂O₃ [symbol] :1.8Na₂O:4R2⁴:200H₂O | 120° | C. | Static 8 days | Amorphous |
| S11 | 30SiO₂²:1Al₂O₃ [symbol] :5.0Na₂O:6R2⁴:500H₂O | 120° | C. | Static 10 days | Amorphous |
| S12 | 20SiO₂²:1Al₂O₃ [symbol] :3.0Na₂O:5R2⁴:400H₂O | 120° | C. | Static 12 days | Amorphous |
| S13 | 30SiO₂²:1Al₂O₃ [symbol] :5.0Na₂O:6R2⁵:500H₂O | 120° | C. | Static 8 days | Amorphous |
| S14 | 100SiO₂²:1Al₂O₃ [symbol] :12Na₂O:20R2⁵:2000H₂O | 100° | C. | Dynamic 5 days | Amorphous |
| S15 | 150SiO₂ [symbol] :1Al₂O₃ [symbol] :15Na₂O:28R2⁵:2800H₂O | 120° | C. | Dynamic 5 days | Amorphous |
| S16 | 80SiO₂ [symbol] :1Al₂O₃ [symbol] :10Na₂O:15R2⁵:1500H₂O | 110° | C. | Dynamic 5 days | Amorphous |
| S17 | 100SiO₂ [symbol] :1Al₂O₃ [symbol] :12Na₂O:20R2⁶:1800H₂O | 115° | C. | Dynamic 5 days | Amorphous |
| S18 | 60SiO₂ [symbol] :1Al₂O₃ [symbol] :5Na₂O:12R2⁶:1100H₂O | 130° | C. | Dynamic 8 days | Amorphous |
| S19 | 45SiO₂ [symbol] :1Al₂O₃ [symbol] :4Na₂O:8R2⁶:800H₂O | 120° | C. | Static 8 days | Amorphous |
| S20 | 15SiO₂ [symbol] :1Al₂O₃ [symbol] :1.8Na₂O:3R2⁷:200H₂O | 90° | C. | Static 15 days | Amorphous |
| S21 | 20SiO₂ [symbol] :1Al₂O₃ [symbol] :1.8Na₂O:4R2 [symbol] :400H₂O | 140° | C. | Static 5 days | Amorphous |
| S22 | 50SiO₂ [symbol] :1Al₂O₃ [symbol] :5Na₂O:8R2⁸:800H₂O | 110° | C. | Static 5 days | Amorphous |
| S23 | 20SiO₂ [symbol] :1Al₂O₃ [symbol] :4.0Na₂O:4R2 [symbol] :400H₂O | 120° | C. | Dynamic 6 days | Amorphous |
| S24 | 15SiO₂⁴:1Al₂O₃ [symbol] :3.0Na₂O:4R2⁹:280H₂O | 140° | C. | Dynamic 5 days | Amorphous |
| S25 | 100SiO₂⁴:1Al₂O₃ [symbol] :10Na₂O:18R2¹⁰:2000H₂O | 110° | C. | Dynamic 5 days | Amorphous |
| S26 | 150SiO₂⁴:1Al₂O₃ [symbol] :15Na₂O:30R2¹⁰:2800H₂O | 120° | C. | Dynamic 5 days | Amorphous |
| S27 | 80SiO₂⁴:1Al₂O₃ [symbol] :10Na₂O:15R2¹⁰:1500H₂O | 120° | C. | Dynamic 8 days | Amorphous |
| S28 | 40SiO₂⁴:1Al₂O₃ [symbol] :5Na₂O:10R2¹¹:1500H₂O | 120° | C. | Dynamic 7 days | Amorphous |
| S29 | 150SiO₂⁴:1Al₂O₃ [symbol] :14Na₂O:25R2¹¹:2500H₂O | 120° | C. | Dynamic 5 days | Amorphous |
| S30 | 15SiO₂ [symbol] :1Al₂O₃ [symbol] :1.8Na₂O:3R2 [symbol] :200H₂O | 120° | C. | Dynamic 6 days | Amorphous |

Note:
Al₂O₃¹: alumina:
Al₂O₃²: Aluminum isopropoxide:
Al₂O₃³: Sodium aluminate:
Al₂O₃⁴: Aluminum nitrate:
Al₂O₃⁵: Aluminum tri-sec-butoxide:
Al₂O₃⁶: Aluminum sulfate:
Al₂O₃⁷: Aluminum powder:
SiO₂¹: silica sol:
SiO₂²: Ethyl orthosilicate:
SiO₂³: fumed silica:
SiO₂⁴: Silica gel:
R2¹: N,N-dimethyl-3,5-dipropylpiperidine hydroxide:
R2²: N,N-diethyl-2,6-dimethylpiperidine hydroxide:
R2³: N,N-diethyl-3,5-dipropylpiperidine hydroxide:
R2⁴: N-ethyl-3-butylpyridine:
R2⁵: N,N-diethyl-3,5-dipropylpiperidine hydroxide:
R2⁶: 1,4-dipropylpiperazine
R2⁷: N-methylpyridine:
R2⁸: N-ethyl-3-butylpyridine
R2⁹: 1-ethyl-3-butylimidazole hydroxide
R2¹⁰: 1-ethyl-4-gutyl-5-methylpiperazine
R2¹¹: 1-ethyl-3-butyl-4-propylimidazole hydroxide [symbol]
indicates data missing or illegible when filed

TABLE 11
Types of raw materials, addition amount of directing agent, molar ratio thereof,
crystallization conditions, and product structure of samples T1-T30

| | | addition | | | | Crystal- | |
|---|---|---|---|---|---|---|---|
| | | amount | | Crystal- | | lization | |
| Sam- | | of seed | | lization | | manner/ | Product |
| ple | Directing agent constitution | crystal | Initial gel constitution | temperature | | time | structure |
| T1 | 10SiO₂ [symbol] :1Al₂O₃¹:1Na₂O:12R1²:180H₂O | 8% | 20SiO₂¹:1Al₂O₃¹:2.0Na₂O:3.6R2¹:360H₂O | 130° | C. | Dynamic | Amorphous |
| | | | | | | 5 days | |
| T2 | 10SiO₂ [symbol] :1Al₂O₃¹:1Na₂O:10R1 [symbol] :180H₂O | 15% | 15SiO₂¹:1Al₂O₃¹:1.8Na₂O:3R2 [symbol] :200H₂O | 130° | C. | Static | Amorphous |
| | | | | | | 4 days | |
| T3 | 30SiO₂:1Al₂O₃¹:1.5Na₂O:30R1¹:600H₂O | 10% | 20SiO₂¹:1Al₂O₃ [symbol] :1.8Na₂O:4R2²:400H₂O | 110° | C. | Dynamic | Amorphous |
| | | | | | | 6 days | |
| T4 | 20SiO₂ [symbol] :1Al₂O₃ [symbol] :10R1 [symbol] :8R1 [symbol] :400H₂O | 10% | 50SiO₂ [symbol] :1Al₂O₃ [symbol] :8.0Na₂O:9R2 [symbol] :800H₂O | 140° | C. | Dynamic | Amorphous |
| | | | | | | 8 days | |
| T5 | 10SiO₂²:1Al₂O₃²:0.5Na₂O:10R1 [symbol] :200H₂O | 20% | 20SiO₂²:1Al₂O₃²:3.0Na₂O:4R2²:400H₂O | 120° | C. | Static | Amorphous |
| | | | | | | 5 days | |
| T6 | 10SiO₂²:1Al₂O₃²:0.5Na₂O:14R1²:200H₂O | 10% | 20SiO₂²:1Al₂O₃²:4.0Na₂O:4R2 [symbol] :400H₂O | 130° | C. | Static | Amorphous |
| | | | | | | 3 days | |
| T7 | 10SiO₂²:1Al₂O₃ [symbol] :1Na₂O:10R1 [symbol] :180H₂O | 5% | 200SiO₂²:1Al₂O₃²:25Na₂O:40R2 [symbol] :3000H₂O | 120° | C. | Dynamic | Amorphous |
| | | | | | | 8 days | |
| T8 | 30SiO₂²:1Al₂O₃⁴:1.5Na₂O:35R1²:600H₂O | 8% | 50SiO₂²:1Al₂O₃²:8.0Na₂O:6R2 [symbol] :800H₂O | 140° | C. | Dynamic | Amorphous |
| | | | | | | 6 days | |
| T9 | 30SiO₂²:1Al₂O₃⁴:1.0Na₂O:34R1⁴:600H₂O | 10% | 60SiO₂²:1Al₂O₃²:9.0Na₂O:8R2 [symbol] :900H₂O | 140° | C. | Dynamic | Amorphous |
| | | | | | | 6 days | |
| T10 | 15SiO₂ [symbol] :1Al₂O₃ [symbol] :1.8Na₂O:12R1 [symbol] :180H₂O | 12% | 15SiO₂²:1Al₂O₃²:1.8Na₂O:4R2⁴:200H₂O | 120° | C. | Static | Amorphous |
| | | | | | | 8 days | |
| T11 | 10SiO₂ [symbol] :1Al₂O₃²:1Na₂O:10R1 [symbol] :180H₂O | 7% | 30SiO₂²:1Al₂O₃ [symbol] :5.0Na₂O:6R2⁴:500H₂O | 120° | C. | Static | Amorphous |
| | | | | | | 10 days | |
| T12 | 15SiO₂ [symbol] :1Al₂O₃ [symbol] :1.8Na₂O:12R1 [symbol] :180H₂O | 5% | 20SiO₂²:1Al₂O₃ [symbol] :3.0Na₂O:5R2⁴:400H₂O | 120° | C. | Static | Amorphous |
| | | | | | | 12 days | |
| T13 | 10SiO₂ [symbol] :1Al₂O₃²:1Na₂O:10R1 [symbol] :180H₂O | 15% | 30SiO₂²:1Al₂O₃ [symbol] :5.0Na₂O:6R2 [symbol] :500H₂O | 120° | C. | Static | Amorphous |
| | | | | | | 8 days | |
| T14 | 15SiO₂ [symbol] :1Al₂O₃ [symbol] :1Na₂O:10R1 [symbol] :200H₂O | 10% | 100SiO₂²:1Al₂O₃ [symbol] :12Na₂O:20R2 [symbol] :2000H₂O | 100° | C. | Dynamic | Amorphous |
| | | | | | | 5 days | |
| T15 | 10SiO₂ [symbol] :1Al₂O₃ [symbol] :2Na₂O:8R1 [symbol] :100H₂O | 18% | 150SiO₂ [symbol] :1Al₂O₃²:15Na₂O:25R2 [symbol] :2800H₂O | 120° | C. | Dynamic | Amorphous |
| | | | | | | 5 days | |
| T16 | 15SiO₂ [symbol] :1Al₂O₃²:15R1 [symbol] :250H₂O | 18% | 80SiO₂ [symbol] :1Al₂O₃²:10Na₂O:15R2 [symbol] :1500H₂O | 110° | C. | Dynamic | Amorphous |
| | | | | | | 5 days | |
| T17 | 30SiO₂ [symbol] :1Al₂O₃ [symbol] :R:600H₂O | 18% | 100SiO₂ [symbol] :1Al₂O₃ [symbol] :12Na₂O:20R2⁶:1800H₂O | 115° | C. | Dynamic | Amorphous |
| | | | | | | 5 days | |
| T18 | 5SiO₂ [symbol] :1Al₂O₃ [symbol] :1Na₂O:10R1 [symbol] :100H₂O | 8% | 60SiO₂ [symbol] :1Al₂O₃ [symbol] :5Na₂O:12R2 [symbol] :1100H₂O | 130° | C. | Dynamic | Amorphous |
| | | | | | | 8 days | |
| T19 | 15SiO₂ [symbol] :1Al₂O₃ [symbol] :1.8Na₂O:12R1⁴:180H₂O | 11% | 45SiO₂ [symbol] :1Al₂O₃ [symbol] :4Na₂O:8R2⁶:800H₂O | 120° | C. | Static | Amorphous |
| | | | | | | 8 days | |
| T20 | 20SiO₂⁴:1Al₂O₃⁴:0.5Na₂O:18R1 [symbol] :400H₂O | 5% | 10SiO₂ [symbol] :1Al₂O₃²:0.1Na₂O:4R2 [symbol] :150H₂O | 90° | C. | Static | Amorphous |
| | | | | | | 15 days | |
| T21 | 10SiO₂⁴:1Al₂O₃ [symbol] :0.5Na₂O:8R1 [symbol] :200H₂O | 10% | 15SiO₂ [symbol] :1Al₂O₃²:1.8Na₂O:3R2 [symbol] :200H₂O | 140° | C. | Static | Amorphous |
| | | | | | | 5 days | |
| T22 | 15SiO₂²:1Al₂O₃⁷:0.5Na₂O:12R1 [symbol] :280H₂O | 10% | 20SiO₂ [symbol] :1Al₂O₃ [symbol] :1.8Na₂O:4R2 [symbol] :400H₂O | 110° | C. | Static | Amorphous |
| | | | | | | 5 days | |
| T23 | 12SiO₂ [symbol] :1Al₂O₃⁷:0.5Na₂O:10R1⁴:200H₂O | 10% | 50SiO₂ [symbol] :1Al₂O₃ [symbol] :5Na₂O:8R2⁸:800H₂O | 120° | C. | Dynamic | Amorphous |
| | | | | | | 6 days | |
| T24 | 20SiO₂⁴:1Al₂O₃ [symbol] :0.5Na₂O:18R1 [symbol] :400H₂O | 18% | 20SiO₂⁴:1Al₂O₃ [symbol] :4.0Na₂O:4R2 [symbol] :400H₂O | 140° | C. | Dynamic | Amorphous |
| | | | | | | 5 days | |
| T25 | 10SiO₂ [symbol] :1Al₂O₃ [symbol] :0.5Na₂O:8R1 [symbol] :400H₂O | 8% | 15SiO₂⁴:1Al₂O₃ [symbol] :3.0Na₂O:4R2 [symbol] :280H₂O | 110° | C. | Dynamic | Amorphous |
| | | | | | | 5 days | |
| T26 | 8SiO₂ [symbol] :1Al₂O₃ [symbol] :8R1 [symbol] :150H₂O | 9% | 100SiO₂⁴:1Al₂O₃⁷:10Na₂O:18R2¹⁰:2000H₂O | 120° | C. | Dynamic | Amorphous |
| | | | | | | 5 days | |
| T27 | 10SiO₂ [symbol] :1Al₂O₃ [symbol] :2Na₂O:7R1 [symbol] :180H₂O | 20% | 150SiO₂⁴:1Al₂O₃⁷:15Na₂O:30R2¹⁰:2800H₂O | 120° | C. | Dynamic | Amorphous |
| | | | | | | 8 days | |
| T2B | 9SiO₂²:1Al₂O₃⁶:0.5Na₂O:8R1 [symbol] :150H₂O | 10% | 80SiO₂ [symbol] :1Al₂O₃ [symbol] :10Na₂O:15R2¹¹:1500H₂O | 120° | C. | Dynamic | Amorphous |
| | | | | | | 7 days | |
| T29 | 25SiO₂⁴:1Al₂O₃ [symbol] :1Na₂O:8R1 [symbol] :480H₂O | 10% | 40SiO₂ [symbol] :1Al₂O₃ [symbol] :5Na₂O:10R2¹¹:1500H₂O | 120° | C. | Dynamic | Amorphous |
| | | | | | | 5 days | |
| T30 | 30SiO₂⁴:1Al₂O₃ [symbol] :3Na₂O:40R1 [symbol] :600H₂O | 10% | 150SiO₂ [symbol] :1Al₂O₃⁷:14Na₂O:25R2¹¹:2500H₂O | 120° | C. | Dynamic | Amorphous |
| | | | | | | 6 days | |

Note:
Al₂O₃¹: Alumina:
Al₂O₃²: Aluminum isopropoxide:
Al₂O₃³: Sodium aluminate:
Al₂O₃⁴: Aluminum nitrate:
Al₂O₃⁵: Aluminum tri-sec-butoxide:
Al₂O₃⁶: Aluminum sulfate:
Al₂O₃⁷: Aluminum powder:
SiO₂¹: Silica sol:
SiO₂²: Ethyl orthosilicate:
SiO₂³: Fumed silica:
SiO₂⁴: Silica gel
R1¹: Tetramethylammonium hydroxide:
R1²: Tetraethylammonium hydroxide:
R1³: Tetrapropylammonium hydroxide:
R1⁴: Choline:
R2¹: N,N-dimethyl-3,5-dipropylpiperidine hydroxide
R2²: N,N-diethyl-2,6-dimethylpiperidine hydroxide
R2³: N,N-diethyl-3,5-dipropylpiperidine hydroxide
R2⁴: N-ethyl-3-butylpyridine
R2⁵: N,N-diethyl-3,5-dipropylpiperidine hydroxide
R2⁶: 1,4-dipropylpiperazine
R2⁷: N-methylpyridine
R2⁸: N-ethyl-3-butylpyridine
R2⁹: 1-ethyl-3-butylimidazole hydroxide
R2¹⁰: 1-ethyl-4-gutyl-5-methylpiperazine
R2¹¹: 1-ethyl-3-butyl-4-propylimidazole hydroxide [symbol]
indicates data missing or illegible when filed

The above example are only illustrative, and do not limit the present application in any form. Any change or modification made by the skilled in the art based on the technical content disclosed above, without departing from the spirit of the present application is equivalent example and falls within the scope of the present application.

1-45. (canceled)

46. A high-silica Y molecular sieve having FAU topology, wherein the anhydrous chemical constitution of the molecular sieve is as shown in formula I:
kM.mR1.nR2.(SiₓAl_{y})O₂ Formula I
wherein, M is at least one of alkali metal elements;
R1 and R2 represent organic templating agents;
k represents the number of moles of alkali metal element M per mole (SiₓAl_{y})O₂, k=0˜0.20;
m and n represent the number of moles of templating agents R¹ and R² per mole of (SiₓAl_{y})O₂, m=0˜0.20, n=0.01˜0.20;
x and y respectively represent the mole fractions of Si and Al, 2x/y=7˜40, and x+y=1;
R¹ and R² are independently one of nitrogen-containing heterocyclic compounds and derivatives thereof, and quaternary ammonium compounds;
a structural formula of the quaternary ammonium compound is as shown in formula II; 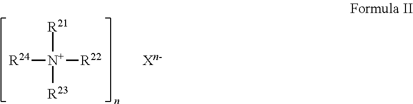
in formula II, R²¹, R²², R²³ and R²⁴ are independently at least one of C₁˜C₁₂ alkyl, C₁˜C₁₂ alkoxy, C₁˜C₁₂ hydroxyalkyl, aryl and adamantyl;
Xⁿ⁻ is one of OH⁻, Cl⁻, Br⁻, I⁻, NO₃⁻, HSO₄⁻, H₂PO₃⁻, SO₄²⁻, HPO₃²⁻, and PO₃³⁻.

47. The high-silica Y molecular sieve having FAU topology according to claim 46, wherein M is at least one of Na, K, and Cs, and 2x/y=7˜30;
preferably, M is at least one of Na, K, and Cs, and 2x/y=8˜30;
preferably, k=0.01˜0.15; m=0.01˜0.1; n=0.02˜0.15;
more preferably, k=0.02˜0.13; m=0.01˜0.04; n=0.03˜0.08.

48. The high-silica Y molecular sieve having FAU topology according to claim 46, wherein R¹ and R² are independently at least one of quaternary ammonium compounds;
preferably, R¹ and R² are independently at least one of tetramethylammonium hydroxide, tetraethylammonium hydroxide, tetrapropylammonium hydroxide, tetrabutylammonium hydroxide, tetrapentylammonium hydroxide, tetrahexylammonium hydroxide, tetrapropylammonium bromide, tetrabutylammonium chloride, tetrapentylammonium bromide, tripropyl-isobutylammonium bromide, tributyl-cyclohexylammonium hydroxide, dibutyl-dihexyl ammonium hydroxide, choline, triethyl-hydroxyethyl ammonium hydroxide, tripropyl-hydroxyethyl ammonium hydroxide, tributyl-hydroxyethyl ammonium hydroxide, tributyl-benzyl ammonium hydroxide, triethyl-benzyl ammonium hydroxide, tripropyl-benzyl ammonium hydroxide, N,N,N-triethyl-adamantyl ammonium chloride, and N,N,N-tripropyl-adamantyl ammonium chloride;
preferably, R¹ is at least one of tetramethylammonium hydroxide, tetraethylammonium hydroxide, tetrapropylammonium hydroxide and choline,
R² is at least one of tetraethylammonium hydroxide, tetrapropylammonium hydroxide, tetrabutylammonium hydroxide, tetrapentylammonium hydroxide, tetrahexylammonium hydroxide, tetrapropylammonium bromide, tetrabutylammonium chloride, tetrapentylammonium bromide, tripropyl-isobutyl ammonium bromide, tributyl-cyclohexylammonium hydroxide, dibutyl-dihexyl ammonium hydroxide, choline, triethyl-hydroxyethyl ammonium hydroxide, tripropyl-hydroxyethyl ammonium hydroxide, tributyl-hydroxyethyl ammonium hydroxide, tributyl-benzyl ammonium hydroxide, triethyl-benzyl ammonium hydroxide, tripropyl-benzyl ammonium hydroxide, N,N,N-triethyl-adamantyl ammonium chloride, and N,N,N-tripropyl-adamantyl ammonium chloride.

49. The high-silica Y molecular sieve having FAU topology according to claim 46, wherein R¹ is at least one of quaternary ammonium compounds; R² is at least one of nitrogen-containing heterocyclic compounds and derivatives thereof;
preferably, R¹ is at least one of tetramethylammonium hydroxide, tetraethylammonium hydroxide, tetrapropylammonium hydroxide and choline, and R² is at least one of nitrogen-containing heterocyclic compounds and derivatives thereof;
preferably, R² is at least one of pyridine, N-methylpyridine, N-ethylpyridine, N-propylpyridine, N-butylpyridine, N-ethyl-3-butylpyridine, 1-ethyl-2-propylpyridine hydroxide, piperidine, N,N-dimethylpiperidine, N,N-dimethyl-3,5-diethylpiperidine hydroxide, N,N-dimethyl-3,5-dipropylpiperidine hydroxide, N,N-diethyl-3,5-dipropylpiperidine hydroxide, N,N-diethyl-2,6-dimethylpiperidine hydroxide, N,N-dimethyl-2,6-diethylpiperidine hydroxide, imidazole, 1-ethyl-3-butylimidazole hydroxide, 1-ethyl-3-butyl-4-propylimidazole hydroxide, 1-benzyl-3-methylimidazole hydroxide, 1-benzyl-3-ethylimidazole hydroxide, 1-benzyl-3-butylimidazole hydroxide, piperazine, N-methylpiperazine, 1,4-dipropylpiperazine, 1-methyl-4-ethylpiperazine, and 1-ethyl-4-butyl-5-methylpiperazine.

50. A method for preparing high-silica Y molecular sieve having FAU topology comprising following steps:
a) mixing raw materials containing aluminum source, silicon source, alkali metal source, organic templating agent R and water to prepare an initial gel mixture I, wherein the aluminum source, silicon source, alkali metal source, organic templating agent R and water in the raw materials have the following molar ratios:
SiO₂/Al₂O₃=10˜200;
M₂O/Al₂O₃=0˜30, wherein M is at least one of alkali metal elements;
R/Al₂O₃=1˜45;
H₂O/Al₂O₃=50˜8000;
b) adding silica-alumina molecular sieve seed crystal having FAU or EMT topology to the initial gel mixture I obtained in step a) to obtain a mixture II;
c) placing the mixture II obtained in step b) in a sealed reactor to perform crystallization to obtain the high-silica Y molecular sieve having FAU topology;
wherein, the number of moles of silicon source is calculated by SiO₂; the number of moles of aluminum source is calculated by Al₂O₃; the number of moles of templating agent R is calculated by the number of moles of R itself; and the number of moles of alkali metal source is calculated by the number of moles of corresponding metal oxide M₂O.

51. The method according to claim 50, wherein, in step a), H₂O/Al₂O₃=50˜6000;
preferably, in step a), H₂O/Al₂O₃=100˜8000;
preferably, in step a), R/Al₂O₃=0.1˜25.

52. The method according to claim 50, wherein, in step a),
the organic templating agent R is at least one of nitrogen-containing heterocyclic compounds and derivatives thereof, and quaternary ammonium compounds;
the structural formula of the quaternary ammonium compound is as shown in formula II; 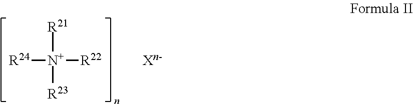
in formula II, R²¹, R²², R²³ and R²⁴ are independently at least one of C₁˜C₁₂ alkyl, C₁˜C₁₂ alkoxy, C₁˜C₁₂ hydroxyalkyl, aryl and adamantyl;
Xⁿ⁻ is one of OH⁻, Cl⁻, Br⁻, I⁻, NO₃⁻, HSO₄⁻, H₂PO₃⁻, SO₄²⁻, HPO₃²⁻, and PO₃³⁻;
preferably, the organic templating agent R in step a) is at least one of tetraethylammonium hydroxide, tetrapropylammonium hydroxide, tetrabutylammonium hydroxide, tetrapentylammonium hydroxide, tetrahexylammonium hydroxide, tetrapropylammonium bromide, tetrabutylammonium chloride, tetrapentylammonium bromide, tripropyl-isobutyl ammonium bromide, tributyl-cyclohexylammonium hydroxide, dibutyl-dihexyl ammonium hydroxide, choline, triethyl-hydroxyethyl ammonium hydroxide, tripropyl-hydroxyethyl ammonium hydroxide, tributyl-hydroxyethyl ammonium hydroxide, tributyl-benzyl ammonium hydroxide, triethyl-benzyl ammonium hydroxide, tripropyl-benzyl ammonium hydroxide, N,N,N-triethyl-adamantyl ammonium chloride, and N,N,N-tripropyl-adamantyl ammonium chloride;
preferably, the nitrogen-containing heterocyclic templating agent R in step a) is at least one of nitrogen-containing heterocyclic compounds and derivatives thereof;
preferably, the nitrogen-containing heterocyclic templating agent R in step a) is at least one of pyridine, N-methylpyridine, N-ethylpyridine, N-propylpyridine, N-butylpyridine, N-ethyl-3-butylpyridine, 1-ethyl-2-propylpyridine hydroxide, piperidine, N,N-dimethylpiperidine, N,N-dimethyl-3,5-diethylpiperidine hydroxide, N,N-dimethyl-3,5-dipropylpiperidine hydroxide, N,N-diethyl-3,5-dipropylpiperidine hydroxide, N,N-diethyl-2,6-dimethylpiperidine hydroxide, N,N-dimethyl-2,6-diethylpiperidine hydroxide, imidazole, 1-ethyl-3-butylimidazole hydroxide, 1-ethyl-3-butyl-4-propylimidazole hydroxide, 1-benzyl-3-methylimidazole hydroxide, 1-benzyl-3-ethylimidazole hydroxide, 1-benzyl-3-butylimidazole hydroxide, piperazine, N-methylpiperazine, 1,4-dipropylpiperazine, 1-methyl-4-ethylpiperazine, and 1-ethyl-4-butyl-5-methylpiperazine.

53. The method according to claim 50, wherein the silicon source in step a) is at least one of methyl ortho silicate, ethyl orthosilicate, silica sol, solid silica gel, fumed silica, and sodium silicate;
the aluminum source in step a) is at least one of sodium aluminate, aluminum oxide, aluminum hydroxide, aluminum isopropoxide, aluminum 2-butoxide, aluminum chloride, aluminum sulfate, aluminum nitrate, and pseudo-boehmite;
the alkali metal source in step a) is at least one of sodium hydroxide, potassium hydroxide, and cesium hydroxide.

54. The method according to claim 50, wherein step a) comprises mixing the aluminum source, the alkali metal source, the organic templating agent R and water, and then adding the silicon source to mix to obtain the initial gel mixture I.

55. The method according to claim 50, wherein the aluminum source, silicon source, alkali metal source, organic templating agent R and water in the raw materials in step a) have the following molar ratios:
SiO₂/Al₂O₃=10˜200;
M₂O/Al₂O₃=0˜30, wherein M is at least one of alkali metal elements;
R/Al₂O₃=1˜45;
H₂O/Al₂O₃=100˜6000.

56. The method according to claim 50, wherein a weight ratio of silica alumina molecular sieve seed crystal having FAU or EMT topology added in the mixture II in step b), to the silicon source in the initial gel mixture I ranges from 0.01:1 to 0.3:1;
wherein, the weight of the silicon source in the initial gel mixture I is calculated by the weight of SiO₂;
preferably, a silica-alumina molar ratio SiO₂/Al₂O₃ of the silica-alumina molecular sieve seed crystal having FAU or EMT topology in step b) is 2˜∞;
preferably, a silica-alumina molar ratio SiO₂/Al₂O₃ of the silica-alumina molecular sieve seed crystal having FAU or EMT topology in step b) ranges from 2.5 to 200.

57. The method according to claim 50, wherein a crystallization temperature in step c) ranges from 90 to 180° C., and a crystallization time in step c) ranges from 0.1 to 15 days;
preferably, the crystallization in step c) is performed dynamically or statically.

58. A method for preparing high-silica Y molecular sieve having FAU topology, comprising following steps:
a) mixing raw materials I containing aluminum source A¹, silicon source Si¹, alkali metal source M¹, organic templating agent R¹ and water, and aging to obtain a directing agent;
wherein, the aluminum source A¹, silicon source Si¹, alkali metal source M¹, organic templating agent R¹ and water in the raw materials I have the following molar ratios:
SiO₂/Al₂O₃=5˜30;
M¹₂O/Al₂O₃=0˜7, wherein M¹ is at least one of alkali metal elements;
R¹/Al₂O₃=1˜40;
H₂O/Al₂O₃=100˜600;
b) mixing raw materials II containing aluminum source A², silicon source Si², alkali metal source M², organic templating agent R², and water to prepare an initial gel;
wherein, the aluminum source A², silicon source Si², alkali metal source M², organic templating agent R² and water in the raw materials II have the following molar ratios:
SiO₂/Al₂O₃=10˜200;
M²₂O/Al₂O₃=0˜30, wherein M² is at least one of alkali metal elements;
R²/Al₂O₃=1˜45;
H₂O/Al₂O₃=100˜8000;
c) adding the directing agent in step a) to the initial gel in step b) and, after mixing uniformly, placing the obtained mixture in a sealed reactor for crystallization to obtain the high-silica Y molecular sieve having FAU topology;
wherein, the number of moles of silicon source Si¹ and Si² is respectively calculated by SiO₂; the number of moles of aluminum source A¹ and A² is respectively calculated by Al₂O₃;
the number of moles of templating agent R¹ and R² is respectively calculated by the number of moles of themselves; and the number of moles of alkali metal source M¹ and M² is respectively calculated by the number of moles of corresponding metal oxide M¹₂ and M²₂O.

59. The method according to claim 58, wherein the aluminum source A¹, silicon source Si¹, alkali metal source M¹, organic templating agent R¹ and water in the raw materials I in step a) have the following molar ratios:
SiO₂/Al₂O₃=5˜30;
M¹₂O/Al₂O₃=0˜3, wherein M¹ is at least one of alkali metal elements;
R¹/Al₂O₃=5˜40;
H₂O/Al₂O₃=100˜600;
preferably, the aluminum source A², silicon source Si², alkali metal source M², organic templating agent R², and water in the raw material II in step b) have the following molar ratios:
SiO₂/Al₂O₃=10˜200;
M²₂O/Al₂O₃=0˜30, wherein M² is at least one of alkali metal elements;
R²/Al₂O₃=1˜45;
H₂O/Al₂O₃=100˜4000;
preferably, the silicon sources Si¹ and Si² in step a) and step b) are independently at least one of methyl orthosilicate, ethyl orthosilicate, silica sol, solid silica gel, fumed silica, and sodium silicate;
the aluminum sources A¹ and A² in step a) and step b) are independently at least one of sodium aluminate, aluminum oxide, aluminum hydroxide, aluminum isopropoxide, aluminum 2-butoxide, aluminum chloride, aluminum sulfate, aluminum nitrate and pseudo-boehmite;
the alkali metal sources M¹ and M² in step a) and step b) are independently at least one of sodium hydroxide, potassium hydroxide, and cesium hydroxide.

60. The method according to claim 58, wherein the organic templating agents R¹ and R² in step a) and step b) are independently one of nitrogen-containing heterocyclic compounds and derivatives thereof, and quaternary ammonium compounds;
the structural formula of the quaternary ammonium compound is as shown in formula II; 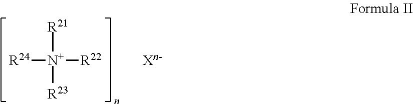
in formula II, R²¹, R²², R²³ and R²⁴ are independently at least one of C₁˜C₁₂ alkyl, C₁˜C₁₂ alkoxy, C₁˜C₁₂ hydroxyalkyl, aryl and adamantyl; Xⁿ⁻ is one of OH⁻, Cl⁻, Br⁻, I⁻, NO₃⁻, HSO₄⁻, H₂PO₃⁻, SO₄²⁻, HPO₃²⁻, and PO₃³⁻;
preferably, R¹ and R² are independently at least one of tetramethylammonium hydroxide, tetraethylammonium hydroxide, tetrapropylammonium hydroxide, tetrabutylammonium hydroxide, tetrapentylammonium hydroxide, tetrahexylammonium hydroxide, tetrapropylammonium bromide, tetrabutylammonium chloride, tetrapentylammonium bromide, tripropyl-isobutylammonium bromide, tributyl-cyclohexylammonium hydroxide, dibutyl-dihexylammonium hydroxide, choline, triethyl-hydroxyethyl ammonium hydroxide, tripropyl-hydroxyethyl ammonium hydroxide, tributyl-hydroxyethyl ammonium hydroxide, tributyl-benzyl ammonium hydroxide, triethyl-benzyl ammonium hydroxide, tripropyl-benzyl ammonium hydroxide, N,N,N-triethyl-adamantyl ammonium chloride, and N,N,N-tripropyl-adamantyl ammonium chloride;
preferably, R¹ is at least one of tetramethylammonium hydroxide, tetraethylammonium hydroxide, tetrapropylammonium hydroxide, and choline;
R² is at least one of tetraethylammonium hydroxide, tetrapropylammonium hydroxide, tetrabutylammonium hydroxide, tetrapentylammonium hydroxide, tetrahexylammonium hydroxide, tetrapropylammonium bromide, tetrabutylammonium chloride, tetrapentylammonium bromide, tripropyl-isobutylammonium bromide, tributyl-cyclohexylammonium hydroxide, dibutyl-dihexyl ammonium hydroxide, choline, triethyl-hydroxyethyl ammonium hydroxide, tripropyl-hydroxyethyl ammonium hydroxide, tributyl-hydroxyethyl ammonium hydroxide, tributyl-benzyl ammonium hydroxide, triethyl-benzyl ammonium hydroxide, tripropyl-benzyl ammonium hydroxide, N,N,N-triethyl-adamantyl ammonium chloride, and N,N,N-tripropyl-adamantyl ammonium chloride;
Preferably, wherein R² is at least one of pyridine, N-methylpyridine, N-ethylpyridine, N-propylpyridine, N-butylpyridine, N-ethyl-3-butylpyridine, 1-ethyl-2-propylpyridine hydroxide, piperidine, N,N-dimethylpiperidine, N,N-dimethyl-3,5-diethylpiperidine hydroxide, N,N-dimethyl-3,5-dipropylpiperidine hydroxide, N,N-diethyl-3,5-dipropylpiperidine hydroxide, N,N-diethyl-2,6-dimethylpiperidine hydroxide, N,N-dimethyl-2,6-diethylpiperidine hydroxide, imidazole, 1-ethyl-3-butylimidazole hydroxide, 1-ethyl-3-butyl-4-propylimidazole hydroxide, 1-benzyl-3-methylimidazole hydroxide, 1-benzyl-3-ethylimidazole hydroxide, 1-benzyl-3-butylimidazole hydroxide, piperazine, N-methylpiperazine, 1,4-dipropylpiperazine, 1-methyl-4-ethylpiperazine, and 1-ethyl-4-butyl-5-methylpiperazine.

61. The method according to claim 58, wherein an aging temperature in step a) ranges from 25 to 140° C. for an aging time in a range from 0.5 to 30 days;
preferably, an aging temperature in step a) ranges from 25 to 140° C. for an aging time in a range from 1 to 30 days;
preferably, an aging temperature in step a) ranges from 30 to 120° C. for an aging time in a range from 1 to 25 days.

62. The method according to claim 58, wherein the aging in step a) is a two-stage aging, a temperature for a first stage aging ranges from 30 to 40° C., a time for the first stage aging ranges from 0.5 to 5 days while a temperature for the second stage aging ranges from 50 to 100° C., and a time for second-stage aging ranges from 2 to 8 days.

63. The method according to claim 58, wherein step a) comprises: mixing the aluminum source A¹, the alkali metal source M¹, the organic templating agent R¹ and water uniformly, adding the silicon source S¹ therein, stirring, mixing and then aging, wherein an aging temperature ranges from 25 to 140° C., and an aging time ranges from 1 to 30 days to obtain the directing agent.

64. The method according to claim 58, wherein the aluminum source A², the silicon source Si², the alkali metal source M², the organic templating agent R², and water in step b) have the following molar ratios:
SiO₂/Al₂O₃=10˜200;
M²₂O/Al₂O₃=0˜30, wherein M² is at least one of alkali metal elements;
R²/Al₂O₃=1˜45;
H₂O/Al₂O₃=100˜6000.

65. The method according to claim 58, wherein, a weight ratio of silica in the directing agent to silica in the initial gel in step c) ranges from 0.01:1 to 0.3:1;
preferably, a weight ratio of silica in the directing agent to silica in the initial gel in step c) ranges from 0.01:1 to 0.2:1;
preferably, a crystallization temperature in step c) ranges from 90 to 180° C. for a crystallization time in a range from 1 to 15 days;
a crystallization temperature in step c) ranges from 90 to 140° C. for a crystallization time in a range from 3 to 15 days;
preferably, the crystallization in step c) is performed dynamically and/or statically.
